(19) United States
(12) Patent Application Publication
(10) Pub. No.: US 2023/0373778 A1
(43) Pub. Date: Nov. 23, 2023

(54) INTEGRATED FOOD SERVICE CUP DISPENSERS, SYSTEMS, AND METHODS

(71) Applicant: GPCP IP Holdings LLC, Atlanta, GA (US)

(72) Inventors: Ryan David Carignan, Suamico, WI (US); Lenox Gregory Wilson, Alpharetta, GA (US); Jason Aaron Morgan, Appleton, WI (US); Michelle Lynn Auda, Atlanta, GA (US); Daniel Huffaker, Kennesaw, GA (US); Brandon Seth Cross, Atlanta, GA (US); Daniel James Geddes, Appleton, WI (US); Antonio Michael Cittadino, Appleton, WI (US); Mark Edwin Peters, New London, WI (US); Roy J. Rozek, Neenah, WI (US); Erik Lips, Greenville, WI (US)

(21) Appl. No.: 18/364,561

(22) Filed: Aug. 3, 2023

Related U.S. Application Data
(63) Continuation of application No. 17/110,955, filed on Dec. 3, 2020, now abandoned.
Application No. 17/110,955 is a continuation-in-part of application No. 16/212,142, filed on Dec. 6, 2018, now abandoned.
Application No. 17/110,955 is a continuation-in-part of application No. 16/700,164, filed on Dec. 2, 2019, now Pat. No. 11,472,579.
(60) Provisional application No. 62/944,597, filed on Dec. 6, 2019.
(60) Provisional application No. 62/712,465, filed on Jul. 31, 2018.
(60) Provisional application No. 62/597,516, filed on Dec. 12, 2017.
(60) Provisional application No. 62/848,735, filed on May 16, 2019.
(60) Provisional application No. 62/775,227, filed on Dec. 4, 2018.

(51) Int. Cl. B67D 1/08; B67D 1/12; B41J 3/407; G06K 19/10; B25J 18/00; B65B 7/28

(52) U.S. Cl. CPC B67D 1/0888; B67D 1/1234; B41J 3/4073; G06K 19/10; B25J 18/00; B65B 7/28; B67D 2210/00076

(57) ABSTRACT

Systems for providing on-demand cup dispensing for food service are provided herein. A system includes a food request module configured to receive a request for food service for a customer. The system further includes a cup source configured to hold one or more cups. The system further includes a cup printer configured to print at least one of order information or personalization information based on the food service on a sidewall of a first cup. The system further includes a cup filler configured to fill the printed first cup with a consumable based on the food service. The system further includes a cup closer configured to at least partially close the open end of the filled first cup. The system further includes one or more cup transfer elements for transferring the first cup between the cup printer, the cup filler, and the cup closer.

### CROSS REFERENCE TO RELATED APPLICATIONS

This application (i) claims priority to U.S. Application No. 62/944,597, filed on Dec. 6, 2019, entitled “INTEGRATED FOOD SERVICE CUP DISPENSERS, SYSTEMS, AND METHODS”, and (ii) is a continuation-in-part of U.S. application Ser. No. 16/212,142, filed Dec. 6, 2018, entitled “Food Service Cup Dispensers, Systems, and Methods”, which claims priority to U.S. Provisional Application No. 62/712,465, filed Jul. 31, 2018, entitled “Personalized Food Service Material Printing Systems”, and U.S. Provisional Application No. 62/597,516, filed Dec. 12, 2017, entitled “Personalized Food Service Material Printing Systems” and (iii) is a continuation-in-part of U.S. application Ser. No. 16/700,164, filed Dec. 2, 2018, entitled “Film Securing Apparatus and Method”, which claims priority to U.S. Provisional Application No. 62/848,735, entitled “Film Securing Apparatus and Method”, filed May 16, 2019, and to U.S. Provisional Application No. 62/775,227, entitled “Film Securing Apparatus and Method”, filed Dec. 4, 2018; each of which is incorporated by reference herein in its entirety.

### BACKGROUND

Customer experience for food service can often feel impersonal. A customer may provide a food order and a food service person may then package up the food order for the customer. For example, cups such as open-top containers used to hold liquids (e.g., a beverage), solids (e.g., ice cream, dry cereal, dry oatmeal, bulk snack items), and mixtures thereof (e.g., a soup, a soda with ice, a milk shake) during consumption and/or storage are pre-printed and supplied to the food service store often months in advance, such that the customer is presented with one or more generic cups for their food order. Further, any promotions or messages that a food service business may want to present to the customer on a food service cup requires a significant lag time from formation of the promotion/message to presentation to the customer.

Often, in food service environment, in order to prepare a cup for a food service order, a food service person may need to read an order from a screen, grab the appropriately sized pre-printed cup, fill the cup with the appropriate contents, and then grab and secure a lid thereto. This process is time consuming and may often lead to one or more errors during preparation of the food order.

### BRIEF SUMMARY

Example embodiments of the present invention generally relate to dispensing systems for food service and, more particularly to on-demand cup (e.g., beverage cup, soup container, ice cream container) dispensing systems for food service.

Some embodiments of the present invention provide various integrated cup dispensing systems that utilize two or more of a cup printer, cup filler, and cup closer to provide for on-demand cup dispensing. Such on-demand cup dispensing, in some embodiments, may be provided in conjunction with a food service request module. Various example embodiments provide a useful solution for providing automated cup dispensing functionality to be used with food service orders. In this regard, order accuracy and speed is increased, and the customer may be provided with a personalized cup.

For example, once a customer places a request for food service, the system can determine order information about the customer's order and/or personalization information about the customer or store. Such information may be gathered based on any information available including, for example, user profiles, past order history, store promotions, social media, a user's device, among many other things. Using that information, the system may determine information to print on one or more cups that may be provided to the customer with their food order. Such print information may include order information (e.g., confirming their food order) and personalization information (e.g., the customer name, a promotion geared to the customer, an image that is personalized for the customer such as a favorite sports team, etc.). That print information may be then printed on one or more cups using a cup printer (and/or on one or more lids/seals using a cup closer, as described herein).

Various example systems integrate such a cup printer with a cup filler such that the printed cup is filled with the appropriate consumable and, thus, the food order can be accurately filled and presented in a personalized cup.

In some embodiments, the integrated system also includes a cup closer that can be used to provide a seal or lid on the printed and filled cup, thereby providing a fully automated cup dispenser.

In some embodiments, the integrated system may not include the cup printer and may just include a cup filler and cup closer. Such a system may, thus, provide a filled and sealed/lidded cup.

In some embodiments, various functionality of example integrated systems may be optional. For example, a cup may be filled and closed, but not printed on. In some embodiments, a user may position a cup appropriately and only utilize some of the available functionality.

In some embodiments, different functionality of different devices can be utilized together. For example, some information (e.g., order information and/or personalization information) may be printed on the sidewall of the cup via the cup printer and the same cup may receive a seal/lid that has printed information (e.g., order information and/or personalization information). In some embodiments, desired printed information may be split between the two (e.g., cup sidewall and cup seal/lid). As an example, the order information may be printed on the sidewall of the cup via the cup printer and personalization information may be printed on the lid/seal used to cover the open end of the cup.

Various cup transfer elements may be provided to cause movement of the cup through the various devices (e.g., cup printer, cup filler, cup closer, etc.). Some such cup transfer elements include, for example, one or more of rollers, chutes, tunnels, conveyor belts, robotic arms, transfer systems, mandrels, or other hardware effecting transfer of the cup. In some embodiments, identifier markings on the cups can be read, such as by mark sensors, and the corresponding information can be utilized to control operation of the integrated cup dispensing system, such as to ensure accurate preparation and dispensing of the cup.

Various example cup printers, cup fillers, and cup closers usable within some example integrated cup dispensing systems are described herein. Notably, however, various example integrated cup dispensing systems may include any type of cup printer, cup filler, and cup closer (in various combinations). In some embodiments, example integrated cup dispensing systems may include distinct and/or separate devices (e.g., cup printer, cup filler, and/or cup closer) that are designed to work together. In other embodiments, example integrated cup dispensing systems may include a single housing that holds each of the devices (e.g., cup printer, cup filler, and/or cup closer) that are designed to work together. In some embodiments, various example integrated cup dispensing systems may work in conjunction with food service request modules to help prepare the appropriate food order and/or print personalized information on the cup and/or lid/seal.

In some embodiments, example integrated cup dispensing systems in accordance with the present teachings may also include or be used in conjunction with other dispensers for preparing food orders, which may include printing on other food service material including, for example, food wrap, food containers, carry out bags, tray liners, napkins, pouches, etc.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a block diagram of an example on-demand food service material (e.g., cup) dispensing system, in accordance with some embodiments discussed herein;

FIG. 2 shows a block diagram of an example food request system, in accordance with some embodiments discussed herein;

FIGS. 2A-2C illustrate example ways to submit a request for food service for an example on-demand food service material dispensing system, in accordance with some embodiments discussed herein;

FIG. 3 shows a block diagram of an example control system for controlling one or more additional dispensers/components/systems, such as various example front or back-of-house dispensers, in accordance with example embodiments described herein;

FIG. 4 shows a block diagram of an example data management and control system for controlling one or more additional dispensers/components/systems, such as various example front or back-of-house dispensers, in accordance with example embodiments described herein;

FIG. 5 illustrates a flowchart of an example method for providing on-demand dispensing of printed, filled, and closed cups for food service, in accordance with some embodiments discussed herein;

FIG. 6A shows a block diagram of an example system for on-demand cup printing, cup filling, and cup closing for food service, in accordance with some embodiments discussed herein;

FIG. 6B shows a block diagram of an example system for on-demand cup printing and cup filling for food service, in accordance with some embodiments discussed herein;

FIG. 6C shows a block diagram of an example system for on-demand cup filling and cup closing for food service, in accordance with some embodiments discussed herein;

FIG. 7 illustrates example order print information and personalization print information for food service material items, in accordance with some embodiments discussed herein;

FIGS. 8A-8B illustrate example order print information and/or personalization print information for a cup, in accordance with some embodiments discussed herein;

FIG. 9A illustrates a common logistics flow from creation of a promotion to supplying a store with promotional material;

FIG. 9B illustrates an example logistics flow from creation of a promotion to packaging a food order using an example on-demand food service material printing system, in accordance with example embodiments described herein;

FIG. 10 illustrates example on-demand printing on a food service material item and packaging of a food order, in accordance with some embodiments discussed herein;

FIGS. 11A-11B show block diagrams of example cup printers, in accordance with some embodiments discussed herein;

FIG. 12 shows two example cup printers for use with an example on-demand food service material dispensing system, in accordance with some embodiments discussed herein;

FIG. 13 shows example food orders, where some of the food orders are packaged in a food service material item with printed information thereon, in accordance with example embodiments described herein;

FIG. 14 illustrates an example cup printer, in accordance with some example embodiments discussed herein;

FIGS. 14A-B illustrate an example path for movement/rotation of a cup from a cup source through the cup printer shown in FIG. 14, in accordance with some example embodiments discussed herein;

FIG. 14C illustrates an example food service environment with a food service provider and the example cup printer shown in FIG. 14, in accordance with some example embodiments discussed herein;

FIG. 14D illustrates an example printed cup, in accordance with some example embodiments discussed herein;

FIG. 14E illustrates a scenario where a food service provider prepares the food service order in the printed cup, in accordance with some example embodiments discussed herein;

FIG. 14F illustrates a scenario where a customer is able to easily locate her food service order using the printed cup, in accordance with some example embodiments discussed herein;

FIG. 15 illustrates another example cup printer, in accordance with some example embodiments discussed herein;

FIGS. 15A-C illustrate example cups suitable for printing by the cup printer of FIG. 15 in accordance with various embodiments discussed herein;

FIG. 15D illustrates some inner components of the example cup printer shown in FIG. 15, in accordance with some example embodiments discussed herein;

FIGS. 16A-G illustrate various example components of the cup printer of FIG. 15, in accordance with some example embodiments discussed herein;

FIG. 17 illustrates an example cup pathway for an example cup printer, in accordance with some example embodiments discussed herein;

FIGS. 18A-B illustrate example mandrels suitable for use in the cup printer of FIG. 15 in accordance with various embodiments discussed herein;

FIG. 19 illustrates various example components of the cup printer of FIG. 15, in accordance with some example embodiments discussed herein;

FIG. 20 illustrates a flowchart of an example method for providing on-demand food service material printing for food service, in accordance with some embodiments discussed herein.

FIGS. 21A-21B show block diagrams of example cup fillers, in accordance with some embodiments discussed herein;

FIG. 21C illustrates an example cup filler, in accordance with some example embodiments discussed herein;

FIG. 22 illustrates a flowchart of an example method for providing cup filling for food service, in accordance with some embodiments discussed herein.

FIG. 23A is a top perspective view of an example cup closing apparatus, in accordance with some embodiments described herein;

FIG. 23B is a top perspective view of another example cup closing apparatus, in accordance with some embodiments described herein;

FIG. 23C is a bottom perspective view of the example cup closing apparatus shown in FIG. 23B, in accordance with some embodiments described herein;

FIG. 24A is a cross-sectional side view of the example cup closing apparatus shown in FIG. 23A, in accordance with some embodiments described herein;

FIG. 24B is a cross-sectional side view of the example cup closing apparatus shown in FIG. 23B, in accordance with some embodiments described herein;

FIG. 25A is a partial side cross-sectional view of an example cup closing apparatus with a shield plate in a first position, in accordance with some embodiments described herein;

FIG. 25B is a partial side cross-sectional view of the example cup closing apparatus shown in FIG. 25A with a shield plate moving between a first position towards a second position, in accordance with some embodiments described herein;

FIG. 25C is a partial side cross-sectional view of the example cup closing apparatus shown in FIG. 25A with a shield plate returned to the first position and with a film secured to a container, in accordance with some embodiments described herein;

FIG. 26A is a side view of the example cup closing apparatus shown in FIG. 23A with a body lid in an opened position, in accordance with some embodiments described herein;

FIG. 26B is a side view of the cup closing apparatus of FIG. 26A, with the body lid open and the pinch roller adjusted away from the drive roller to enable loading of film from a roll of film, in accordance with some embodiments described herein;

FIG. 27A is an enlarged cross-sectional side view of a portion of an example cup closing apparatus, in accordance with some embodiments described herein;

FIG. 27B is an enlarged cross-sectional perspective view of another portion of an example cup closing apparatus, in accordance with some embodiments described herein;

FIG. 27C is an enlarged cross-sectional perspective view of yet another portion of an example cup closing apparatus, in accordance with some embodiments described herein;

FIG. 28A is a top perspective view of a portion of an example securing head assembly for an example cup closing apparatus, in accordance with some embodiments described herein;

FIG. 28B is an enlarged cross-sectional side view of the securing head assembly of FIG. 28A, in accordance with some embodiments described herein;

FIG. 28C is an exploded view of the securing head assembly of FIG. 28A, in accordance with some embodiments described herein;

FIG. 29 shows a cross-sectional view of the cup closing apparatus shown in FIG. 24A, wherein air flow through the apparatus is illustrated, in accordance with some embodiments described herein;

FIG. 30A shows an example sealed lid of a cup including a single slit;

FIG. 30B shows an example piercer with two spaced apart actuable tips, in accordance with some embodiments described herein;

FIG. 30C shows an example sealed lid of a cup utilizing the example piercer shown in FIG. 30B, in accordance with some embodiments described herein;

FIG. 30D illustrates example leakage protection provided by the spaced apart slits in the sealed lid shown in FIG. 30C, in accordance with some embodiments described herein;

FIG. 31A is a top view of an example film that can be used in accordance with some embodiments described herein;

FIG. 31B is a top view of a portion of a film supply, where a radiation-absorbing layer of ink has been applied to the film supply, in accordance with some embodiments described herein;

FIG. 31C is a top view of the portion of the film supply shown in FIG. 31B, where a first non-radiation-absorbing layer of ink has been applied to the film supply, in accordance with some embodiments described herein;

FIG. 31D is a top view of the portion of the film supply shown in FIG. 31C, where a second non-radiation-absorbing layer of ink has been applied to the film supply, in accordance with some embodiments described herein;

FIGS. 32-34 illustrate various example film marking schemes, in accordance with some embodiments described herein;

FIG. 35 shows a block diagram of an example system utilizing an example cup closing apparatus, in accordance with some embodiments described herein;

FIG. 36 illustrates a flowchart of an example method for operating an example cup closing apparatus, in accordance with some embodiments described herein;

FIG. 37 illustrates a flowchart of an example method for confirming use of an approved film with an example cup closing apparatus utilizing a marking scheme on the film, in accordance with some embodiments described herein;

FIG. 38 illustrates a flowchart of an example method for operating an example cup closing apparatus utilizing a marking scheme on the film, in accordance with some embodiments described herein;

FIG. 39 shows an example sealing lid with a customized message printed on the lid, in accordance with some embodiments described herein;

FIG. 40 shows an example dispensing system for on-demand cup printing, cup filling, and cup closing for food service, in accordance with some embodiments discussed herein;

FIG. 41 shows another example dispensing system for on-demand cup printing, cup filling, and cup closing for food service, in accordance with some embodiments discussed herein;

FIG. 42 shows an example dispensing system for on-demand cup printing and cup filling for food service, in accordance with some embodiments discussed herein;

FIG. 43 shows an example dispensing system for on-demand cup filling and cup closing for food service, in accordance with some embodiments discussed herein;

FIG. 44 shows another example dispensing system for on-demand cup printing, cup filling, and cup closing for food service, in accordance with some embodiments discussed herein;

FIG. 45 shows another example dispensing system for on-demand cup filling and cup closing for food service, in accordance with some embodiments discussed herein; and

FIG. 46 shows another example dispensing system for on-demand cup printing and cup filling for food service, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

As used herein, unless otherwise specifically stated, the term cup may refer any type of cup (e.g., beverage cup, soup container, ice cream container, a bowl, etc.) configured to hold liquid content, solid content, or mixture therein. In some embodiments, a cup may be defined to include one or more circular or oval cross-sections, such as at the open end of the cup and/or the closed end of the cup (and/or at some cross-sectional position therebetween). Though various described embodiments focus on use with a cup, other food service material items are contemplated for use with various embodiments, such as described herein.

As used herein, unless otherwise specifically stated, the term “dispensing” is not meant to be limiting and may refer to various cup processing, handling, presenting, etc., such as described herein.

As used herein, unless otherwise specifically stated, the term “close”, “closer”, “closing”, or “closed” in the context of a cup is not meant to be limiting and may refer/relate to, for example, sealing a cup, closing an open end of a cup, applying a permanent or removable lid to an open end of a cup, etc.

As used herein, unless otherwise specifically stated, the term “integrated” is not meant to be limiting and may refer to operational connectivity of various devices and systems described herein. For example, an integrated dispenser (or integrated system) may include discrete devices and systems designed to work together, such as via a common controller or co-controllers. In some embodiments, however, an integrated dispenser may include an integrally formed set of devices and systems, such as may be contained within a single housing.

As used herein, unless otherwise specifically stated, directional terms are not meant to be absolute and can encompass various orientations that are near the stated direction (e.g., substantially or generally). For example, the term “horizontal” is not meant to be absolute and can encompass various orientations that are near horizontal (e.g., substantially horizontal, generally horizontal, etc.); the term “vertical” is not meant to be absolute and can encompass various orientations that are near vertical (e.g., substantially vertical, generally vertical, etc.); and the term “parallel” is not meant to be absolute and can encompass various relative orientations that are near parallel (e.g., substantially parallel, generally parallel, etc.).

### Example On-Demand Food Service Material Dispensing System

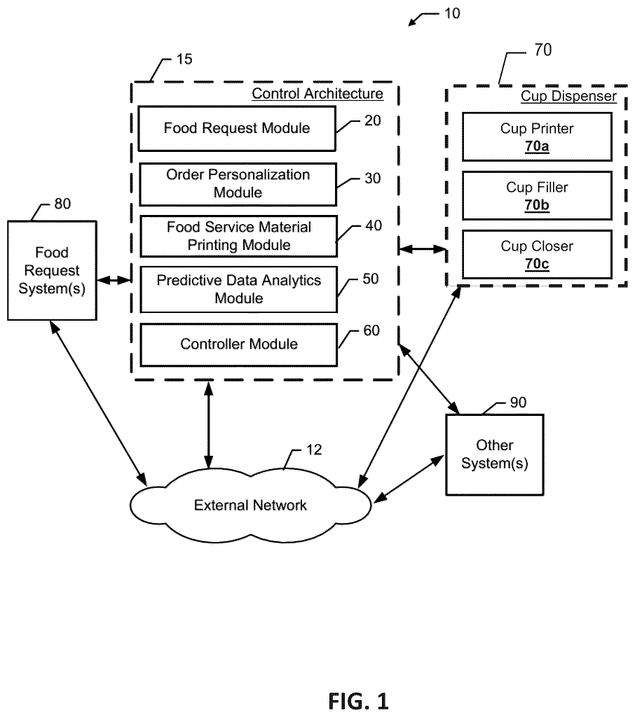

FIG. 1 shows a block diagram of an example on-demand food service material (e.g., cup) dispensing system 10 for food service. The depicted system 10 includes a number of modules, architectures, systems, and/or devices that are configured to work together to perform various functions, including providing on-demand food service material dispensing such as the dispensing to a user (e.g., a consumer or food service person) one or more of a cup printed on by one or more dispensers (70), a cup filled with a consumable by the one or more dispensers (70), and/or a filled cup that has been closed by the one or more dispensers (70). In the depicted embodiment, the system 10 includes a control architecture 15, food request system(s) 80 (e.g., point-of-sale (POS) system(s)), cup dispenser(s) 70, an external network 12, and other system(s) 90 (e.g., front of house (FOH) or back-of-house (BOH) system(s), other food service material dispenser(s)/printer(s)).

As shown in FIG. 1 and as discussed in detail below, the depicted dispenser 70 includes a cup printer 70a configured to print at least one of order information or personalization information on a cup based on the food service order associated with the cup, a cup filler 70b configured to fill the printed cup with a consumable (e.g., a beverage, soup, ice cream) based on the food service order, and a cup closer 70c configured to at least partially close (e.g., seal, lid) the filled cup. Though various embodiments of the present invention describe a cup printer, cup filler, and cup closer that can be used to form a printed, filled, and closed cup, various embodiments herein contemplate optional usage of various features of integrated systems/dispensers such that a food service person and/or an automated controller may selectively utilize various features as needed, such as based on the needs of a food service order. Though shown working in conjunction with a food request system 80, in some embodiments, various dispensers 70 described herein and corresponding systems may not necessarily work in conjunction with a food request system as they may be stand-alone and/or operated without such a connection or functionality.

In some embodiments, various controllers, including for example from the control architecture 15, the food request system(s) 80, the cup dispenser(s) 70, the other system(s) 90, or a remote computer server, may be configured to communicate with and/or control operation of various components of the system 10 such as according to various functions/modules described herein. In such a regard, while the depicted embodiment shows various particular modules, architectures, systems, and/or devices, some embodiments of the present invention contemplate many variations, including additional modules, architectures, systems, and/or devices and/or combinations in whole or part thereof. Additionally, while much of the described examples are detailed for dispensing one or more cup(s) (e.g., beverage cups, soup containers, ice cream containers), which may be printed on, filled, and/or closed as otherwise discussed herein, some embodiments of the present invention are contemplated for use with one or more other food service material dispensers/printers, including, for example, dispensers/printers for food wrap, food containers, lids, carry-out bags, tray liners, napkins, pouches, among many other things. In various aspects, the food service material may also have printed thereon the same or different order information or personalization information as that printed on one or more cups associated with the food service order.

The control architecture 15 may include one or more modules that are configured to perform various functions of the dispensing system 10. In the depicted embodiment, the control architecture 15 includes a food request module 20, an order personalization module 30, a food service material printing module 40, a predictive data analytics module 50, and a controller module 60. Though shown as distinct modules, some modules may be configured to share functionality. Likewise, various combinations of functionality are contemplated across the various modules.

As described in more detail herein, the control architecture 15 provides logic and control functionality used during utilization of the various modules and/or systems of the on-demand food service material (e.g., cup) dispensing system 10. The control architecture 15 and/or its various modules may comprise (or be connected to) hardware and software to enable performance of various functions described herein. Along these lines, the modules may share functionality across distinct hardware (e.g., among various servers, controllers, various systems described herein (e.g., food request system(s), printer(s), other system(s)), etc.) including in different locations and/or different apparatuses. For example, though FIG. 1 depicts modules for each of the cup printer 70a, the cup filler 70b, and the cup closer 70c within a single dispenser 70, systems in accordance with the present teachings can comprise distinct devices for each of one or more of these modules as discussed otherwise herein. Moreover, example embodiments of systems in accordance with the present teachings may comprise an automated cup printer and filler (e.g., with a lid and/or seal to be placed/formed manually) or an automated cup filler and closer (e.g., for filling and closing an unprinted or previously-printed cup).

The control architecture 15 may comprise one or more suitable electronic device(s)/server(s) capable of executing described functionality via hardware and/or software control. In some embodiments, the control architecture 15 may include one or more user interfaces (not shown), such as for displaying information and/or accepting instructions. The control architecture 15 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The control architecture 15 may be configured to communicate with various components of the dispensing system 10, such as directly or through an external network 12. In some embodiments, the control architecture 15 may be operably coupled with one or more components of the dispensing system 10, including for example, the food request system(s) 80, dispenser(s) 70, other system(s) 90, controllers, processors, communication interfaces, and other components (such as described herein) to provide functionality for the dispensing system 10. For example, depending on the components, the control architecture 15 may be operably coupled such as through use of solid-core wiring, twisted pair wiring, coaxial cable, fiber optic cable, mechanical, wireless, radio, infrared, or any other suitable connection. In this regard, depending on the components, the operable coupling may be through one or more intermediate controllers or mechanical coupling, such as used for controlling some components (e.g., controlling operation of the dispenser(s) 70). In some embodiments, the control architecture 15 may be configured to provide one or more operating signals to these components and to receive data from these components.

The control architecture 15 may include one or more processors coupled to a memory device. Control architecture 15 may optionally be connected to one or more input/output (I/O) controllers or data interface devices (not shown). The memory may be any suitable form of memory such as an EPROM (Erasable Programmable Read Only Memory) chip, a flash memory chip, a disk drive, or the like. As such, the memory may store various data, protocols, instructions, computer program code, operational parameters, etc. In this regard, a controller may include operation control methods embodied in application code. These methods are embodied in computer instructions written to be executed by one or more processors, typically in the form of software. The software can be encoded in any suitable language, including, but not limited to, machine language, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the control architecture 15 may be configured to execute computer program code instructions to perform aspects of various embodiments of the present invention described herein.

In some embodiments described herein, various components (e.g., modules, systems, architectures) of the dispensing system 10 may be configured to determine various things. As used herein, “determine” is not meant to be limiting and may include, for example, determining a selection, determining something from one or more instructions, generating something.

Example Food Request Module and/or Systems The control architecture 15, such as through the food request module 20, is configured to receive a request for food service by a customer, such as from one or more food request systems 80. The request for food service may include order information corresponding to a food order by the customer. Such a food order may include any suitable consumable (e.g., food or beverage item such as a drink, soup, ice cream, bulk items, etc.) and is not meant to be limiting.

In some embodiments, the request may include a purchase (e.g., a sale, a utilization of loyalty points, etc.) for the request, such as using a point-of-sale (POS) system. Additionally or alternatively, some or all of the request may not include a purchase. For example, the food request may be requested in conjunction with a non-purchase program (e.g., all-inclusive resort, charity, etc.) and, thus, no purchase or sale may be required.

In some embodiments, a customer may provide one or more custom order characteristics along with the request for food service. Example custom order characteristics may include order preferences, dietary preferences, exceptions to a standard food order (e.g., extra cheese or no tomatoes, extra ice), among others.

The food request module 20 may be further configured to determine order information based on the request for food service. For example, the food request module 20 may determine one or more food orders (e.g., food or drink items) that the customer has requested. Additionally, the food request module 20 may determine one or more custom characteristics that are specific to the request, such as being related to one or more of the food orders for the request.

Depending on the configuration of the food service and/or store for food service, example on-demand food service material (e.g., cup) dispensing systems 10 may include one or more food request systems for interaction with a customer. Some non-limiting example food request systems 80 include a self-order kiosk, a point-of-sale (POS) operator terminal, an application stored on a remote device (such as a customer's personal device), a web-based application (e.g., via a web browser), a cloud-based application, a computer server, and combinations thereof.

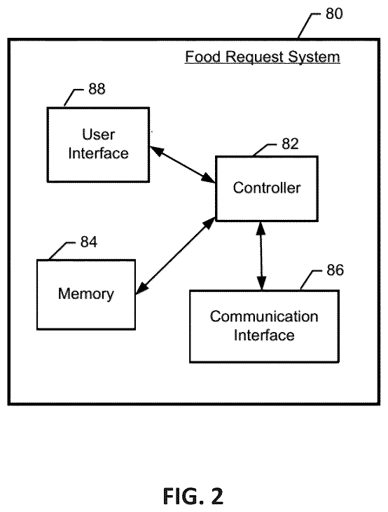

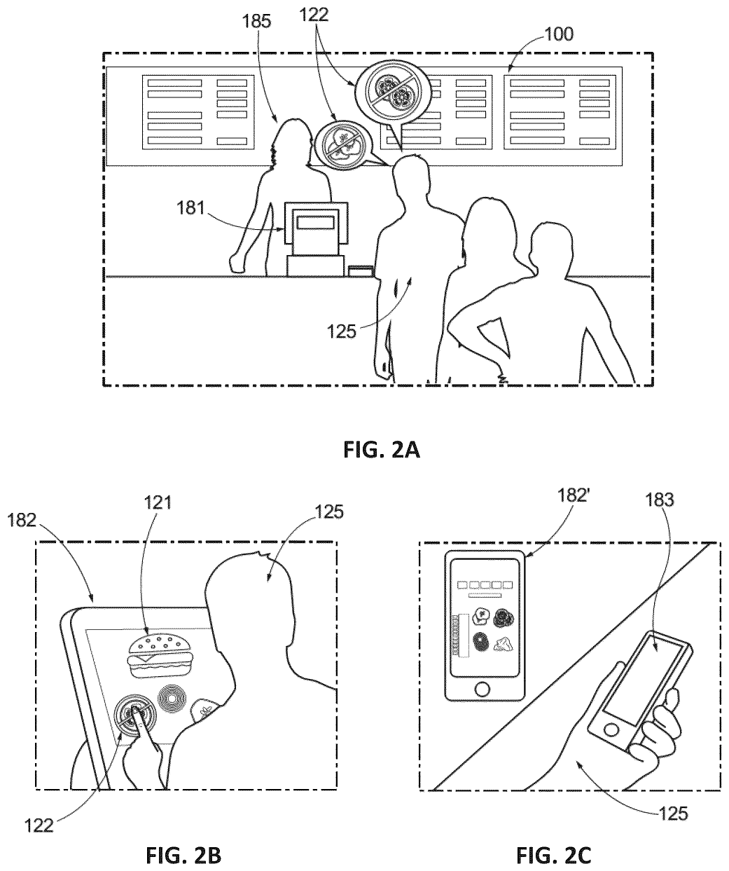

With reference to FIG. 2, an example food request system 80 may comprise hardware and/or software capable of performing one or more functions described herein. In this regard, the food request system 80 may include a controller 82, a memory 84, a communication interface 86, and a user interface 88.

The controller 82 may be configured to execute various programmed operations or instructions stored in a memory device such as a device or circuitry operating in accordance with software or otherwise embodied in hardware or a combination of hardware and software, thereby configuring the device or circuitry to perform the corresponding functions of the controller 82 as described herein. In this regard, the controller 82 may be configured to receive one or more requests for a food order from a customer, such as through the user interface 88. Additionally, in some embodiments, the controller 82 may receive and/or determine additional information regarding the customer (e.g., personalization information). The controller 82 may also be configured to send gathered information and/or instructions to other devices, systems, or modules to perform various functions described herein. In some embodiments, the controller 82 may be configured to operate according to one or more modules described herein.

The memory 84 may be configured to store instructions, computer program code, order data (e.g., order information), personalization information, and other data/information associated with the food request system 80 in a non-transitory computer readable medium for use, such as by the controller 82.

The communication interface 86 may be configured to enable connection to external systems (e.g., an external network 12, one or more dispenser(s)/printer(s) 70, a customer's mobile device, a computer server, the control architecture 15, and/or one or more other system(s)/device(s)). In some embodiments, the communication interface 86 may comprise one or more transmitters configured to transmit, for example, one or more signals according to example embodiments described herein. Likewise, the communication interface 86 may include at least one receiver configured to, for example, receive data according to example embodiments described herein. In some embodiments, the transmitter and receiver may be combined as a transceiver. In this regard, the food request system 80 may be configured for wired and/or wireless communication. In some embodiments, the communication interface 86 may comprise wireless capabilities for WiFi, Bluetooth, or other wireless protocols. In some embodiments, the food request system 80 may be connected, such as through Bluetooth, to one or more dispenser(s) 70 such as to enable performance of various functions herein.

The user interface 88 may be configured to receive input from a user and/or provide output to a user. The user interface 88 may include, for example, a display, a keyboard, keypad, function keys, mouse, scrolling device, input/output ports, touch screen, or any other mechanism by which a user may interface with the system. Although the user interface 88 is shown as being directly connected to the controller 82 and within the food request system 80, the user interface 88 could alternatively be remote from the controller 82 and/or food request system 80. Likewise, in some embodiments, other components of the food request/POS system 80 could be remotely located.

FIG. 2A illustrates an example food service environment 100 where a customer 125 has placed a request for a food service with a food service employee 185 that is using a POS operator terminal 181. In the depicted illustration, the customer 125 has ordered a large soda and a hamburger (e.g., a food order), the soda being cherry cola (with light ice) and the hamburger having no tomatoes and no pickles (e.g., custom order characteristics). In response, the food service employee 185 has entered the request into the POS operator terminal 181. In such an example, the food request module 80 receives the request for food service from the POS operator terminal 181.

FIG. 2B illustrates a similar request for food service by a customer 125 at a self-order kiosk 182. In the illustration, the customer 125 selects the food order 121 (e.g., a soda and hamburger) and provides one or more custom characteristics (e.g., light ice, no tomatoes). In such an example, the food request module 20 receives the request for food service from the self-order kiosk 182.

FIG. 2C illustrates two example ordering options, namely a self-order kiosk 182′ and a customer's personal device 183. In this regard, in some embodiments, the customer 125 may submit a request for food service through a remote device, such as a mobile phone device 183. That request may then be provided to the food request module 20 such as through an application on the user's mobile device or through a computer server (e.g., through an online ordering system).

As noted herein, although the above descriptions detail examples of a self-order kiosk, a POS operator terminal, and an application on a user's mobile device, other food request systems are contemplated by various example embodiments. For example, a user may place a food request through an online ordering system (e.g., a web-based or cloud-based application). In such an example, or through other contemplated food request systems (e.g., self-order kiosk, application, POS operator terminal, etc.), the food service request may be received through a computer server (e.g., an external network) that may be connected to the system 10.

### Example Control System(s)

In addition to communicating with the dispenser(s) 70 as discussed above with reference to FIG. 1, the control architecture 15, such as through the controller module 60, may also be configured to communicate with one or more other systems 90 (e.g., front of house (FOH) or back-of-house (BOH) system(s)). In some embodiments, the controller module 60 may be configured to determine, based on at least one of the order information or the personalization information, one or more instructions to transmit to one or more other components/systems.

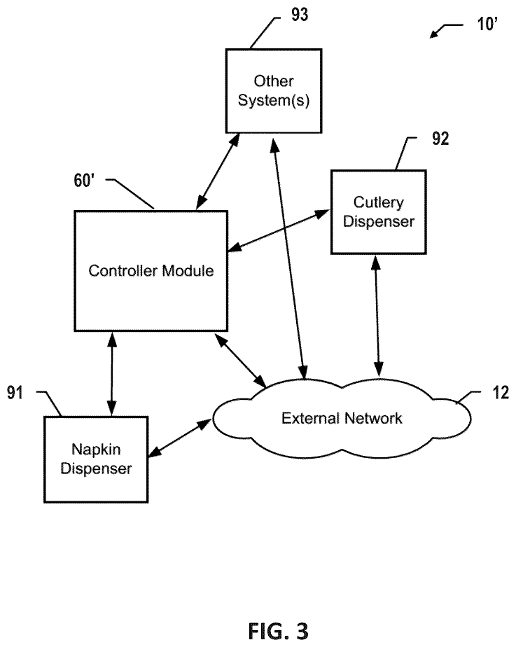

FIG. 3, for example, shows an example control system 10′ that includes a controller module 60′, a napkin dispenser 91, a cutlery dispenser 92, other system(s) 93, and an external network 12. The controller module 60′ may be configured to determine one or more instructions/messages to provide to various other systems (e.g., a napkin dispenser, cutlery dispenser, paper towel dispenser, soap dispenser, etc.). In some embodiments, some such dispensers (e.g., napkin dispenser(s), cutlery dispenser(s), paper towel dispenser(s), soap dispenser(s), etc.) may be referred to as back-of-house (BOH) systems. Such communication may occur directly to the other system(s) and/or through an external network 12.

In some embodiments, the determined instructions or messages may be based on any information gathered herein. For example, the controller module 60′ may determine that the napkin dispenser 91 should dispense a certain number of napkins to fulfill a food order request and instruct the napkin dispenser 91 accordingly. Such determination of the number of napkins may be made at the napkin dispenser 91 and/or by the controller module 60′. In this regard, the determined number of napkins could be based on a personal preference, other personalization information for the customer, and/or the order information.

Similarly, the controller module 60′ may determine that the cutlery dispenser 92 should dispense a certain number and/or type of cutlery items to fulfill a food order request and instruct the cutlery dispenser 92 accordingly. Such determinations may be made at the cutlery dispenser 92 and/or by the controller module 60′. In this regard, the determined number and/or type of cutlery could be based on a personal preference, other personalization information for the customer, and/or the order information. By way of example, the controller module 60′ may instruct the cutlery dispenser 92 to provide a number of spoons corresponding to the number of soup cups in the food order request. In various example embodiments, one or more of the other systems 93 could comprise a straw dispenser, for example, that may be instructed to provide the number of straws corresponding to the number of cold beverage cups in the food service request, or according to the personal preference in the food request (e.g., two straws for a single milkshake to allow for sharing).

In some embodiments, the on-demand dispensing system 10′ may utilize napkins or cutlery for printing information thereon—e.g., as the food service material item. In such embodiments, a printer may be configured to print on such items and may be built into the corresponding dispenser (e.g., napkin dispenser 91) or separate dispenser(s).

In some embodiments, the controller module 60′ may be configured to gather information and provide the gathered information to a remote server and/or the control architecture 15 for use with data aggregation/analysis, reports, and/or other data analytics. Such information may include data gathered from various other systems as well as any other connected system.

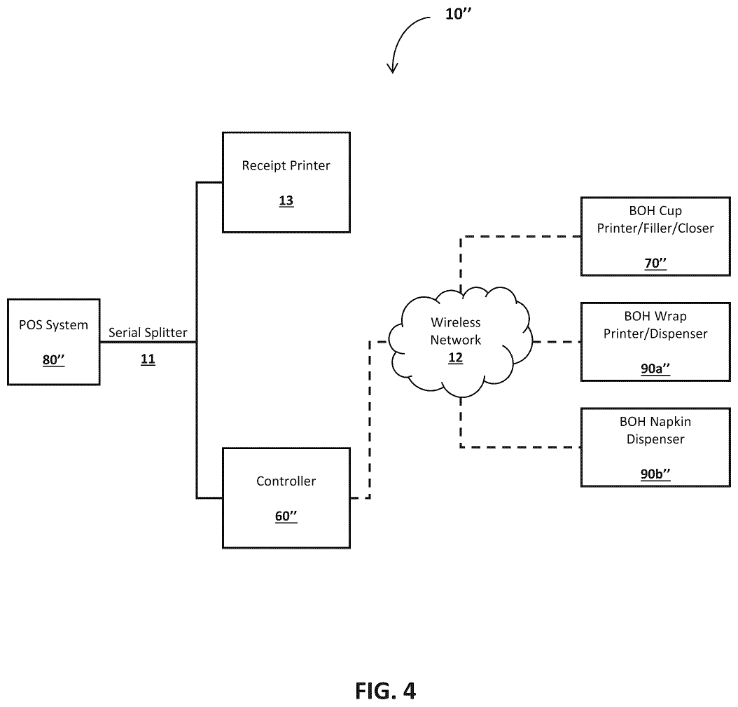

Another example control architecture is depicted in FIG. 4, in which a data management system 10″ includes a controller 60″ configured to gather receipt data directly from a POS system 80″ and to provide print/dispense instructions to various BOH printers/dispensers, such as in the food preparation/sales business.

In this regard, various BOH printers/dispensers may be positioned in the back of the restaurant/store where food preparation is occurring. An example BOH dispenser includes a cup printer/filler/closer 70″ that can receive data and print directly onto a cup, fill a cup, and/or close a cup as otherwise discussed herein. Additionally, the system 10″ can include a food service material printer/dispenser 90a″ that can receive data and print directly onto a food service material item (e.g., a wrap) that is dispensed for use during food preparation. Other example BOH printers/dispensers include a cutlery dispenser, a napkin dispenser 90b″, and a bag printer/dispenser, among others. The proposed data management system 10″ contemplates parsing through receipt data and generating and providing print/dispense instructions for one or more such BOH printers/dispensers utilizing the controller 60″.

The controller 60″ may connect directly to the POS system 80″ and receive pre-created “receipt data”. For example, a Serial Splitter 11 may be installed at the POS system 80″ to enable the controller 60″ to receive an exact copy of the “receipt data” received by the receipt printer 13 (which may be already provided and installed by the restaurant/business). The controller 60″ then parses/filters the receipt data and uses that data to generate print/dispense instructions for the various BOH printers/dispensers, which are then communicated (such as wirelessly through wireless network 12) to the appropriate BOH printers/dispensers 70″, 90a″, 90b″, etc. One notable advantage of the proposed data management system 10″ is that it can be plugged into the POS system 80″ and receive the same receipt data that is already being generated such that no changes are needed in the POS system.

As noted above, the controller 60″ may parse/filter the receipt data received from the POS system 80″ to generate print/dispense instructions for the various BOH printers/dispensers. For example, in some embodiments, the receipt data generated by the POS system 80″ may comprise a text string that may be used to determine the print information to print on one or more food service material items. In some such aspects, the controller 60″ may utilize a look-up table to identify a predetermined image to have printed on the food service material corresponding to the text string received from the POS system 80″. For example, the look-up table may indicate that the text string “no sugar” matches to a graphic of sugar with an “X” or line through it.

### Example Flowchart(s)

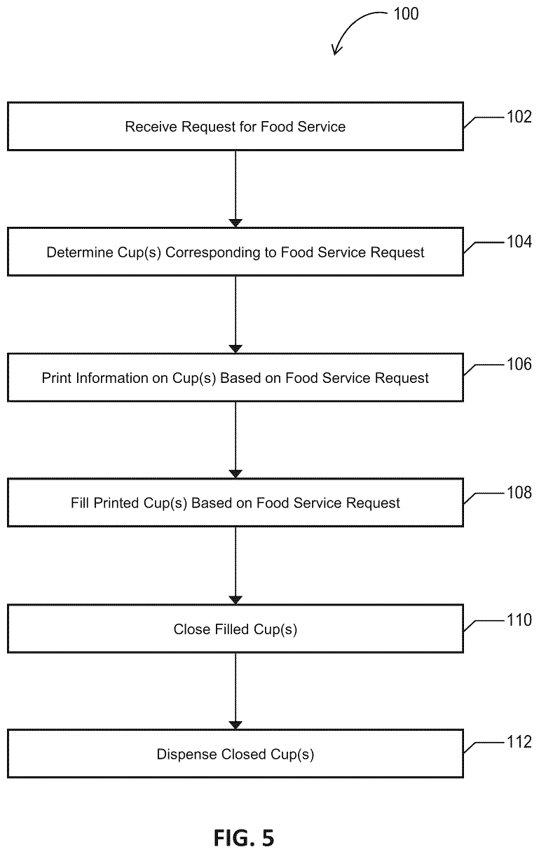

Embodiments of the present invention provide methods, apparatuses and computer program products for providing on-demand food service material dispensing for a food order according to various embodiments described herein. Various examples of the operations performed in accordance with embodiments of the present invention will now be provided with reference to FIG. 5.

FIG. 5 illustrates a flowchart according to an example method for providing on-demand cup dispensing for a food order according to an example embodiment. The operations illustrated in and described with respect to FIG. 5 may, for example, be performed by, with the assistance of, and/or under the control of one or more of the components, architectures, modules, networks, and/or systems/devices of system 10 of FIG. 1, such as described herein.

The method 100 may include receiving a request for food service at operation 102. At operation 104, the method may include determining one or more cups indicated by the request for food service. For example, the size (e.g., small, medium, and large) and/or style (e.g., for cold beverages, for hot beverages/soup, for storing frozen consumable) of the one or more cups corresponding to the food service request may be determined. At operation 106, the method may include printing order information or personalization information based on the request for each of the one or more cup. At operation 108, each of the printed cups may be filled with a consumable based on the food service order. For example, a small cup for cold beverages that was printed in operation 106 may be filled with soda as indicated by the food service request while a large soup container printed on in operation 106 may be filled with a minestrone soup as indicated by the food service request. Thereafter, at operation 110, the one or more cups may be closed (e.g., lidded, sealed) so as to at least partially close the open end of the cup and may be presented to a user (e.g., the consumer, a food service person) at operation 112.

FIG. 5 illustrates an example flowchart of a system, method, and computer program product according to various example embodiments described herein. It will be understood that each block of the flowcharts, and combinations of blocks in the flowcharts, may be implemented, for example, by hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the control architecture 15. As will be appreciated, any such computer program product may be loaded onto a computer or other programmable apparatus to produce a machine, such that the computer program product including the instructions which execute on the computer or other programmable apparatus may be suitable for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### Example Dispensing Systems

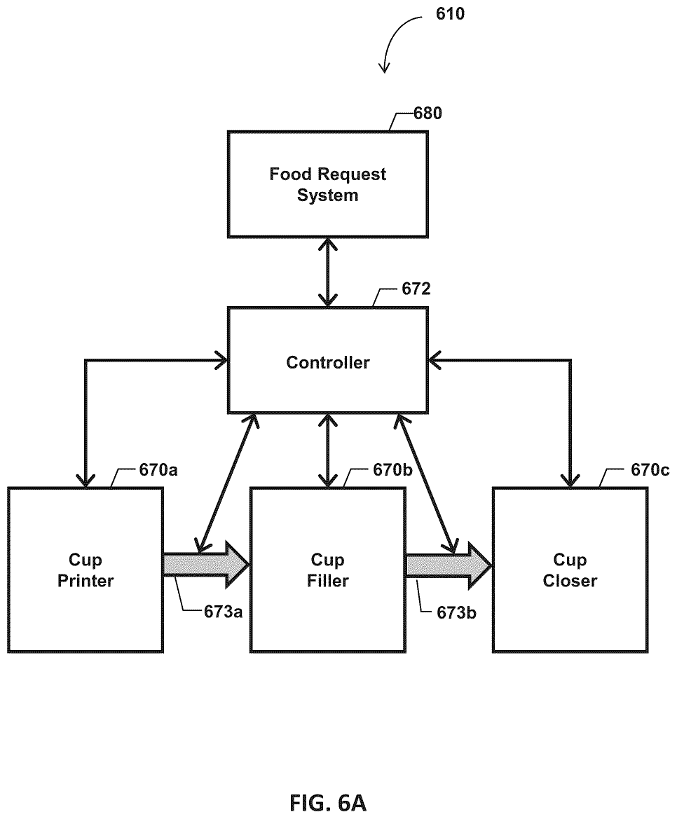

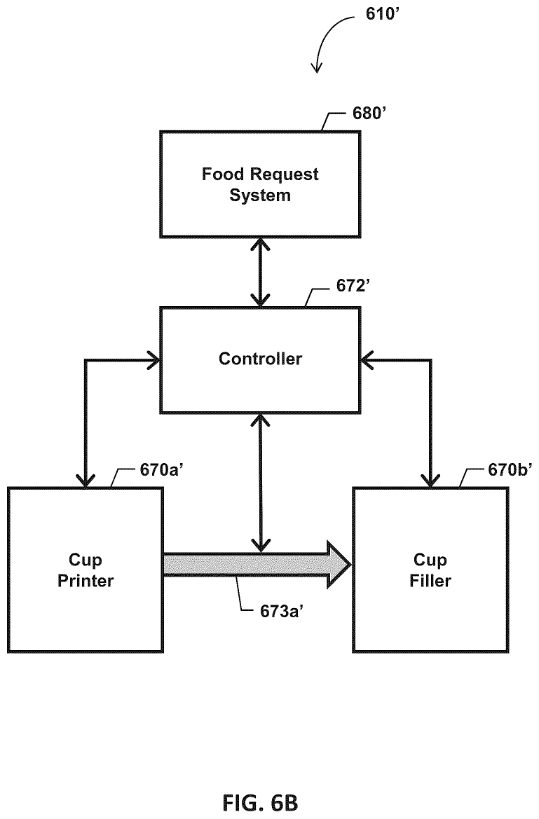

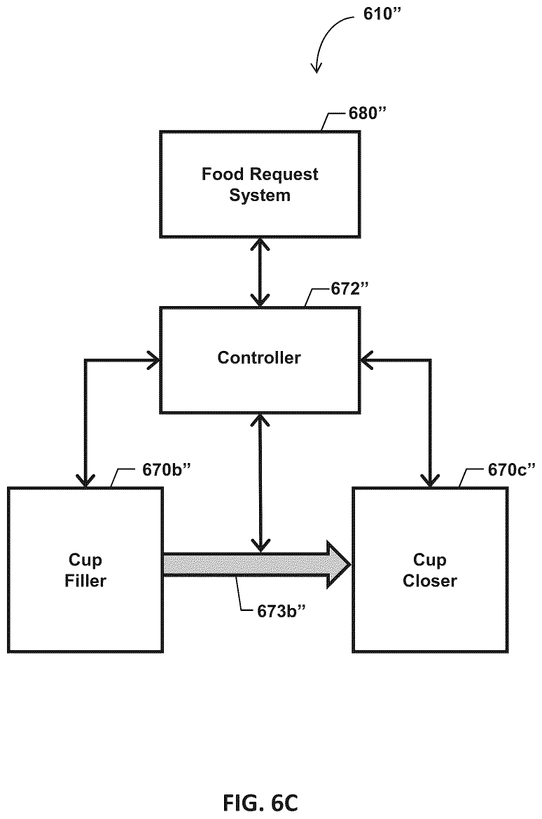

With reference now to FIG. 6A, an example cup dispenser 610 (e.g., a system, integrated system, integral device, etc.) may comprise hardware and/or software capable of performing various functions described herein. In this regard, the dispenser 610 may include a food request system or module 680, a controller 672, a cup printer 670a, a cup filler 670b, and a cup closer 670c. In addition, in some embodiments, one or more cup transfer elements 673a, 673b are provided for transferring a cup through the dispenser 610, such as between the various modules.

The controller 672 may be configured to execute various programmed operations or instructions stored in a memory device and may be, for example, a device comprising a processor or circuitry operating in accordance with software or otherwise embodied in hardware or a combination of hardware and software, thereby configuring the device or circuitry to perform the corresponding functions as described herein. In this regard, the controller 672 may be configured to receive one or more instructions for dispensing (e.g., through a communication interface) and may be configured to determine, process, and/or choose the determined cup to be printed, filled, and/or sealed from among a plurality of available cups at a cup source of the cup printer 670a (e.g., comprising multiple stacks of cups of various sizes and/or styles). In some embodiments, the controller 672 may be configured to cause printing on one or more of the cups (such as through the cup printer 670a), filling of the printed cup (such as through cup filler 670b), and closing of the filled cup (such as through the cup closer 670c), which may be dispensed in a dispensing section accessible to a user.

In some embodiments, the controller 672 may cause monitoring of the system operation. By way of example, the controller 672 may be in communication with one or more sensor(s) for monitoring supply materials of the cup printer 670a (such as ink for the cup printer and/or cups in the one or more cup sources), the supply of consumable materials of the cup filler 670b, and the supply of materials for closing the cups (e.g., lids, films). In some embodiments, the controller 672 may be configured to cause dispensing of a cup, such as a cup of a specific style and/or size. The controller 672 may also be configured to send gathered information and/or instructions to other devices, systems, or modules to perform various functions described herein. In some embodiments, the controller 672 may be configured to operate according to one or more modules described herein. For example, in some embodiments, the controller 672 may be configured to operate according to the control architecture 15 of FIG. 1, such as the food service material printing module 40. Additionally, and along similar lines, in some embodiments, the controller 672 may be configured to operate as (or in conjunction with) any other controller, processor, etc. of any systems or devices described herein (e.g., of the cup printer 670a, cup filler 670b, and/or cup closer 670c).

The one or more cup supplies of the cup printer 670a may be configured to hold and/or store one or more cups to be printed. For example, the cup printer 670a, depending on the configuration, may be configured to hold one or more stacks of cups, though other cup source options are contemplated, such as lines of cups, a single cup, etc. In some embodiments, the cup source may hold multiple stacks of the same type of cup (e.g., each may hold a beverage cup of the same size). In such a situation, the cup printer 670a may be enabled to switch to dispensing and printing from a primary supply to a secondary supply when the primary supply is depleted. In some embodiments, the cup source may hold different types of cups (e.g., two cups of different materials depending on the temperature of the beverage or food to be stored therewithin) and/or different sizes of cups (e.g., two cups of the same material but of different sizes). In some embodiments, for example, the cups of the cup source may differ in at least one material characteristic, such as composition (e.g., paper, plastic, composite, etc.), weight, dimensions, etc. In some such embodiments, the controller 672 or the cup printer 670a may be configured to choose which supply to use for printing. For example, in some embodiments, the food service material printing module 40 (e.g., as shown in FIG. 1) may be configured to determine which type of cup to print on, and instruct the cup printer 670a accordingly.

Notably, while some embodiments described herein describe the cup source being provided in conjunction with example cup printers 670a, some embodiments of the present invention contemplate a separate cup source, such as may be separately controlled or controllable. Likewise, corresponding cup transfer elements may be provided and/or controlled (e.g., by controller 672) to cause transfer of the appropriate cup from the cup source to another system/device (e.g., the cup may be transferred to the cup printer 670a).

In some embodiments, the cup printer 670a may be configured to print order print information and personalization print information on the cup(s). For example, in some embodiments, the cup printer 670a may include a printer head (e.g., such as an ink jet printer head), mandrels, rollers, presses, belts, or other hardware necessary for performing the printing. The cup printer 670a may be configured to print on cups simultaneously or sequentially, and may be configured to utilize different print characteristics for different types of cups (e.g., cups of different materials). For example, depending on which cup is selected for printing, the cup printer 670a may be configured to employ different print characteristics, such as different ink (e.g., UV curable ink for plastic cups), different settings, different components, (e.g., rollers and/or presses), etc.

Following printing of the cups by the cup printer 670a, the printed cup may be transferred to the cup filler 670b for filling thereof in accordance with the food service request. By way of example, the cup transfer element 673a may be configured to transfer the printed cup to the cup filler 670b. For example, in some embodiments, the cup transfer element 673a may include rollers, tunnels, chutes, conveyor belts, robotic arms, transfer systems, mandrels, or other hardware effecting transfer of the printed cup to the cup filler 670b. In some embodiments, the cup dispenser 670 may include one or more chutes for guiding the cup, such as toward the cup filler 670b. In some embodiments, one or more tunnels may extend short or long distances between the various devices and may utilize different movement capabilities for the cup (e.g., vacuum, forced air, etc.) for transferring the cup through the tunnels. Likewise, one or more motors may be used to operate various features/components of the cup transfer element 673a. In some embodiments, the controller 672 may be configured to operate the motor(s) accordingly. For example, one or more motors may be used to drive one or more cup transfer elements 673a (e.g., a conveyor belt, robotic arm, etc.) to cause one or more printed cups to be transferred to the cup filler 670b.

As noted above, in some embodiments, the controller 672 may cause monitoring of the system operation. By way of example, the controller 672 may be in communication with one or more sensor(s) for monitoring the cups as they move through the dispensing system 610. For example, in some aspects, each of the cups may be pre-printed with an identifier, such as a unique or semi-unique marking, (e.g., a bar code, QR code) or may be printed with such an identifier by the cup printer 670a that enables the controller 672 to confirm, for example, the cup and/or its contents at each module of the dispenser 610. For example, a small cup for cold beverages printed with order information or personalization information by the cup printer 670a may include an identifier that associates that cup with a particular item of a particular food request order. Such an identifier may be detected by a sensor before, during, or after transfer from the cup printer 670a to the cup filler 670b, for example, prior to filling to confirm that the appropriate printed cup is to be filled with the appropriate consumable (e.g., soda) by the cup filler 670b. In this regard, one or more mark sensors (e.g., cup identifier sensors) may be positioned at one or more positions throughout the dispenser 610 and used to verify and/or control appropriate operation of various portions of the dispenser 610 accordingly.

Upon being transferred to the cup filler 670b, the printed cup may be filled, for example, with the type and amount of one or more consumables corresponding to the printed cup based on the food service order. The cup filler 670b, for example, may contain and/or be operatively connected to one or more tanks, reservoirs, and/or supplies containing one or more consumables as well as one or more fill nozzles, chutes, funnels, or tubes, among others, capable of filling the cup with a consumable. By way of example, a cup filler 670b may comprise a chute associated with an ice supply (or ice generator) for adding an appropriate amount of ice (e.g., a default amount of ice corresponding to the cup size or based on a consumer's preferences such as light ice). Additionally or alternatively, a nozzle can provide a beverage from a beverage supply according to the food service request for that particular cup to be filled such as after adding the desired amount of ice, although other consumables are also contemplated for dispensing, such as ice cream, soup, bulk items (such as snacks, cereal, etc.).

In various aspects, the cup filler 670b may comprise one or more filling sections, each of which may correspond to a particular consumable, for example. In such example embodiments, the cup filler 670b may also include one or more cup-moving structures/features that may be used to enable movement of the cup between one or more of the consumable filling sections. A cup holder (or cup positioner) at each filling section may be configured to grasp, hold, or otherwise stabilize the cup during filling thereof to prevent the cup from tipping over, for example.

Following filling of the cup(s) by the cup filler 670b, the filled cup may be transferred to the cup closer 670c for at least partially closing (e.g., covering, lidding, sealing) the open end of the cup. By way of example, a cup transfer element 673b may be configured to transfer the filled cup to the cup closer 670c. For example, in some embodiments, the cup transfer element 673b may include rollers, tunnels, chutes, conveyor belts, robotic arms, transfer systems, mandrels, or other hardware effecting transfer of the filled cup to the cup closer 670c. One or more motors may be used to operate various features/components of the cup transfer element 673b such as to drive one or more cup transfer elements 673a (e.g., a conveyor belt, robotic arm) to cause one or more filled cups to be transferred to the cup closer 670c. In some embodiments, the controller 672 may be able to confirm before, during, or after transfer to the cup closer 670c the cup and/or its contents (e.g., based on an identifier such as a bar code or QR code) to ensure that the proper closure is provided to the cup. Additionally or alternatively, by reading the identifier, the controller may determine how to operate (e.g., which lid/seal to provide, what (if anything) to print on it, how long to operate, how far to move to close the cup (e.g., in relation to the size of the cup), etc.).

Upon being transferred to the cup closer 670c, the filled cup may be closed (e.g., lidded, sealed), for example as otherwise discussed herein, and may be made available to a user. By way of example, in some aspects, the cup may be transferred to a dispensing section via one or more of rollers, tunnels, chutes, conveyor belts, robotic arms, transfer systems, mandrels, or other hardware effecting transfer of the filled cup. In some aspects, a cup rotation structure may be provided for causing the cup to rotate (e.g., about its central axis) for presentation of the printed, filled, and closed cup to a user (e.g., a consumer, a food service provider) within the dispensing section.

While the example embodiment of FIG. 6A shows various particular modules, architectures, systems, and/or devices, it will be appreciated that some embodiments of the present invention contemplate many variations, including fewer or additional modules, architectures, systems, and/or devices and/or combinations in whole or part thereof as otherwise discussed herein. For example, with reference now to FIG. 6B, another example cup dispenser 610′ in accordance with various aspects of the present teachings is depicted. Like dispenser 610 of FIG. 6A, the dispenser 610′ may include a food request system 680′, a controller 672′, a cup printer 670a′ and a cup filler 670b′ as well as one or more cup transfer elements 673a′ for transferring a cup, for example, between a cup source (not shown), the cup printer 670a′, and the cup filler 670b′. Unlike dispenser 610, however, the dispenser 610′ does not include an automated cup closer. Rather, upon being filled by the cup filler 670b′, the filled cup may be made available to a user (e.g., a consumer, a food service provider) within a dispensing section. In such aspects, the printed, filled cup may not be automatically closed (e.g., lidded, sealed), but may be removed from the dispenser 610′ at a dispensing section and may be closed manually, if necessary. By way of example, a food service person may remove the filled cup and manually place a lid thereon.

FIG. 6C depicts another example cup dispenser 610″ in accordance with various aspects of the present teachings is depicted. Like dispenser 610 of FIG. 6A, the dispenser 610″ may include a food request system 680″, a controller 672″, a cup filler 670b″, and a cup closer 670c″ as well as one or more cup transfer elements 673b″ for transferring a cup, for example, between the cup filler 670b″ and the cup closer 670c″. However, the example dispenser 610″ does not include an automated cup printer but instead may access from a cup source one or more cups to be filled and closed by the system. In various embodiments, for example, the cup filler 670b″ may be configured to hold and/or store one or more cups to be printed. Alternatively, in some embodiments, a user may manually feed one or more cups into the cup filler 670b″. For example, the cup filler 670a″, depending on the configuration, may be configured to hold one or more stacks of pre-printed or blank cups, though other cup source options are contemplated, such as lines of cups, a single cup, etc. In some embodiments, a cup source of the cup filler 670b″ may hold multiple stacks of the same type of cup (e.g., both may hold a beverage cup of the same size), and may be enabled to switch to dispensing and filling from a primary supply to a secondary supply when the primary supply of cups is depleted. In some embodiments, the cup filler 670b″ may be associated with a cup source for holding different types of cups (e.g., two cups of different materials depending on the temperature of the beverage or food to be stored therewithin) and/or different sizes of cups (e.g., two cups of the same material but of different sizes). In some embodiments, for example, the cups of the cup source may differ in at least one material characteristic, such as composition (e.g., paper, plastic, composite, etc.), weight, dimensions, etc. In some such embodiments, the controller 672″ or the cup filler 670b″ may be configured to choose which supply to use for filling. In this regard, the controller 672″ may be configured to receive one or more instructions for dispensing (e.g., through a communication interface) and may be configured to determine, process, and/or choose the determined cup to be filled and sealed from among a plurality of available cups. In some embodiments, the controller 672″ may be configured to cause dispensing of a filled and closed cup, such as a cup of a specific style and/or size.

As noted above with respect to FIGS. 6A-C, for example, it will be appreciated that some embodiments of the present invention may contain one or more of the various particular modules, architectures, systems, and/or devices described herein. While the following description may explicate various example features of the cup printer, cup filler, and cup closer as independent devices, a person skilled in the art will appreciate in light of the present teachings that one or more of these devices (and/or the various components/features) may be combined to form an integrated system, such as being configured to operate in conjunction and/or formed into an integral printing, filling, and/or closing device (e.g., within a single housing).

### Example Personalization Information

With reference again to FIG. 1, the control architecture 15, such as through the order personalization module 30, may be configured to determine personalization information related to the customer or store. Some example personalization information includes the customer's name, preferences, allergies, order/customer profile, other identifiers, preferred language(s), order history, social media data, other external data (including purchase and trend data), among other things.

In some embodiments, the personalization information may be gathered in various different ways. For example, in some embodiments, the customer may provide personalization information during the request. In some embodiments, personal information may be gathered based on the request. For example, the customer may be signed in to a profile during submittal of the request. In some embodiments, the personalization information may be gathered from purchase information provided during purchase of the food service (e.g., from the credit card, an account for the customer, a loyalty card, etc.). In some embodiments, personalization information may be gathered from publicly available data related to the customer, such as through social media, other databases, etc. In some embodiments, personalization information may be gathered, such as with the permission of the customer, from one or more personal devices of the customer—such as data stored on the device (e.g., pictures, profile data, history, online data, etc.). In some embodiments, the personalization information may be related to the location (e.g., region, the specific store, city, etc.) associated with the customer and/or the request for food service.

### Example Print Module and Print Determination

The control architecture 15, such as through the food service material printing module 40, may be configured to determine print information to print on one or more food service material items. In this regard, in some embodiments, the food service material printing module 40 may be configured to communicate with one or more cup printer(s) 70 and/or one or more other food service material printer(s)/dispenser(s) 90 to cause the print information to be printed on the corresponding food service material item(s) using the one or more cup printer(s) 70a or other dispenser(s)/printer(s) 90.

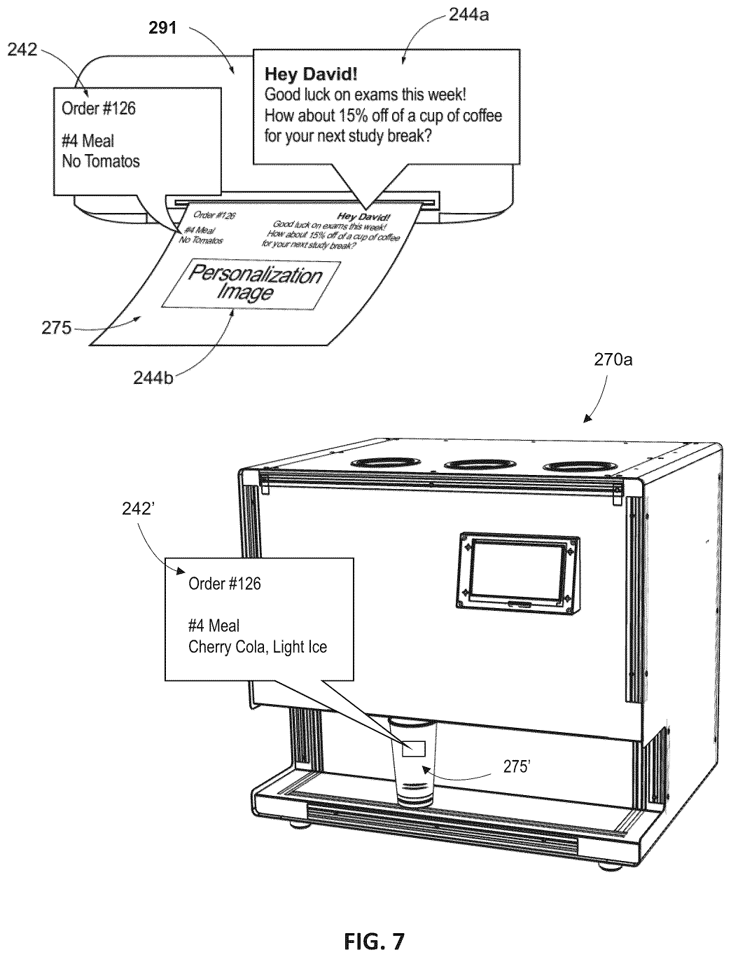

In some embodiments, the food service material printing module 40 is configured to determine, based on the order information from the food request module 20, order print information to print on at least one food service material item. In some embodiments, the order print information includes at least the food order and one or more custom characteristics that are specific to the request for food service. For example, FIG. 7 shows an example dispenser/printer 291 that is configured to print on a food service material item (e.g., a food wrap 275) and an example cup printer 270a that is configured to print on a cup 275′. In the depicted embodiment, the food service material printing module 40 has determined the order print information 242 to be printed on the food wrap 275 includes an order number (“Order #126”), an indication of the food order (“#4 Meal”), and a custom order characteristic (“No Tomatos”) and the order print information 242′ to be printed on the cup 275′ includes the order number, and indication of the food order, and a custom order characteristic (“Cherry Cola, Light Ice”).

In some embodiments, the order print information may include other order related information, such as ingredients and/or nutritional information. For example, the calorie count may be determined based on chosen ingredients and printed onto the food service material. In some such embodiments, the “basic”, “common”, or “advertised” make-up (e.g., ingredients) of the ordered food service item may form a base level calorie count. From there, the customization of the ingredients may be factored into the calorie count to produce a customized calorie count. In some embodiments, the base level calorie count and/or custom calorie count may be printed on the food service material (e.g., wrap 275, cup 275′) for the consumer.

In some embodiments, the order print information may be designed to be presented to the customer with the food order. For example, the order print information (or a portion thereof) may be visible to the customer upon the customer receiving the food order. In such an example embodiment with the order print information printed on the food service material item, the customer may feel confident in the accuracy of their food order.

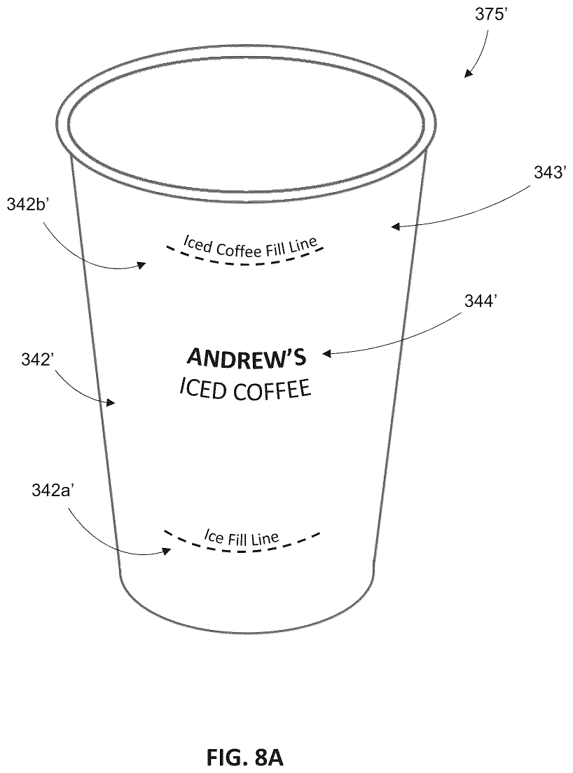

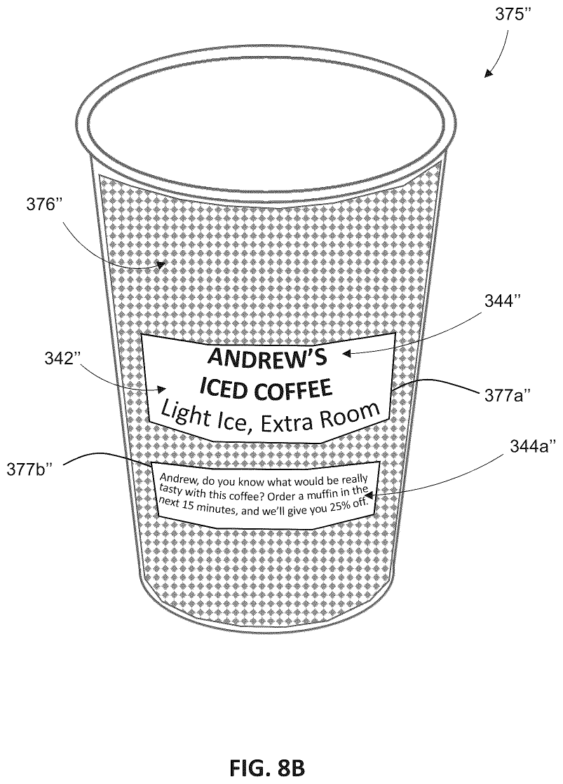

Additionally or alternatively, in some embodiments, one or more food service people may use the order print information during assembly of food order, thereby increasing accuracy of the food order. In this regard, in some embodiments, the order print information may be printed on the food service material item in a position or orientation such that it can be utilized during assembly of the food order by the food service person. For example, in some embodiments, the order print information may be printed in one or more positions on a cup to provide a food service person guidance as to the food order and custom characteristics thereof. For example, FIG. 8A illustrates an example cup 375′ that has order print information 342′ (“Iced Coffee”) printed on an outer surface of the cup's sidewall 343′, as well as line 342a′ to provide instructions as to the desired fill level of ice (e.g., light ice) and line 342b′ to provide instructions as to the desired fill level of coffee (e.g., extra room) in accordance with the custom characteristics of the food order. FIG. 8B provides another example, wherein the order print information 344″ is printed on the cup 375″ (“Iced Coffee, Light Ice, Extra Room”). Such example embodiments may help ensure order accuracy and speed, as a food service person may not need to constantly look back and forth between a monitor and the food order. In accordance with various embodiments, the cup 275′ may alternatively be transferred to a cup filler (e.g., cup filler 70b of FIG. 1) as otherwise discussed herein, for automated filling thereof based on the food service order.

In some embodiments, the food service material printing module 40 may determine any form of communication to utilize for the order print information. For example, while example lines and/or text are shown in FIGS. 8A-B, other forms of communication are contemplated, such as text, lines, icons (e.g., ice cubes, a cherry for cherry cola), images, etc., and combinations thereof.

Similarly, in some embodiments, only positive ingredients may be printed on the food service material (e.g., only ingredients that the food service operator will need to add to complete the order). Such an example may help ensure the proper ingredients are utilized, not needing to rely on the memory of the food service operator.

In some embodiments, the food service material printing module 40 is configured to determine, based on the personalization information from the order personalization module 30, personalization print information to print on at least one food service material item. In some embodiments, the personalization print information includes personalization information and/or advertisement information. For example, FIG. 7 shows two example dispensers 291, 270a that are configured to print on food service material items (e.g., a food wrap 275, cup 275′). In the depicted embodiment, the food service material printing module 40 has determined to include the personalization print information 244a on the food wrap 275 with a greeting with the customer's name (“Hey David!”), a personalized message (“Good luck on exams this week!”), and an advertisement/promotion (“How about 15% off of a cup of coffee for your next study break”), though the same or different personalization information can additionally or alternatively be printed on the cup 275′ (not shown). Additionally, the food service material printing module 40 has determined the personalization print information 244b to include an image, such as may be any image including, for example, a logo from a favorite or local sports team, college, etc., a picture from the camera roll of the customer, or other image. Although shown as “David” in the above example, in some embodiments, the customer's name may be any identifier for the customer, e.g., their name, their nickname, their first name, an avatar, a screen name, a user id, etc.

In this regard, in some embodiments, the personalization print information may be any suitable image, text, icon, etc. It may be related to the customer, the store, the location, or any other personalization feature. FIGS. 8A-B illustrate example cups that have personalization print information printed on an outer surface (e.g., a surface designed to face the customer after assembly). For example, FIG. 8A shows personalization print information 344′ that includes the customer name in relation to the order information. FIG. 8B shows personalization print information 344″ that includes the customer name in relation to a limited time offer (LTO) 344a″. However, in accordance with various embodiments of the present teachings, the personalization print information may additionally or alternatively include a personalized message (e.g., “Andrew, good luck on exams this week!”), an advertisement/service announcement/request for charity assistance (e.g., “Andrew, help us support Hurricane Harvey Relief”), and/or a promotion offer, all by way of non-limiting examples.

In some embodiments, the cup for on-demand printing in accordance with the present teachings may include pre-printed information. In such example embodiments, the order print information and/or personalization print information may be printed on the cup in addition to the pre-printed information. In some such embodiments, the order print information and/or personalization print information may need to account for such pre-printed information such as in content and/or positioning on the food service material item. As shown in FIG. 8B, for example, the cup may be pre-printed with a graphic (e.g., pattern 376″, the store's name and/or logo). In addition, the pre-printed information may define one or more windows, for example, within which the cup dispenser may be configured to print on-demand order information or personalization information. For example, the pattern 376″ in FIG. 8B defines two blank spaces (e.g., windows 377a,b″) within which print information may be added.

In some embodiments, the personalization print information may be determined based on any number of factors. For example, the personalization print information may be determined to include one or more targeted messages and/or advertisements based on past habits (e.g., order history, time of orders, etc.) or projected habits of the customer. Additionally or alternatively, the food service business may wish to “push” or promote certain products or time windows for customers, which may be considered in determination of the personalization print information. Other possible factors include, for example, related/sister businesses (e.g., cross marketing), limited time offers, promotional offers, products or time windows for that store and/or corresponding location (e.g., region), preferences of the customer, etc. For example, the food service business may want to promote cheeseburgers in the region, because barbeque sandwiches are currently popular at that location.

In some embodiments, the personalization print information and/or order print information may be determined to be printed in a preferred language of the customer. In some embodiments, the preferred language may be determined from the personalization information. In some embodiments, the preferred language may be determined based on the location of the store in which the food order was requested. Similarly, in some embodiments, the personalization print information and/or order print information may be determined to be printed in braille, such as to accommodate the customer. For example, divots, imprints, or other features may be employed by the printer to manipulate the food service material item to product braille. In some embodiments, the determination to use braille may be based on the personalization information regarding the customer.

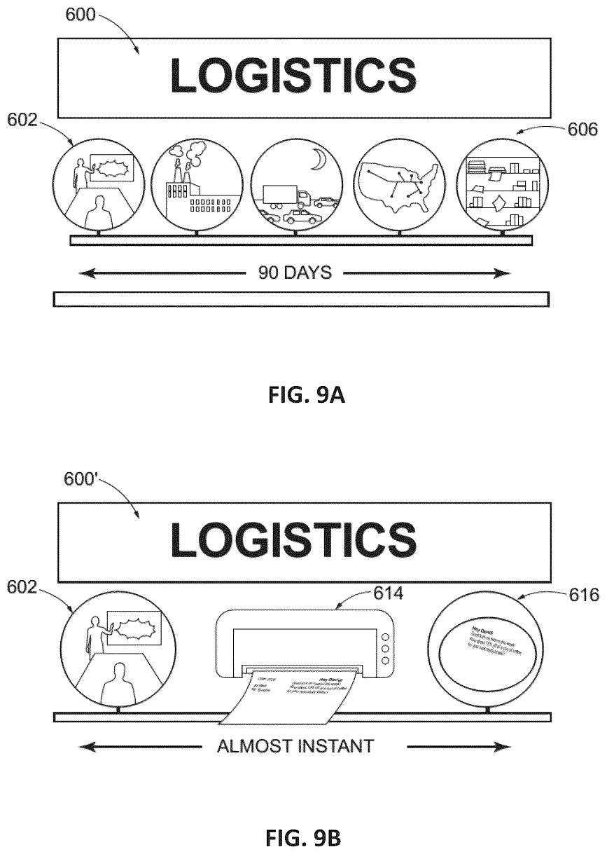

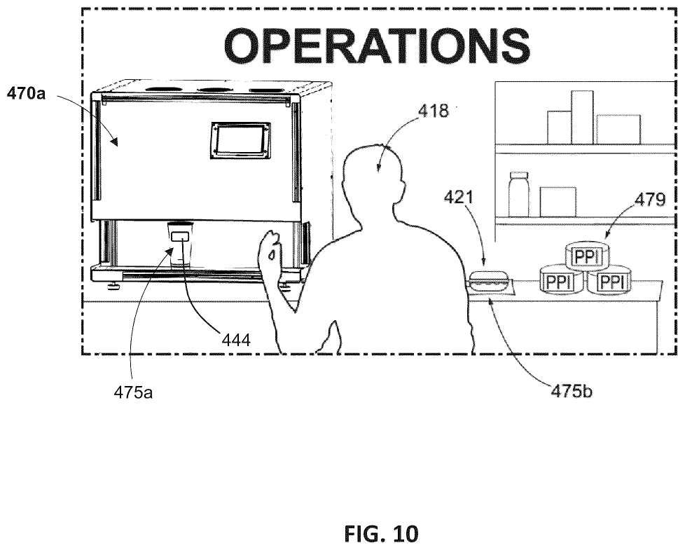

In some embodiments, the personalization print information may be determined in real-time, such as while the food service request is being processed. In this regard, updated information can be utilized at the time the food service request is being placed. This allows current information to be utilized in determining what to print on the food service material item. For example, the food service business may have just come up with a new promotion. Once the system is updated with the available new promotion, it can be used by the on-demand cup dispensing system 10. This avoids the previous long logistics time frame it took from a decision to implement a new promotion to available food service material with the new promotion. Instead, the update may be instantaneous. For example, FIG. 9A illustrates a common prior logistics flow 600 from creation of a promotion 602 to supplying a store with promotional material 606. That logistics flow would often take at least 90 days. FIG. 9B, however, illustrates an example logistics flow 600′ according to various example on-demand food service material printing systems. That logistics flow 600′ is almost instant from creation of a promotion 602 to availability of personalization print information for printing on the food service material item at 614 and for providing to the customer at 616.

In some embodiments, the control architecture 15 may include an advertisement module configured to determine one or more advertisements (e.g., a promotion, limited time offer, etc.) to print on the food service material item. In some embodiments, the advertisement module may work in conjunction with or replace portions of the food service material printing module 40.

In some embodiments, the control architecture 15, such as through the predictive data analytics module 50 and/or food service material printing module 40, may be configured to determine one or more messages and/or advertisements to provide to the customer based on the personalization information. In some embodiments, the predictive analytics module 50 and/or food service material printing module 40 may take into account gathered order information and/or personalization information from a plurality of food order requests. Such considered order and/or personalization information may be bounded/limited according to a time threshold (e.g., between 11 am-3 pm, within the last 30 days, etc.) and/or location threshold (e.g., just this store, stores within 25 miles, etc.).

In some embodiments, the predictive data analytics module 50 and/or food service material printing module 40 may be configured to determine a message to provide based on a determined product, time window, promotion, limited-time-offer, etc. For example, the food service business may determine that they wish to “push” customer traffic in the store after 5 pm. The predictive data analytics module 50 and/or food service material printing module 40 may determine, such as based on the customer history, that the customer that just placed an order usually orders chicken strips between 11 am-3 pm. Additionally, the predictive data analytics module 50 and/or food service material printing module 40 may determine that the food service business wants to drive in customers after 5 pm. In such a situation, the predictive data analytics module 50 and/or food service material printing module 40 may determine a message that provides a promotional offer for coffee, but only after 1 pm—thereby personalizing the offer to the customer (as the customer normally orders coffee on the way into work), but incentivizing the customer to come to the store for an afternoon coffee break (e.g., after 1 pm per the food service business' wishes). In response, the predictive data analytics module 50 and/or food service material printing module 40 may provide the determined message to the control architecture 15, the cup printer 70a, other modules, and/or other systems/devices (e.g., one or more dispenser(s)/printer(s) 90) to have the determined message printed on the cup for presentation to the customer with their food order.

In some embodiments, the predictive data analytics module 50 and/or food service material printing module 40 may be configured to determine a message to provide from among a plurality of messages. Such a determination may be based on a prediction of what type of message may drive a desired output from the customer. For example, certain products, time windows, promotions, or limited-time-offers may be associated with a set of available messages for driving customer action. Each of the messages in the set may approach that goal differently. For example, a first message (message 1) may provide a percentage off the product as an incentive; a second message (message 2) may offer a percentage off a related product that is often purchased with the product; or a third message (message 3) may offer extra loyalty reward points for purchasing the product. In some embodiments, the predictive data analytics module 50 and/or food service material printing module 40 may be configured to determine which of the messages to use for the specific customer that just placed an order based on personalization information and/or order information. For example, if the customer is close to reaching a threshold for their loyalty reward points, the predictive data analytics module 50 and/or food service material printing module 40 may determine that message 3 should be used to attempt to drive the customer to purchase the product (and reach a desirable loyalty reward point threshold). In response, the predictive data analytics module 50 and/or food service material printing module 40 may provide the determined message to the control architecture 15, the cup printer 70a, other modules, and/or other systems/devices (e.g., one or more dispenser(s)/printer(s) 90) to have the determined message printed on the food service material item for presentation to the customer with their food order.

In some embodiments, the predictive data analytics module 50 may be configured to determine one or more messages to provide to a third-party based on a plurality of requests for food service. For example, the predictive data analytics module 50 may consider a plurality of requests for food service during a specific time period and/or for a specific location/region and determine that a delivery service may likely require certain packaging needs (e.g., a certain number of heaters, bags, etc.). The predictive data analytics module 50 may be configured to send that information to the third party.

In some embodiments, the predictive data analytics module 50 and/or food service material printing module 40 may be configured to determine print information (e.g., personalization print information) that includes game features, such as game pieces. For example, the game pieces could be determined and printed on-demand, thereby removing such game pieces from inventory storage and limiting lost pieces/winning potential. This may also enable tracking of “winning” pieces, such as being able to link the winning game piece with a customer—since the customer that purchased the winning piece may be determined from the request for food service.

In some embodiments, the predictive data analytics module 50 and/or food service material printing module 40 may be configured to determine print information (e.g., personalization print information) that can be recognized by a user's device (e.g., through image recognition and/or computer readable marker detection such as quick response codes). In such example embodiments, an image and/or message may be printed on the food service material item and a customer may utilize their mobile device to interact with the printed information, such as by using a camera to perform image recognition of the printed image and/or message. In response, an application and/or message may be downloaded to and/or presented on their mobile device based on recognition of the printed image and/or message. The printed image and/or message may be determined based on personalization information such that it is targeted toward the customer.

In some embodiments, the predictive data analytics module 50 and/or food service material printing module 40 may be configured to determine print information (e.g., personalization print information) based on the location of the customer and/or store. For example, one or more messages could be determined to target a nearby promotion, event, store, etc. In such a regard, the location of the customer at the time of the request and/or the location of the store for picking up the food order may be utilized in determination of the print information.

In some embodiments, the system may be configured to enable printing of information related to storage or other functions that may be useful for the store. For example, the system may be configured to enable printing on food service material items that may be used by the store, such as for storage. In such a regard, the printer may be configured to print relevant storage data, such as a package date, what food item is being stored, a use by date, etc.

In some embodiments, the system may be configured to enable reprinting of the food service material item, such as if an error occurred or the food service material item was accidently dropped on the floor. In some such embodiments, an operator may request the “last” print job, a certain order number, or other identifier to cause the relevant food service material item to be reprinted. In some such embodiments, the printer may be configured to receive voice commands, such as to enable reprinting. For example, a food service person may say “Printer, reprint the last order” or “Reprint Order 271”. In response, the printer may reprint the appropriate printed information on a new food service material item.

### Example Cup Printing and Printers

FIG. 10 illustrates example on-demand printing on a cup and packaging of a food order. In the depicted embodiment, a cup printer 470a has printed and dispensed a cup 475a. The printed cup 475a includes personalization print information and order print information 444, such as described herein. The food service person 418 is able to retrieve the printed cup 475a and fill the cup with the desired beverage, for example. Alternatively, as otherwise discussed herein, the system may automatically transfer the printed cup 475a to a cup filler for filling, and in some aspects, a cup closer for closing the filled cup. As shown with respect to a second printed food service material item (e.g., a food wrap 475b for a hamburger 421), the food service person 418 is able to package the food order (e.g., the cup 475a and the hamburger 421) in order to fulfill the food service request. The result is a packaged food order 479 with personalization print information and/or order information printed and presented to the customer with their food order.

Though the above described example details an example printed cup in combination with a printed food service material item of food wrap, in some embodiments, the on-demand cup printing/dispensing may occur independent from other printed food service material items. Likewise, many different food service material items are contemplated for such on-demand printing with example cup dispenser systems described herein (e.g., a bag dispenser/printer, a food tray liner dispenser/printer, etc.). In such a regard, depending on the available or desired food service material item, the one or more cup printers 70a and other printers/dispensers 90 may be configured to enable printing thereon (e.g., utilize the proper ink for the material, store the desired material for the food service material item, etc.).

In addition to a printer of one or more cups (e.g., beverage cups, soup containers, ice cream containers) as otherwise discussed herein, systems incorporating the same may include one or more additional dispensers for on-demand printed cups (e.g., cups of a different size and/or style) and/or one or more additional dispensers of on-demand printed food service material items including a food wrap (e.g., paper, foil, partially translucent paper, etc.) for wrapping a portion of the food order, a pouch for at least partially containing or covering the food order, a container for at least partially containing or covering the food order, a cup lid for covering the food order, a tray liner for use with the food order, a bag (e.g., in store bag, carry out bag, etc.) for at least partially containing the food order, or a napkin for use with the food order. In some embodiments, the food service material item may be one or more food packages that are configured to at least partially cover or contain the food order. Example food packages may include, at least, food wrap for wrapping the food order, container(s) for at least partially containing or covering the food order, a pouch for at least partially containing or covering the food order, a bag for at least partially containing the food order, among others.

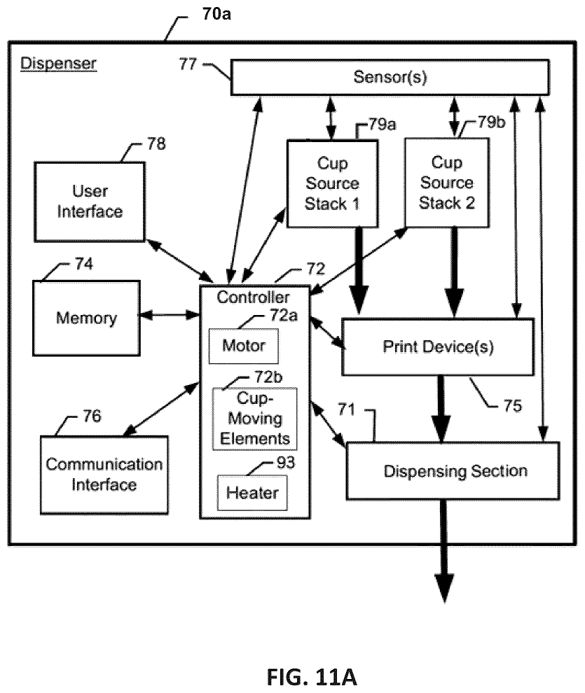

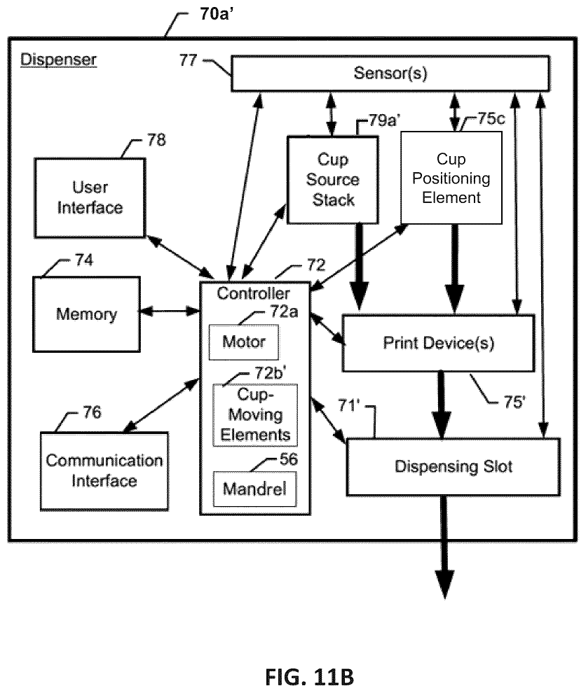

With reference now to FIG. 11A, an example cup printer 70a may comprise hardware and/or software capable of performing various functions described herein. In this regard, the cup printer 70a may include a controller 72, a motor 72a, cup-moving elements 72b, a memory 74, a communication interface 76, a user interface 78, one or more cup supplies (e.g., Cup Source Stack 1 79a and Cup Source Stack 2 79b), one or more print devices 75, one or more dispensing or transfer sections 71, and one or more sensor(s) 77.

The controller 72 may be configured to execute various programmed operations or instructions stored in a memory device and may be, for example, a device comprising a processor or circuitry operating in accordance with software or otherwise embodied in hardware or a combination of hardware and software, thereby configuring the device or circuitry to perform the corresponding functions of the controller 72 as described herein. In this regard, the controller 72 may be configured to receive one or more instructions for printing, such as through the communication interface 76. In some embodiments, the controller 72 may be configured to determine, process, and/or choose the determined cup to be printed from among a plurality of available cups (e.g., either a first cup from Cup Source Stack 1 79a or a second cup from Cup Source Stack 2 79b). In some embodiments, the controller 72 may be configured to cause printing on one or more of the cups (such as through the print device(s) 75). In some embodiments, the controller 72 may be configured to cause dispensing of the printed cup(s), such as using the dispensing/transfer section 71. In some embodiments, the controller 72 may configured to cause transfer of the printed cup(s) from the dispensing/transfer section 71 to one or more downstream devices such as a cup filler. In some embodiments, the controller 72 may cause monitoring, such as through sensor(s) 77, of supply materials of the printer (such as ink for the print devices 75 and/or cups from the supplies 79a, 79b). The controller 72 may also be configured to send gathered information and/or instructions to other devices, systems, or modules to perform various functions described herein. In some embodiments, the controller 72 may be configured to operate according to one or more modules described herein. For example, in some embodiments, the controller 72 may be configured to operate according to the control architecture 15, such as the food service material printing module 40.

The one or more cup supplies 79a, 79b may be configured to hold and/or store one or more cups to be printed. For example, the cup printer 70a, depending on the configuration, may be configured to hold a stack of cups as shown, though other cup source options are contemplated, such as lines of cups, a single cup, etc. In the depicted embodiment, the cup printer 70a includes two supplies 79a, 79b. In some embodiments, the supplies 79a, 79b may hold the same type of cup (e.g., both may hold a cold beverage cup of the same size). In such a situation, the cup printer 70a may be enabled to switch to printing from a primary supply to a secondary supply when the primary supply is depleted. In some embodiments, the supplies 79a, 79b may hold different types of cups (e.g., two cups of different materials depending on the temperature of the beverage or food to be stored therewithin) and/or different sizes of cups (e.g., two cups of the same material but of different sizes). In some embodiments, for example, the cups for each supply 79a, 79b may differ in at least one material characteristic, such as composition (e.g., paper, plastic, composite, etc.), weight, dimensions, etc. In some such embodiments, the cup printer 70a may be configured to choose which supply to use for printing. In some embodiments, the food service material printing module 40 may be configured to determine which type of cup to print on, and instruct the cup printer 70a accordingly.

The one or more print devices 75 may be configured to print on one or more cups simultaneously or sequentially, such as from one of the supplies 79a, 79b. In some embodiments, the print device 75 includes ink that enables the printing, such as provided from one or more ink cartridges, tanks, reservoirs, etc. In some embodiments, the print devices 75 and/or cup printer 70a may be configured such that only proprietary ink cartridges may be utilized with the cup printer 70a (e.g., non-proprietary ink cartridges may be locked out). The ink may be specially configured based on the cup, desired print quality, or other factors (e.g., safety, durability, etc.). In some embodiments, the print device(s) 75 may be configured to utilize different print characteristics for different types of cups (e.g., cups of different materials). For example, depending on which cup is selected for printing (such as from supplies 79a,b), the print device(s) 75 may be configured to employ different print characteristics, such as different ink (e.g., UV curable ink for plastic cups), different settings, different components, (e.g., rollers and/or presses), etc.

In some embodiments, the print devices 75 are configured to print the order print information and the personalization print information on the cup(s). In some embodiments, the print devices 75 may include a printer head (e.g., such as an ink jet printer head), mandrels, rollers, presses, belts, or other hardware necessary for performing the printing. In some embodiments, the print devices 75 may be configured to print on multiple surfaces or portions of the cup. For example, the print device 75 may be configured to print order print information on a first surface or portion and personalization print information on a second surface or position (e.g., a front and back of a cup from the perspective of the consumer).

The dispensing/transfer section 71 may be configured to cause dispensing and/or transfer of printed food service material items. In some embodiments, the cup printer 70a may include rollers, transfer systems, mandrels, or other hardware for effecting transfer of the food service material item through the components of the cup printer and out of the dispenser for the food service provider/person (e.g., along a path through the dispenser) or to another device (e.g., a cup filler). In some embodiments, the cup printer 70a may include one or more chutes for guiding the food service material, such as toward the dispensing/transfer section or to a cup filling device.

One or more motors 72a may be used to operate various features/components of the cup printer 70a. In some embodiments, the controller 72 may be configured to operate the motor(s) 72a accordingly. For example, one or more motors 72a may be used to drive one or more cup moving elements 72b to cause one or more cups to move through the cup printer 70a, to interact with the print devices 75, to be manipulated within the dispensing/transfer section 71, etc. In some embodiments, the controller 72 may be configured to control the motor 72a to cause printing of a cup, such as a cup of a specific style and/or size.

The cup printer 70a may also include one or more cup-moving structures/features (e.g., cup-moving elements 72b) that may be used to enable movement of the cup from one or more of the cup sources 79a,b through the cup printer and its various components and into the dispensing/transfer section 71. Some example structures include at least one cup source removal structure (e.g., a singulator) for separating a single cup from the cup source, a cup movement structure for causing the cup to move from the cup source to a printing position for being printed on by the print device 75, and a cup rotation structure for causing the cup to rotate (e.g., about its central axis) for printing and/or for presentation of the printed cup to a food service provider within the dispensing/transfer section.

In some example embodiments, a cup source removal structure can also be provided to remove a cup from one or more of the cup sources. In some embodiments, the cup movement structure(s) can cause a cup from the Cup Source Stack 1 79a′ to be moved to a first printing position and/or a cup from the Cup Source Stack 2 79b′ to be moved to a second printing position different from the first printing position. While a dedicated print device 75 may include a printer head for each of the first and second printing positions, in some embodiments the print device 75 can include a printer head for printing a cup disposed in either of the first and second printing positions.

The printer head and a cup disposed in one of the first and second printing positions can have a variety of orientations relative to one another and can move relative to another in a variety of manners. By way of example, a cup may be stationary while a printer head moves about the cup during printing thereof. In such aspects, the cup may be disposed in a vertical or horizontal orientation during movement of the printer head thereabout (e.g., along and around the sidewall). Alternatively, in some example aspects, a cup may be rotated about its central axis while the printer head translates along a sidewall of the cup. By way of example, in some embodiments, the printer head can translate horizontally in two dimensions above each of the first and second printing positions for printing of a cup disposed thereat. In some embodiments, the printer head can be configured to translate in at least one horizontal dimension while a cup in the printing position is rotated about its central axis during printing thereof. In some aspects, coordinated movement of the printer head and rotation of the cup may be provided (e.g., via controller 72) such that a desired design may be printed on the sidewall of the cup. In some aspects, the printer head can be maintained in a fixed vertical position during horizontal translation over one or more of the printing positions.

The one or more sensor(s) 77 may be configured to monitor various components or supplies of the cup printer 70a or various features corresponding to the cup bring printed and dispensed. For example, in some embodiments, the one or more sensors 77 may be configured to monitor the available ink for the print device(s) 75. In such embodiments, the controller 72, such as through one or more modules of the system 10 (e.g., the food service printing module 40), may determine when replacement ink is needed and, in some cases, perform automatic ordering thereof. Similarly, in some embodiments, the one or more sensors 77 may be configured to monitor the available cup supply, such as from supplies 79a, 79b. In such embodiments, the controller 72 may determine when replacement cups are needed and, in some cases, perform automatic ordering thereof. In some embodiments, the controller 72 may provide one or more messages/indications to be sent to the food service business indicating a need to supply more ink or cups for the cup printer 70a. In some embodiments, the one or more sensor(s) 77 may be a seam sensor that is configured to detect a seam of the sidewall of the cup, such as described herein.

The memory 74 may be configured to store instructions, computer program code, order data (e.g., order information), order print information, personalization information, personalization print information, and other data/information associated with the cup printer 70a in a non-transitory computer readable medium for use, such as by the controller 72.

The communication interface 76 may be configured to enable connection to external systems (e.g., an external network 12, one or more food request systems 80, one or more other food service material dispenser(s) 90, a customer's mobile device, a computer server, the control architecture 15, and/or one or more other system(s)/device(s)). In some embodiments, the communication interface 76 may comprise one or more transmitters configured to transmit, for example, one or more signals according to example embodiments described herein. Likewise, the communication interface 76 may include at least one receiver configured to, for example, receive data according to example embodiments described herein. In some embodiments, the transmitter and receiver may be combined as a transceiver. In this regard, the cup printer 70a may be configured for wired and/or wireless communication. In some embodiments, the communication interface 76 may comprise wireless capabilities for WiFi, Bluetooth, or other wireless protocols. In some embodiments, the cup printer 70a may be connected, such as through Bluetooth, to one or more food request/POS system(s) 80 such as to enable performance of various functions herein.

The user interface 78 may be configured to receive input from a user and/or provide output to a user. The user interface 78 may include, for example, a display, a keyboard, keypad, function keys, mouse, scrolling device, input/output ports, touch screen, or any other mechanism by which a user may interface with the system. Although the user interface 78 is shown as being directly connected to the controller 72 and within the cup printer 70a, the user interface 78 could alternatively be remote from the controller 72 and/or cup printer 70a. Likewise, in some embodiments, other components of the cup printer 70a could be remotely located.

The dispenser of FIG. 11A also includes one or more heaters 93 for increasing the temperature of at least a portion of the cup printer 70a, for example, to raise a temperature of a cup before, during, or after printing so as to dry ink printed thereon. In some related embodiments, for example, one of the sensors 77 may comprise a temperature sensor for detecting the temperature within the cup printer 70a, for example, at or near one or more of the printing positions such that the controller 72 can selectively operate the heater(s) 93 to maintain a sufficient temperature for drying the ink prior to dispensing the printed cup or transferring the printed cup to a cup filler.

FIG. 11B illustrates another example cup printer 70a′ for on-demand printing of cups for use in a food service order. While the depicted cup printer 70a′ includes a Cup Source Stack 79a′, other cup source options are contemplated, such as a plurality of cup source stacks, lines of cups, a single cup, etc. In some example embodiments, the Cup Source Stack 79a′ can maintain the stack of cups in a vertical orientation. The depicted cup printer 70a′ also includes cup-moving elements 72b′ that are configured to enable movement of the cup from the cup source through the cup printer 70a′ and its various components. In some embodiments, the cup-moving elements 72b′ can orient, rotate, or otherwise move a cup maintained in a vertical orientation at the cup source to a printing position in which the cup is in a horizontal orientation for printing by the printing device 75′.

In some embodiments, the cup-moving elements 72b′ can move the cup into engagement with a mandrel 56 for rotating the cup about its central axis when disposed in a horizontal orientation at the printing position. In some embodiments, the printer head can be configured to translate in at least one horizontal dimension while the mandrel causes rotation of the cup about its central axis in a horizontal orientation during printing thereof.

In some embodiments, the mandrel may maintain the cup in an orientation during printing thereof such that at least a portion of the sidewall of a tapered cup to be printed is horizontal. In some related embodiments, the printer head translates in a horizontal plane while nonetheless maintaining a fixed distance relative to a portion of the tapered sidewall during printing thereof. In some embodiments, a cup positioning element 75c is provided for balancing or otherwise centering the cup on the mandrel 56 in the horizontal orientation at the printing position.

In some embodiments, the printer head may maintain a substantially fixed position while the cup rotates about its axis to print around the perimeter of the cup. Alternatively, the cup may maintain a specific angular orientation about its central axis while the printer head translates along a sidewall of the cup to print extending along the length of the cup, for example. In some aspects, coordinated movement of the printer head and rotation of the cup may be provided (e.g., via controller 72) such that a desired design may be printed on the sidewall of the cup. In some embodiments, one or more of the sensors 77 may comprise a seam sensor for detecting the position of a cup's seam, such as described herein. In some aspects, ejection of ink from the print device 75′ and/or rotation of the cup may be coordinated such that the printer does not print on the cup seam.

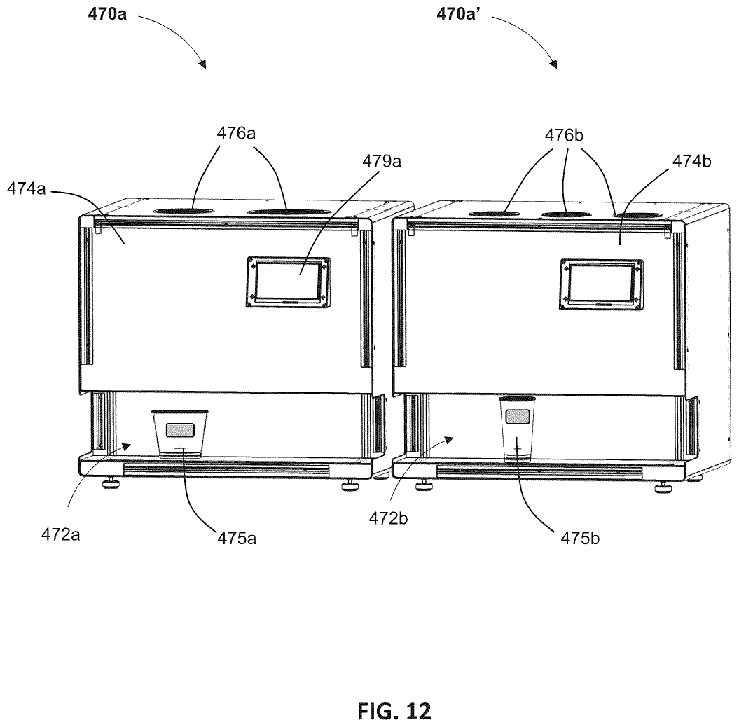

FIG. 12 illustrates two example cup dispensers 470a, 470a′ for use with an example on-demand cup dispensing system. In such a system, the system includes a first cup printer 470a that is configured to print on a first type of cup of various sizes (e.g., a small and large containers for holding hot contents such as soup). The system also includes a second cup printer 470a′ that is configured to print on and dispense a second type of cup of various sizes (e.g., a small, medium, and large cold beverage cups). In the depicted embodiment, the system has determined that a small soup container and a medium beverage cup are needed for the current food order and, thus, printed on and dispensed a printed small soup container 475a using the first cup printer 470a and a medium beverage cup 475b using the second cup printer 470a′. In some embodiments, the system may determine, for example, that both a small and medium beverage cup are needed for a food order such that the second cup printer 470a′ may print the different sized beverage cups sequentially or simultaneously. Though cup printers 470a, 470a′ are depicted as being disposed side-by-side, it will be appreciated that the dispensers may be disposed in different locations depending on the configuration of the store (and each of which may be associated with a cup filler and/or cup closer as otherwise discussed herein). For example, the soup cup printer 470a may be located adjacent to the soup station in back-of-house (BOH), while the beverage printer 470a′ may be located in front-of-house (FOH) or drive-through area for immediate filling of the beverage portion of the food order. Alternatively, though shown as separate cup printers 471a, 471b) for different types of cups in FIG. 12, in some embodiments, a single dispenser may be configured to print on both types of cups.

It will also be appreciated in light of the present teachings that each cup printers 470a, 470a′ may comprise a housing 474a, 474b that may be sized to maintain a small and/or desired footprint. For example, there may be limited space in the store and it may be desirable to position the on-demand cup printer(s) near or within the food service preparation line (e.g., to allow the food service person to easily and quickly retrieve the printed food service material item for use in preparing the food order). In some embodiments, the system may be designed such that one or more of the printers 470a, 470a′ are positioned within a certain proximity of one or more food request systems 80. By way of non-limiting example, the dispenser(s) may be within 30-45 feet of at least one of a self-order kiosk or a point-of-sale operator terminal. Indeed, one benefit of the present system is to provide on-demand printing capability for food service material items for use during preparation of the food order and, thus, designing the dispenser to be positioned proximate the food order preparation area corresponding to the contents of the cup(s) to be dispensed and ultimately filled may be desirable to maintain efficient food order preparation. In some embodiments, due to the close proximity of the food request system and printer, Bluetooth communication between the two devices/systems could be utilized. Along similar lines, in some embodiments, the cup dispenser may additionally include or be coupled to a filling system or device (e.g., for filling the cup with the appropriate beverage, soup, etc.) and/or a lidding system or device (e.g., for sealing the open end of the cup that has been filled via a lid or seal).

Returning to FIG. 12, the example cup printer 470a includes a housing 474a that is configured to maintain two vertical stacks of differently-sized cups (e.g., soup containers), each stack of which may extend upward from the top of the housing 474a through supply holes 476a in the top of the housing 474a. Similarly, the example cup printer 470a″ includes a housing 474b that is configured to maintain three vertical stacks of differently-sized cups (e.g., cold beverage cups), each stack of which may extend upward from the top of the housing 474b through supply holes 476b in the top of the housing 474b. As otherwise discussed herein, a cup from each stack of cups in each cup printer may be removed sequentially or simultaneously and printed within the housing for moving to the corresponding dispensing/transfer section 472a, 472b to allow a user to access the printed cups or to allow the printed cup to be transferred to a downstream module (e.g., a cup filler 70b). It will also be appreciated that a single cup, for example, may be manually loaded (e.g., placed within the supply holes) for printing by the cup printer(s) 470a, 470a′. In some embodiments, a food service provider may press a button (e.g., on user interface 479a) to initiate the manual load feature. Additionally, the cup printers 470a, 470a′ may be designed to enable access to the internal housing for maintenance, replacement of ink or food service material item supply, etc. For example, one or more of the outer panels of cup printers 470a, 470a′ may be opened and/or removed to enable access to the various internal components. As noted herein, in some embodiments, the integrated system may enable optional use of the printer, such that an un-printed (or pre-printed) cup could be utilized in the system. In this regard, the cup printer (or features thereof) may be selectively applied.

Each cup printer 470a, 470a′ also respectively includes a user interface (e.g., user interface 479a) that can be used to display information to the food service provider and/or enable functionality, such as through button(s) and/or touchscreen(s). For example, the user interfaces 479a may display the current food service material item that is being prepared by the cup printer 470a. Additionally, the user interface 471a may provide maintenance information to a nearby food service provider, such as if the ink needs replacement, if the cups are nearly depleted, error messages, etc. In some embodiments, such information may (additionally or alternatively) be provided through wireless or wired communication element (e.g., the communication interface 76 shown and described with respect to FIG. 11A) in communication with a remote computing device, such as for use with various embodiments of the present invention described herein (e.g., with/in an on-demand food service printing system).

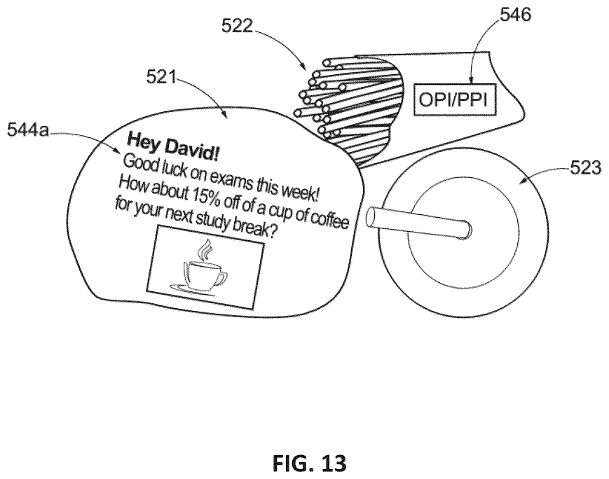

FIG. 13 shows example food orders, where portions of the food orders are packaged in various food service material with printed information thereon. For example, a hamburger 521 has been wrapped with a food wrap that has personalization print information 544a printed and oriented to face the customer upon presentation of their food order. In the depicted embodiment, the fries 522 are provided in a pouch that also has order print information (OPI) and/or personalization print information (PPI) 546 printed thereon. In some embodiments, the cup 523 may include printed information (such as personalization print information) in accordance with various embodiments of the present teachings.

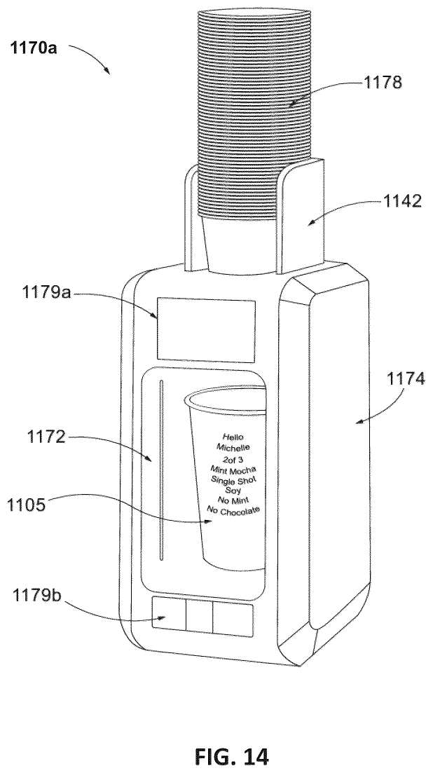

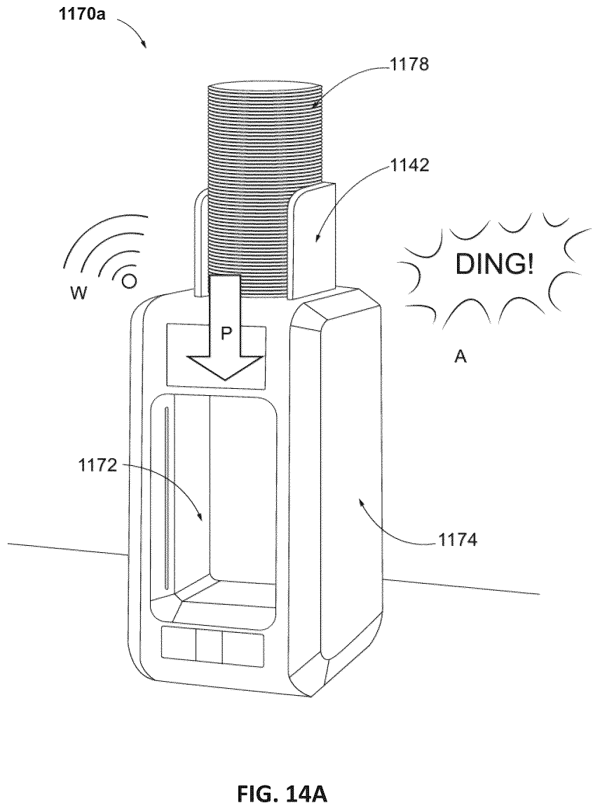

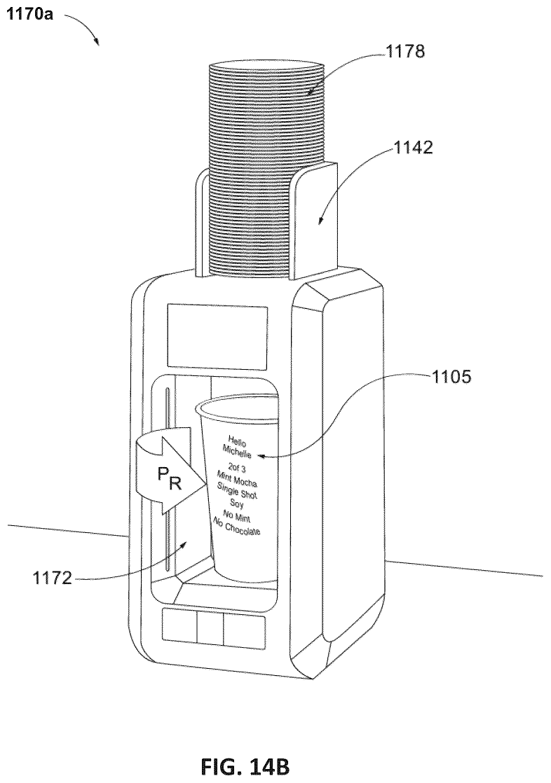

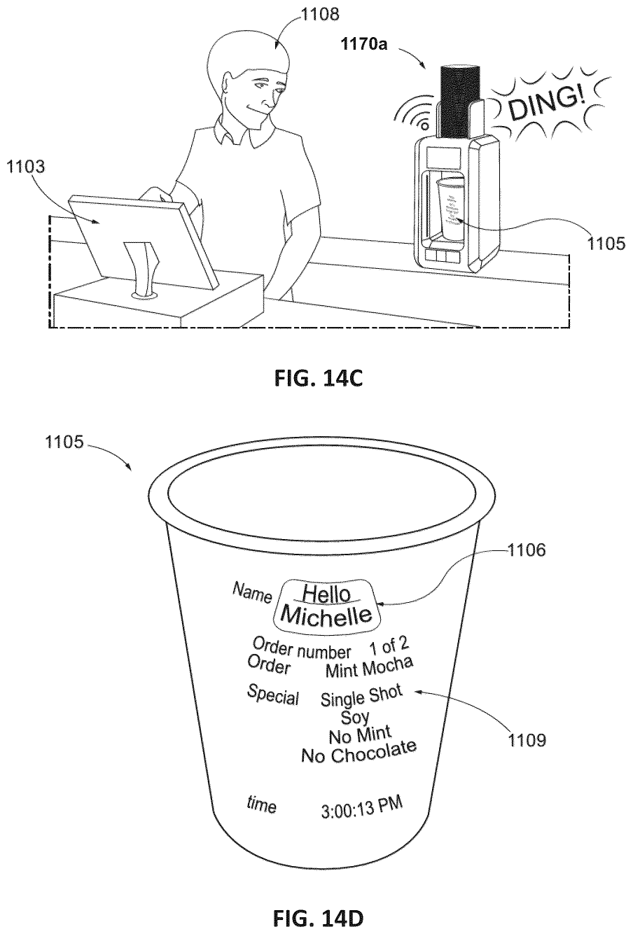

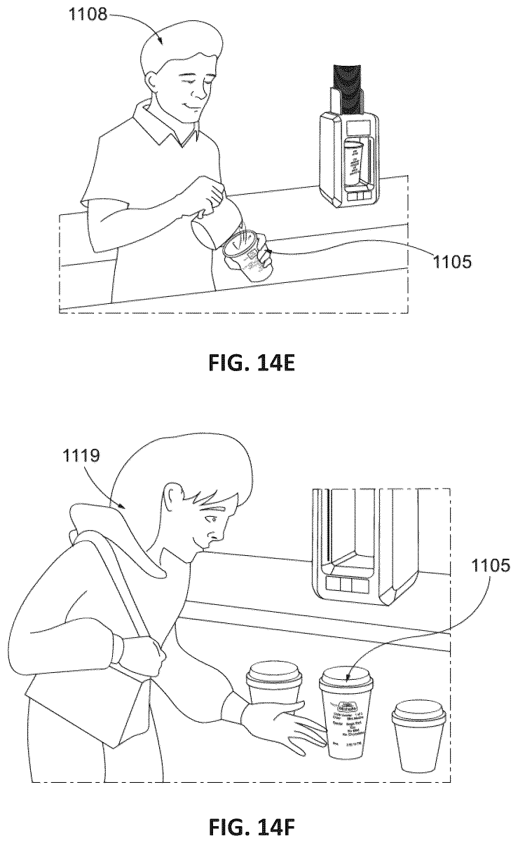

FIG. 14 illustrates an example cup printer 1170a in accordance with various example embodiments described herein (such as the cup printer 70a shown in FIG. 11A). The depicted cup printer 1170a includes a housing 1174 that is sized with a small footprint such as to fit on a counter and/or within a food service preparation area. The depicted cup printer 1170a includes a cup source 1142 that holds a stack of cups 1178. Additionally, the cup printer 1170a includes a user interface in the form of a screen 1179a and buttons 1179b. The screen 1179a can be used to display information to the food service provider. For example, the user interface 1179a may display the cup order that is being prepared by the printer 1170a. Additionally, the user interface 1179a may provide maintenance information to a nearby food service provider, such as if the ink needs replacement, if the stack of cups is nearly depleted, error messages, etc. In some embodiments, such information may (additionally or alternatively) be provided through wireless or wired communications with a remote computing device. The printer 1170a also includes a dispensing/transfer slot 1172 that enables a food service provider to collect a printed cup 1105 therefrom and/or to allow a cup transfer element to transfer the printed cup to one or more downstream elements such as a cup filler 70b as otherwise discussed herein.

With reference to FIG. 14A, upon receiving a food service order, such as from a remote food service request module (e.g., the point of sale computing device 1103 shown in FIG. 14C) through a wireless connection W, the cup printer 1170a may provide an alert A to indicate that it has received the order and is beginning preparation of the printed cup. One or more cup-moving elements (not shown) may cause a single cup to move along a path into the dispenser (e.g., along arrow P). In the depicted embodiment, a cup is separated from the stack of cups 1178 and moves from the cup source 1142 into the dispensing slot 1172. In some embodiments, the force of gravity may assist with movement of the cup.

With reference to FIG. 14B, a print device (not shown) may print order information and/or personalization information on the cup 1105. After printing, a cup-rotation element may cause the printed cup to rotate, such as for presentation to a food service provider. In some embodiments, a door may be used to block access to the cup, such as during printing. Such an example door may be unlocked and/or automatically opened after printing is complete to enable retrieval of the printed cup by the food service provider. Alternatively, the door may be opened to allow a cup transfer element to transfer the printed cup to one or more downstream elements such as a cup filler 70b as otherwise discussed herein.

FIG. 14C illustrates dispensing of a printed cup 1105 using the cup printer 1170a. In the illustrated example, a food service provider 1108 may be alerted (e.g., the “Ding”) to completion of the printed cup (although other types of alerts are contemplated, such as visual, text message, voice, vibration, etc.). Alternatively, a controller (not shown) may be alerted to completion of the printed cup such that a cup transfer element may transfer the printed cup to one or more downstream elements such as a cup filler 70b as otherwise discussed herein.

FIG. 14D illustrates an example printed cup 1105 that includes personalization information 1106 (e.g., the customer's name “Michelle”) and order information 1109 (e.g., “Mint Mocha” and corresponding special instructions, such as “No Chocolate”). Once the food service provider 1108 has retrieved the printed cup, they can use the order information printed directly on the cup to help in preparation of the appropriate food service order (e.g., illustrated in FIG. 10E). Thereafter, the completed food order and corresponding printed cup 1105 can be placed out for gathering by the customer 1119 (e.g., illustrated in FIG. 14F). In this regard, the printed order information and/or personalization information enable easy identification of the appropriate food service order by the customer. Alternatively, as otherwise discussed herein, a cup filler and/or closer can receive the cup from the printer 1170a to fill and/or close the cup prior to dispensing the cup (e.g., making available) to the user (e.g., a food service person, the consumer, etc.). As above, the filled/closed cup may be retrieved and placed in another location (e.g., a counter), or may be available for pick up directly from the dispenser system.

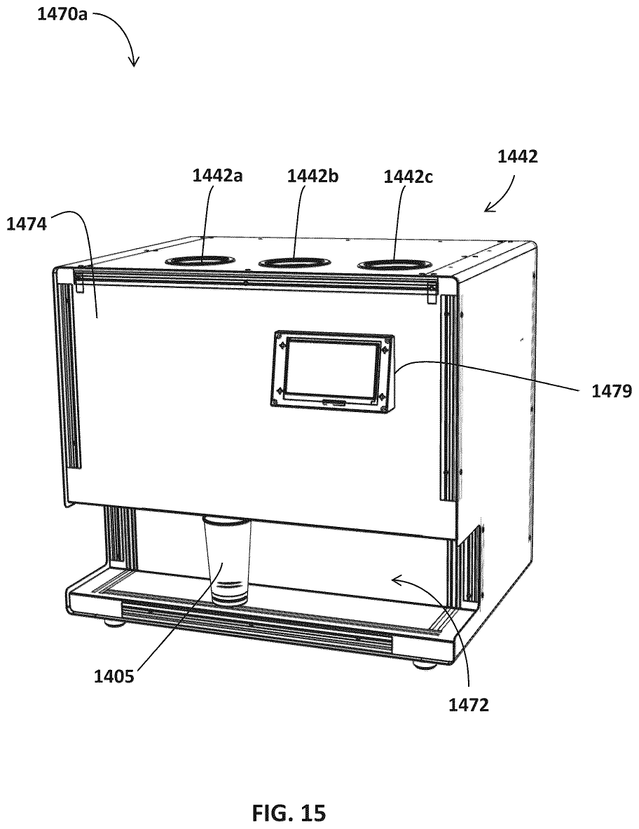

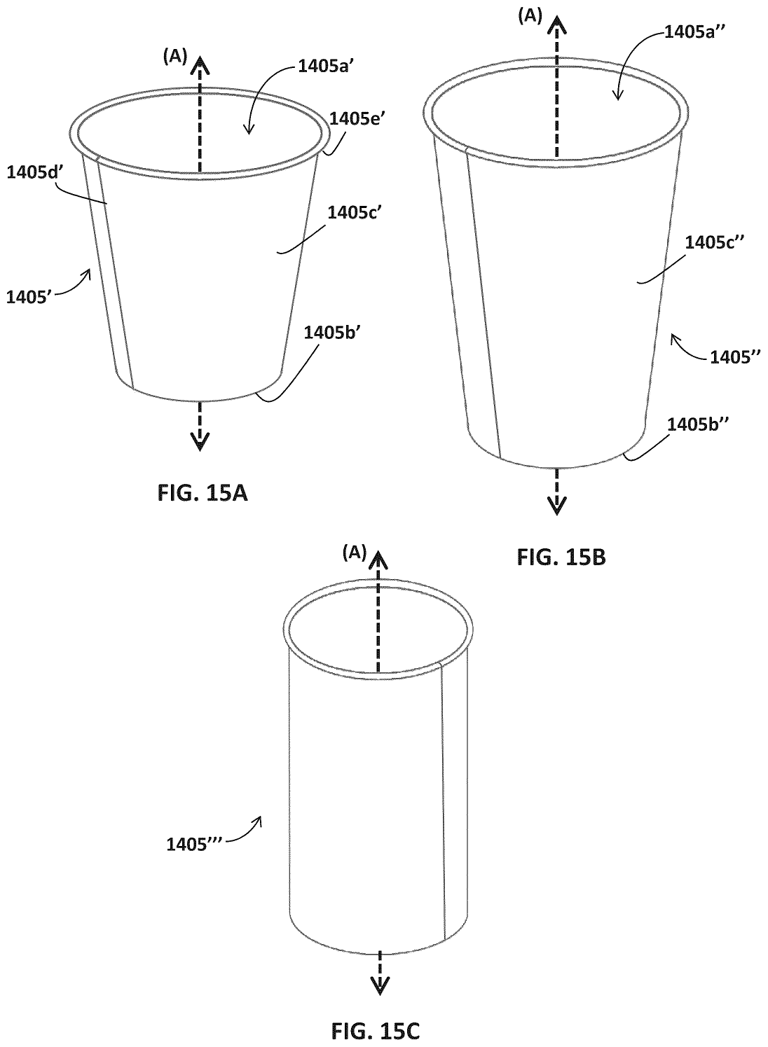

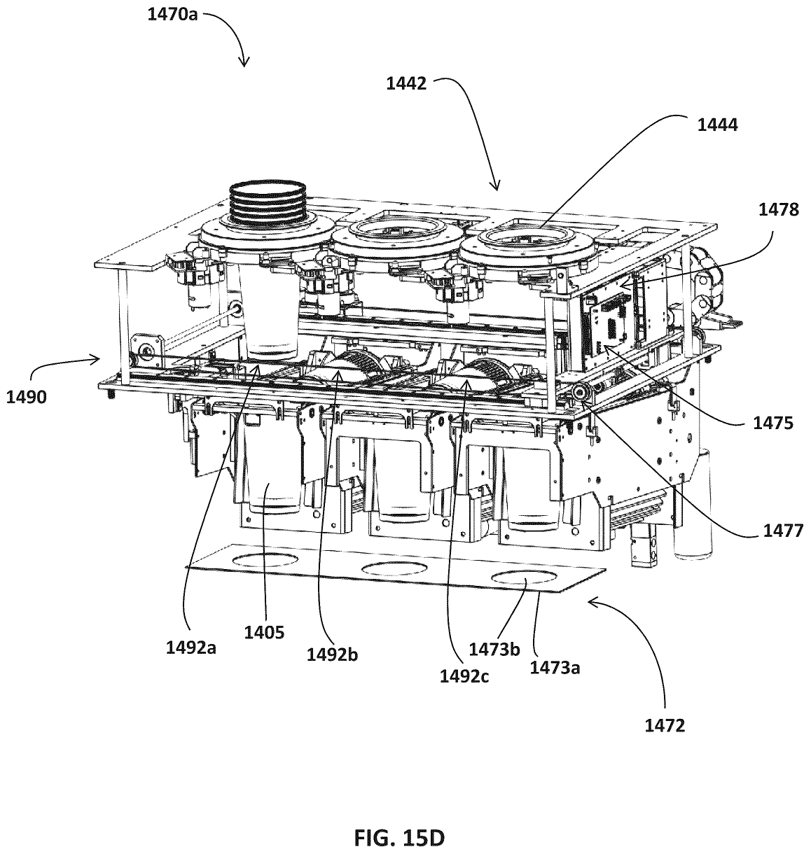

FIG. 15 illustrates another example cup printer 1470a in accordance with various example embodiments described herein (such as the printers 70a, 70a′ shown in FIGS. 11A-B). The depicted cup printer 1470a includes a housing 1474, such that may be sized to fit within a food service line. The printer 1470a has a cup source 1442 that is configured to hold one or more cups. As depicted in the embodiment of FIG. 15, for example, the cup source 1442 is configured to hold three stacks 1442a-c of cups to be printed by printer 1470a in a vertical orientation. By holding the stack of cups in a vertical orientation, the footprint of the printer 1470a may be reduced when disposed on a counter and/or within a food service preparation area. In some embodiments, the cup source may be designed such that the stacks of cups are in a different orientation, e.g., a generally horizontal orientation. Notably, in some embodiments, the designed cup pathway through the printer 1470a may be adjusted accordingly.

As discussed in detail below, in some embodiments, each stack of cups can comprise cups of a different volume (e.g., a stack of small cups, a stack of medium cups, and a stack of large cups) and/or cups of a different shape (e.g., three stacks of cups of different tapers).

Additionally, the cup printer 1470a includes a user interface in the form of a screen 1479 (e.g., a display, a touchscreen that enables selection of a displayed item, etc.), which can be used to display information to the food service provider. The user interface 1479, for example, may display the cup order that is being prepared by the dispenser 1470 and/or provide maintenance information to a nearby food service provider (e.g., a need for a new ink cartridge, cup replenishment, error messages, etc.). In some embodiments, such information may (additionally or alternatively) be provided through wireless or wired communications with a remote computing device. The printer 1470a also includes a dispensing/transfer section 1472 that enables a food service provider to collect a printed cup 1405 therefrom and/or to allow for automated transfer to a downstream device such as cup filler 70b of FIG. 1.

With reference now to FIGS. 15A-C, three cups suitable for use in printer 1470a are depicted. As shown in FIG. 15A, cup 1405′ represents a small cup extending from an open top end 1405a′ to a closed bottom end 1405b′. A sidewall 1405c′ extends between the open end 1405a′ and closed end 1405b′ so as to define a volume within which a beverage may be contained. As shown, cup 1405′ exhibits a central longitudinal axis (A) extending through the ends 1405a′, 1405b′ and along which the sidewall 1405c′ extends. The cup 1405′ is tapered in that the cross-sectional area of the cup 1405′ changes (e.g., decreases) along the length between the cup's open end 1405a′ and closed end 1405b′. As a result of this taper, it will be appreciated that the sidewall 1405c′ of cup 1405′ is not parallel to the central axis (A).

Cups suitable for use in dispensers of the present teachings can be made of a variety materials (e.g., plastic, paper, metal, combinations thereof) and can have a variety of configurations (e.g., unitary, multi-piece). In the example embodiment of FIG. 15A, cup 1405′ is made of paper (e.g., coated or uncoated) in which the sidewall 1405c′ is formed by joining (e.g., adhering) two ends of a planar sheet together to form a seam 1405d′. Likewise, as is known in the art, the closed bottom end 1405b′ can be a separate piece that is joined (e.g., adhered) to a lower portion of the sidewall 1405c′, thereby defining an inner volume within which a beverage can be retained. As shown, cup 1405′ additionally includes a lip 1405e′ (e.g., a rolled edge of the planar sheet) at the open end 1405a′, which can provide additional structural integrity to the cup and/or provide a location for a user and/or lid (not shown) to grip. Lip 1405e′ extends outwardly from the sidewall 1405c′ and includes a narrow, lower surface and an upper surface when the cup is disposed in the vertical orientation as shown in FIG. 15A. In some embodiments, multiple cups can be stacked upon one another by inserting the closed end and a portion of the sidewall of a first cup within the second cup until the lips of each cups engage one another, for example. It will be appreciated that cups can be stacked right-side up (e.g., as shown in FIG. 15A) or upside down (e.g., with the closed end 1405b′ disposed above open end 1405a′).

FIG. 15B depicts another example cup 1405″ suitable for use with dispenser 1470 in accordance with the present teachings. Cup 1405″ differs in both volume and shape from cup 1405′. Like cup 1405′, cup 1405″ is tapered in that the sidewall 1405c″ is not parallel to the central axis (A) of the cup 1405″. However, cup 1405″ differs from cup 1405′ in that cup 1405″ exhibits a longer distance between its open and closed ends 1405a″,b″ and defines a greater volume. As shown, cup 1405′ and cup 1405″ exhibit the same diameter as one another at their respective open and closed ends such that the sidewall 1405c″ of the longer cup 1405″ is closer to parallel with the central axis (A) than the sidewall 1045c′. That is, cup 1405″ exhibits a smaller taper, and thus, different shape relative to cup 1405′.

It will be appreciated, for example, that each stack of cups in dispenser 1470 can comprise a plurality of one type of the cups 1405′ and 1405″ (as well as a third stack of cups, which may the same as one or cups 1405′ and 1405″ or a stack of differently-sized and/or differently-shaped cups), which may be selectively removed from the respective stack, printed, and/or dispensed from dispenser 1470 in accordance with the food service order.

FIG. 15C also depicts an example cup 1405′″ suitable for use with dispenser 1470 in accordance with various aspects of the present teachings. Like the cups of FIGS. 15A-B, cup 1405′″ extends from an open end 1405a′″ to a closed end 1405b′″ along a sidewall 1405c′″, but differs in that the cup 1405′″ is cylindrical (e.g., instead of a truncated cone). That is, the sidewall 1405e′″ is substantially parallel to the central axis (A) along its entire length.

With reference again to FIG. 15, the housing 1474 includes one or more outer panels that can be opened and/or removed to enable access to various components of the printer 1470a, such as for maintenance or replacement of parts or features. For example, the printer 1470a may be designed to enable replacement of ink for the one or more print devices, as otherwise discussed herein.

FIG. 15D depicts the various outer panels of FIG. 15 removed such that various additional features of the example printer 1470a are visible. As shown in FIG. 15D, the example dispenser 1470a generally includes a cup source 1442, a printing module 1490 within which one or more cups may be disposed during printing thereof, and a dispensing/transfer section 1472 that enables a food service provider to collect a printed cup 1405 therefrom and/or to allow for automated transfer to a downstream device such as cup filler 70b of FIG. 1.

As shown, the example cup source 1442 includes three positions, each of which is configured to maintain a stack of cups in a vertical orientation (e.g., the central axis (A) of each cup is vertical), with the closed end of each cup facing downward and positioned such that additional cups can be refilled from the top of the printer 1470a, for example, as the quantity of cups remaining in the stack is depleted. As noted above, the cups of the stack maintained at each position may differ in at least one of volume and shape from the cups of the other two stacks (e.g., a stack of small cups, a stack of medium cups, and a stack of large cups). Only the leftmost position in the cup source 1442 is depicted as having a stack of cups mounted thereat in FIG. 15D. Although the depicted stack of cups is shown in a vertical orientation, other orientations are contemplated, including slightly off vertical, as well as horizontal (and various orientations therebetween). Accordingly, variations in the cup path between the cup source and the printer may be applied to achieve a corresponding printing and dispensing.

In the depicted example embodiment, each of the three positions of the cup source 1442 is additionally associated with a cup removal structure 1444, which is generally configured to separate a single cup from the stack of cups maintained at one of the positions of the cup source 1442 (e.g., based on a command by a controller that a particular size cup is to be printed based on a food service order or that the previous cup has been ejected from the printing module 1490). In some example embodiments as otherwise discussed herein, by maintaining the stack of cups in a vertical orientation and by positioning the cup source 1442 and cup removal structure 1444 generally above other elements of the printer 1470a, a cup 1405 removed from the stack by the removal structure 1444 may be placed or dropped (e.g., via gravity) into a position to be further manipulated within the cup printer 1470a. A person skilled in the art will appreciate that any of various mechanisms known in the art for removing a cup from a stack of cups and modified in accordance with the present teachings may be suitable for use in the printer 1470a. An exemplary cup removal structure suitable for use in accordance with the present teachings is described, for example, in U.S. Pat. No. 3,279,652 (the teachings of which are incorporated by reference in its entirety), which provides a rotating cam member that selectively engages the lip of the lowest cup in a stack to separate it therefrom.

As discussed in detail below, following separation from a stack of cups, a cup may be transported along a path within the printer 1470a to a printing position within the printing module 1490 such that a sidewall of the cup may be printed. As shown in FIG. 15D, the example printing module 1490 of dispenser 1470 includes three printing positions 1492a-c, each of which corresponds to one of the three stacks of cups maintained by the cup source 1442. Notably, though the cup may be maintained in a vertical orientation within the cup source 1442 (e.g., to conserve space), some embodiments of the present teachings advantageously move (e.g., reorient) the cup such that either the central axis (A) of the cup 1405 or a portion of the sidewall of cup extending between the open and closed ends 1405a′, 1405b′ is disposed in a horizontal orientation to facilitate printing as otherwise discussed herein. FIG. 15D depicts a cup disposed horizontally in each of the center and right printing positions 1492b,c.

One or more cups disposed in the printing positions depicted in FIG. 15D may then be printed on by one more printing devices 1475 of the printing module 1490. By way of example, in some embodiments, a plurality of printing devices can be provided, each of which may be responsible for printing a cup disposed in one of the respective printing positions 1492a-c. For example, each of the printing devices can comprise a printer head, each of which is configured to eject ink toward a sidewall of a cup disposed in only one of the three printer positions 1492a-c. In such embodiments and with the cup disposed in the horizontal orientation, each printer head may propel ink downwardly as the cup rotates substantially about its central axis (A) in order to deposit ink around the perimeter of the cup's sidewall. For example, the printer head may maintain a substantially fixed position while the cup rotates about its axis (A) in order to print around the perimeter of a cup. Alternatively, the cup may maintain a specific angular orientation about its central axis (A) while the printer head translates along the sidewall (e.g., substantially parallel to the sidewall in the horizontal orientation) in order to print extending along the length of the cup, for example. In some embodiments, each of the printer positions 1492a-c may be associated with a dedicated printer head that is only enabled to translate linearly (e.g., back and forth in a horizontal direction) along the sidewall (e.g., between the open and closed ends 1405a′, 1405b′). It will further be appreciated that a controller as otherwise discussed herein may coordinate the linear translation of each of the one or more printer heads, the ejection of ink thereby, and the rotation of the cup in each respective position 1492a-c such that the sidewall of each cup may have the intended design printed thereon.

In the example embodiment depicted in FIG. 15D, however, only a single printer head is provided for printing cups disposed at any of the plurality of printing positions 1492a-c. As shown in FIG. 15D, for example, the printing module 1490 may comprise a carriage 1478 to which the printer head is attached and which may travel along a gantry 1477 such that the printer head may be caused to translate horizontally in two dimensions, for example, first along the length of a sidewall of a cup disposed in the right printing position 1492c during printing thereof. When printing of such a cup in the right printing position 1492c has been completed, the printing device 1475 may then be caused to translate in an orthogonal, horizontal direction such that the printer head may be aligned with a cup disposed in one of the left or center printing positions 1492a,b. Upon alignment with one of these positions 1492a,b, the printer head may again translate linearly over and along the length of the respective cup in order to deposit ink on the uppermost portion of the sidewall of the cup now disposed thereunder. Again, it will be appreciated in light of the present teachings that a controller may coordinate the translation and/or alignment of each of the printer head, the ejection of ink thereby, and the rotation of the cup such that the entire sidewall of each cup may have the intended design printed thereon. Moreover, a person skilled in the art will appreciate that such an embodiment as depicted in FIG. 15D may reduce costs and/or complexity of the printer 1470a as a single printer head may be utilized to print cups disposed at different positions 1492a-c within the printing module 1490.

The one or more printer heads may be configured to print on one or more cups of the same or different sizes from the various stacks of cup from the cup source 1442. In this regard, the printer head may be positioned in the same horizontal plane when in each of the printing positions, but may need to adapt the relative printing distances anticipated from each jet based on the cup size being printed on. For example, the ink ejection pattern for printing a logo on a first cup size with a first taper may be different than the ink ejection pattern for printing the same logo on a second cup size with a different taper—where the goal is to have uniform appearance of the logo regardless of the size of the cup. In this regard, in some embodiments, the controller may be configured to determine the cup size being printed on (such as by determining which printing position is being utilized—e.g., if the corresponding cup stacks are maintained with a dedicated cup size). In some embodiments, one or more sensors (e.g., the seam sensor) may be used to determine the taper of the cup and the ink ejection pattern may be adjusted accordingly.

In some embodiments, the print device 1475 utilizes ink that enables the printing, such as provided from one or more ink cartridges, tanks, reservoirs, etc. that may also be stored within the housing 1474. In some embodiments, the print devices 1475 and/or printer 1470a may be configured such that only proprietary ink cartridges may be utilized with the printer 1470a, such as to ensure quality, etc. The ink may be specially configured based on the food service material item, desired print quality, or other factors (e.g., safety, durability, etc.).

Following printing a cup within the printing module 1490, the printed cup may be transported along a path within the printer 1470a to the dispensing/transfer section 1472 so as to provide a user such as a food service provider access to the printed cup and/or to allow for automated transfer to a downstream device such as cup filler 70b of FIG. 1. For example, as shown in FIG. 15D, a printed cup may be translated and/or rotated from its horizontal orientation in the printing position to a position above the dispensing/transfer section 1472, at which point the printed cup may be dropped or deposited within the dispensing/transfer section 1472. As shown, for example, the dispensing/transfer section 1472 may comprise a plate 1473a having one or more through holes 1473b through which a printed cup may only pass in a vertical orientation. As discussed above, in some embodiments, a cup rotation structure may also be provided to rotate the cup about its central axis (A), such as within the dispensing/transfer section 1472 (or prior to dropping into the dispensing/transfer section 1472), such that a desired portion of the sidewall of the printed cup is preferably displayed to a food service provider.

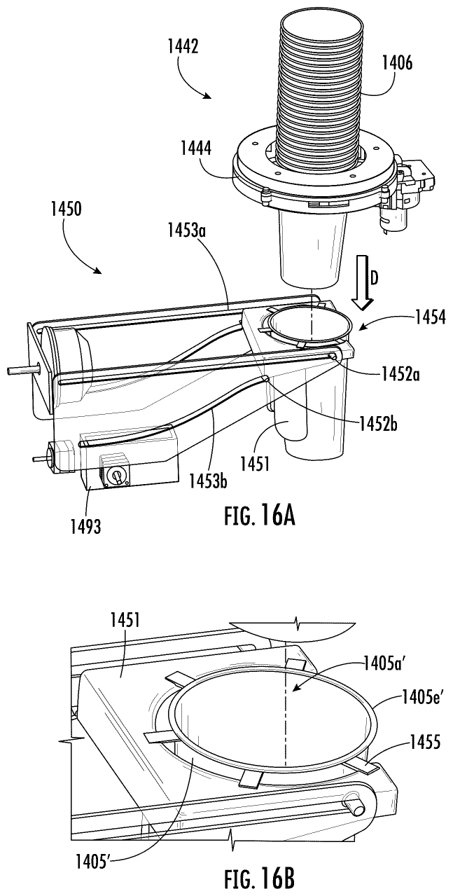

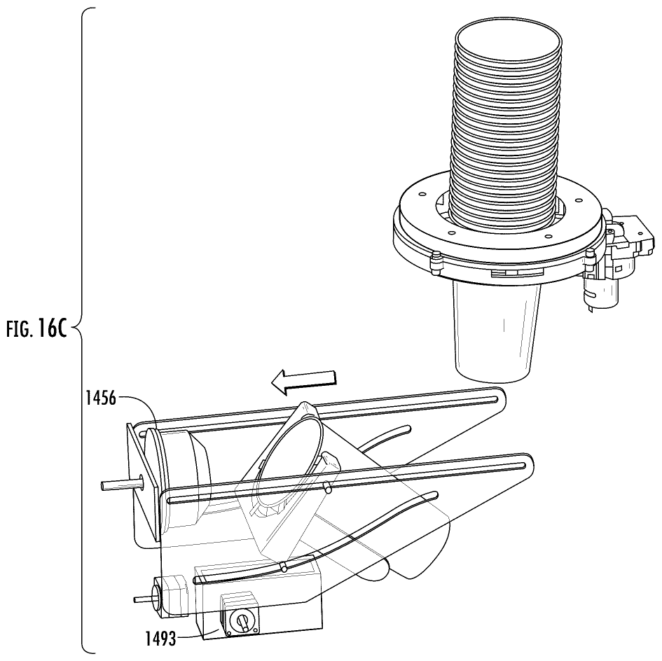

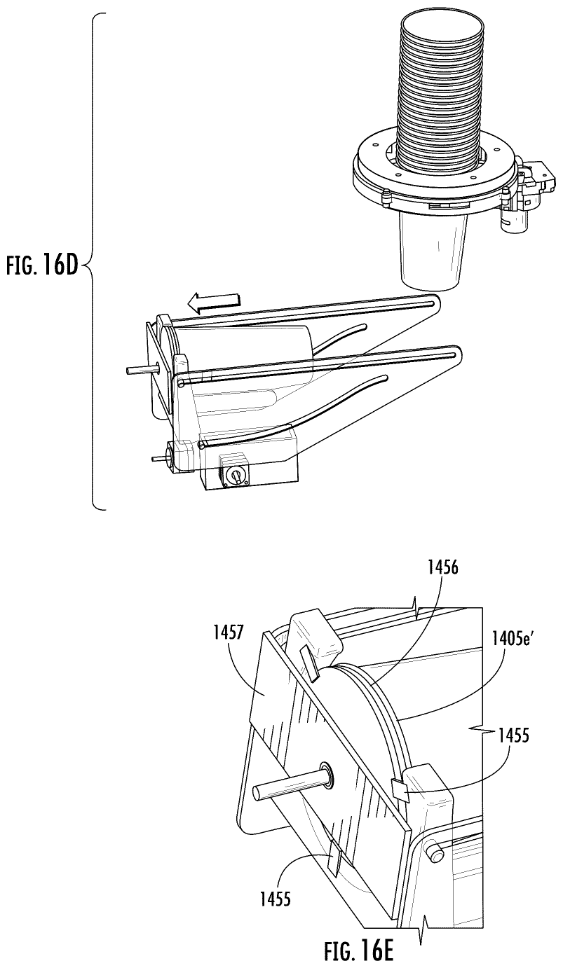

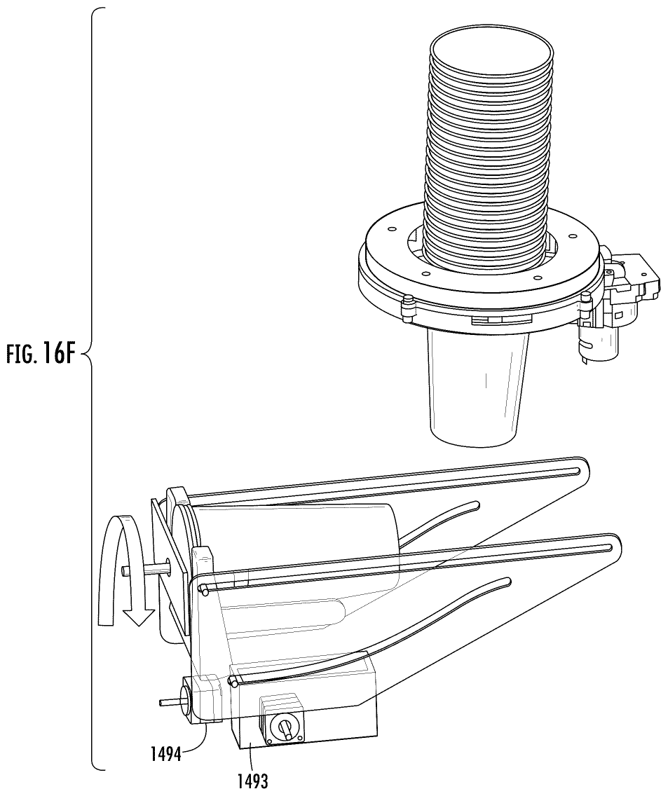

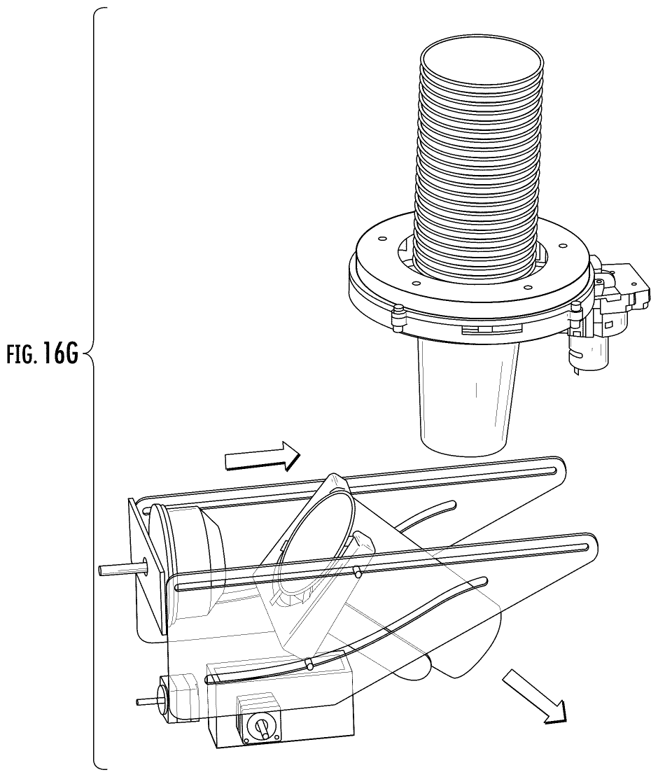

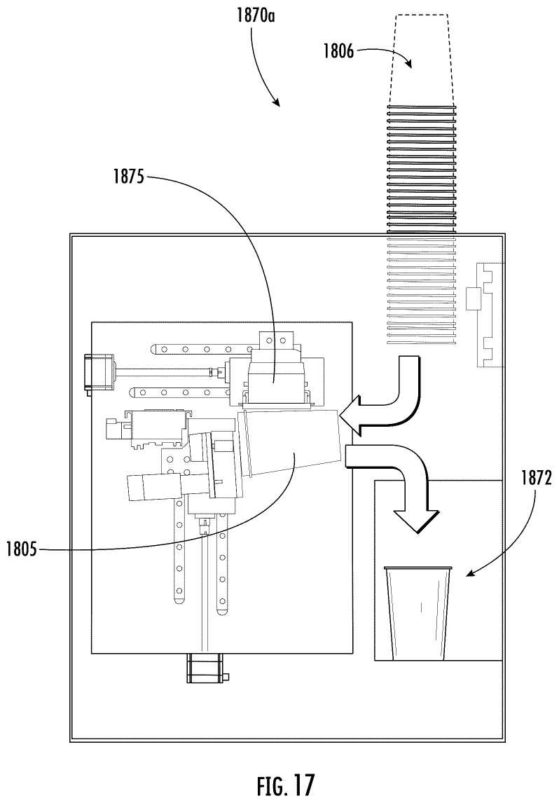

As noted above, a cup from a stack of cups at the cup source 1442 may be transported along a path to a printing position (e.g., 1492a) within the printer 1470a, and after printing, may be transported along a path from the printing position to the dispensing/transfer section 1472. In various embodiments, the various paths may at least partially overlap. A person skilled in the art will appreciate in light of the present teachings that various cup-moving elements may be utilized to move the cup along the one or more paths through the cup printer (e.g., cup printer 1470). With reference now to FIGS. 16A-G, an embodiment of such an example cup moving element suitable for use in the dispenser 1470a is depicted in additional detail. As shown in FIG. 16A, the example cup source 1442 maintains a stack of cups 1406 waiting to be dispensed in a vertical orientation, with the closed end of each cup facing downward. Upon receiving a food service order (e.g., from a remote food service request module), the cup printer 1470a may begin preparation of the printed cup, for example, by releasing a cup corresponding to the food service order from the stack for printing thereof (though cups may alternatively be pre-loaded within the printing module). As shown, the cup removal structure 1444 may be configured to separate the lowest cup from the stack of cups 1406 such that the separated cup moves into the dispenser as indicated by the arrow D of FIG. 16A. In some embodiments, the force of gravity may assist with movement of the cup from the cup source 1442 to a cup-moving element disposed below.

The example illustrated cup moving element comprises a sled 1451 that is configured to move along a support 1450 extending between the cup source 1442 and a printing position. In particular, the sled 1451 includes a plurality of protrusions 1452a,b extending therefrom that are slidably disposed within corresponding tracks 1453a,b, though a person skilled in the art that the sled can move along a track according to other mechanisms (e.g., rack and pinion). In the illustrated embodiment, the sled 1451 includes a first set of protrusions 1452a that are configured to slid along a first track 1453a and a second set of protrusions 1452b that are configured to slide along a second track 1453b.

In the depicted example, the sled 1451 additionally comprises a cup receiving opening 1454 that is sized and positioned to at least partially retain (e.g., encircle) the cup 1405′ that drops from the cup source 1442. As best shown in FIG. 16B, an upper surface of the opening is at least partially defined by a resilient shoulder 1455 (e.g., flanges), which exhibits a diameter slightly less than the maximum diameter of the lip 1405e′ of the cup 1405′. In this manner, when the cup to be printed is removed from the stack of cups, the shoulder 1455 engages the lower surface of the lip 1405e′ at the cup's open end 1405a′ as shown in FIG. 16B. After the shoulder 1455 engages the cup, one or more motors (e.g., under the control of a controller) may be utilized to cause the sled 1451 to move within the dispenser 1470 as the protrusions 1452a,b slide within the tracks 1453a,b. Though resilient, the shoulder 1455 is sufficiently stiff to push the cup through its engagement with the lip 1405e′. As shown, the tracks 1453a,b diverge with the lower second track 1453b being angled downwardly such that the sled 1451 moving therealong begins to rotate the cup 1405′ from its vertical orientation as shown in FIG. 16C to a horizontal orientation shown in FIG. 16D (e.g., the cup 1405′ is moved onto the mandrel 1456, as described herein).

In some embodiments, in order to ensure that ink ejected onto the cup is able to dry prior to delivery to the dispensing/transfer section, one or more heaters may be provided to increase the temperature within the housing and/or of the cup before, during, and/or after printing. In this regard, the one or more heaters may be used to preheat the cup (such as for adhesion of the ink), heat the cup during printing (such as to pin the ink to the cup), and/or heat the cup after printing is complete (such as to control drying/coalescing of the ink). Additionally, one or more reflectors or shielding elements may be provided to further enhance efficient heating and/or prevent undesirable heating from occurring to various dispenser components or cups. Various mechanisms are contemplated herein including, by way of example, the use of hot forced air and/or the use of radiative heating elements such as one or more infrared (IR) lamps. For example, with reference to FIG. 16C, one or more heating elements (e.g., IR lamp 1493) may be activated while the cup is being delivered to the printing position so as to pre-heat the prior to having ink ejected thereon. Additionally or alternatively, the IR lamp 1493 may be activated during printing of the cup (FIG. 16F) such that the perimeter of the sidewall upon which ink has been ejected may be exposed to the heating element(s) as the cup rotates about its central axis (A). Finally, the IR lamp 1493 may additionally or alternatively be activated after printing as the cup is being moved to the dispensing/transfer section (FIG. 16G) to ensure drying or curing of the ink prior to the cup being accessible by the user. In some embodiments, ultraviolet (UV) curing ink may be printed onto the cup (such as may be useful for plastic cups). In such example embodiments, the one or more heaters may apply UV light to cause curing of the ink accordingly.

In some embodiments, a temperature sensor (not shown) may be provided for detecting the temperature of the cup itself and/or the ambient temperature at or near the printing position such that the heating element(s) may be activated (e.g., based on feedback control) to maintain a sufficient temperature for drying the ink prior to dispensing the printed cup. By way of example, a non-contact infrared temperature sensor may be configured to measure the surface temperature of the sidewall of the cup.

With reference now to FIGS. 16C-D, as the sled 1451 pushes the cup toward the printing module, a rotatable mandrel 1456 is positioned to be received within the open end 1405a′ of the cup and engage an inner surface thereof (e.g., via friction fit). The rotatable mandrel 1456, which may be laterally fixed in its position (e.g., via stop plate 1457 having a bore through which a portion of the mandrel extends—as shown in FIG. 16E), is effective to stop the cup's progress while the sled 1451 continues along the track 1453 such that the resilient shoulder 1455 passes over the lip 1405e′ as best shown in FIG. 16E, thereby disengaging the cup 1405 from the sled 1451. With the cup now disposed at the printing position (e.g., one of printing positions 1492a-c), rotation of the mandrel 1456 (e.g., via the action of one or more motors) is effective to rotate the cup 1405′ about its central axis (A) for printing of the cup sidewall as shown in FIG. 16F and as otherwise discussed herein, for example, as a printer head translates over an uppermost portion of the sidewall of the cup disposed in the horizontal orientation.

To avoid bleeding, streaking, or smearing, it may be preferable to avoid printing on the cup's seam, if any. Accordingly, a seam sensor 1494 may be provided in some embodiments for detecting the position of a cup's seam during rotation of the cup, for example, when the cup is disposed in the horizontal orientation. By tracking the position of the seam, a controller can be configured to coordinate ejection of ink from the printer and rotation of the cup such that ink is not ejected onto the seam. For example, the controller may be configured to prevent ink from being ejected when the seam is directly below the printer head, or may adjust rotation of the cup (e.g., reversing direction of rotation about its axis) such that the seam does not pass under the printer. Additionally or alternatively, the seam sensor may be used to determine the position of the seam along the rotation cycle of the cup 1405′ and, thus, can be used by the controller to control rotation of the cup 1405′ during printing, such as to enable printing in a certain position along the sidewall of the cup 1405′. Similarly, in some embodiments, the relative position of the seam may be used to align the printed cup during ejection so as to cause the printed portion of the sidewall to face toward a food service provider when moved to the dispensing/transfer section.

A variety of detection mechanisms modified in accordance with the present teachings may be utilized as a seam sensor, including contact sensors such as mechanical sensors and non-contact sensors such as optical or ultrasound sensors, all by way of non-limiting example. In one embodiment, for example, the seam sensor 1494 may include a source of optical radiation or ultrasound waves that are directed at a sidewall of the rotating cup. A detector of the seam sensor 1494 may receive the light or sound reflected from the sidewall, with a difference in reflection from the seam (e.g., bump, depression) being indicated in the sensor signal. By way of example, the position of the seam may be indicated based on the time-of-flight of the reflected light during rotation of the cup substantially about the central axis in the second orientation. With data as to the position of the seam, for example, relative to the angular orientation of the mandrel, the controller can operate the printer and/or mandrel so as not to print on the detected seam position and/or to otherwise control the rotational position of the cup as described herein.

In accordance with various aspects of the present teachings, the mandrel 1456 preferably maintains the cup in a horizontal orientation during printing thereof such that at least one of the uppermost portion of the sidewall is horizontal and/or the central axis of the cup is horizontal such that the printer head maintains a distance (e.g., a fixed distance) from the portion of the cup to be printed, irrespective of the taper. Such configurations enable the provision of a constant ink density along the uppermost portion of the sidewall, for example, such that the printer head does not need to adjust spray pattern or injected ink density (e.g., volumetric flow rate of the ink ejected from the ink jet) due to differences in the distance between the ink jet and the cup resulting from the cup's tapered sidewall. Likewise, for a cylindrical cup (e.g., cup 1405″), by having the mandrel 1456 maintain the central axis (A) in a horizontal orientation, the parallel sidewalls would likewise remain a fixed distance from a printer head configured to translate in only a horizontal direction along the uppermost portion of the sidewall during printing thereof.

Upon the completion of the printing, one or more motors may be configured to reverse the direction of the sled 1451. Because the flanges may now engage the upper surface of the cup lip 1405e′, movement of the sled 1451 in the reverse direction may push the cup away from and off of the mandrel 1456 and toward the dispensing section as shown in FIG. 16G, thereby removing the inner surface of the tapered cup from engagement with the mandrel 1456. Upon achieving the vertical orientation at the end of the track 1453, the cup may be moved, ejected, or fall (e.g., via gravity) from the sled 1451, for example, into a dispensing/transfer section 1472.

In this regard, in some embodiments, the cup travels along a cup path within the cup printer. For example, with reference to FIG. 13, a cup 1805 travels within the cup printer 1870a from a vertical orientation (in the cup stack 1806) to a horizontal orientation (for printing thereon with a printer 1875), and then to a vertical orientation (in the dispensing/transfer section 1872) for collection by the food service provider and/or to allow for automated transfer to a downstream device such as cup filler 70b of FIG. 1.

As described herein, one or more mandrels may be used to receive and hold the cup for printing. In some embodiments, each mandrel may be sized to fit within a specific size cup or range of cup sizes such as to properly position (e.g., orient) the cup into the corresponding printing position (e.g., such that at least one of a central axis of the cup extending through each of the cup's open and closed ends or a portion of the sidewall of the first cup is horizontal during printing of the cup). For example, each cup may have a diameter size corresponding to the opening at the open end (e.g., top) of the cup and may have a degree of taper leading down from the open end (e.g., described and shown with respect to FIGS. 15A-C) that fits within a corresponding mandrel in an interference fit manner (such as described with respect to FIGS. 16A-G and 18A-B). Further, in some embodiments, depending on the taper of the planned cup, the corresponding mandrel may be oriented such that an uppermost portion of the sidewall of a cup thereon is in the horizontal orientation—such as to correspond with the printer head to receive ink thereon. Thus, each mandrel (e.g., for each printing position) may be sized and oriented for each printing position and may correspond to each specific size cup or range of cup sizes planned for that printing position. Likewise, though some of the described embodiments detail downward printing onto a cup in a horizontal orientation, the one or more mandrels may be configured to orient a cup differently and/or hold the cup such that printing occurs in a different direction (e.g., sideways toward the cup, at an angle with respect to the cup, etc.).

In some embodiments, each mandrel (e.g., one for each printing position) may be configured to operate as a universal mandrel such that it can receive and hold a wide range of cup sizes. For example, the universal mandrel may receive and securely hold each contemplated cup size (e.g., small, medium, and large) such that the lanes for each cup stack can accommodate each cup size. Further, utilizing universal mandrels may ease maintenance, such as requiring only one type of mandrel if replacement is needed.

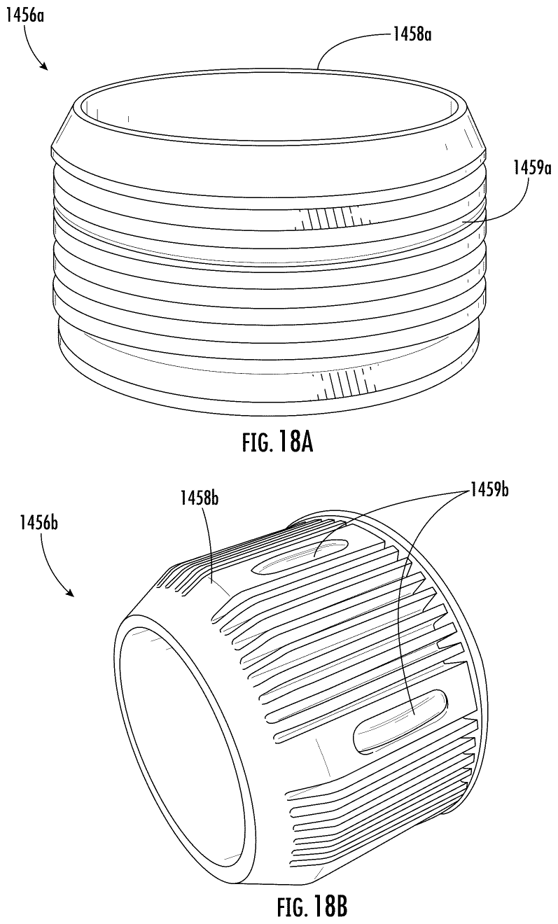

With reference now to FIGS. 18A-B, two additional example mandrels 1456a and 1456b suitable for use in systems according to the present teachings are depicted. With particular reference to FIG. 18A, the example mandrel 1456a comprises a head 1458a that is configured to be disposed at least partially within the cup so as to engage an inner surface thereof. As shown, the mandrel head 1458a defines a groove for seating an O-ring 1459a. Upon insertion of the head 1458a into the open end of a cup, the O-ring 1459a can be compressed against the inner surface of the cup to retain the cup on the mandrel by frictional fit. The mandrel 1456b of FIG. 18B is similar in that it also comprises a head 1458b configured to be inserted into the open end of the cup. Rather than having a frictional element disposed completely around the head as with mandrel head 1458a, the head 1458b includes a series of circumferentially spaced frictional elements 1459b on its outer surface, which may better accommodate cup-to-cup variations and/or provide sufficient frictional force to retain the cup without requiring excessive forces for the initial engagement between the inner surface of the cup and frictional elements 1459b. It will be appreciated in light of the present teachings that each of a plurality of mandrels in a cup printer (e.g., a first mandrel for rotating a first cup from a first stack at a first printing position and a second mandrel for rotating a second cup from a second stack at a second printing position) can be the same or different from one another. For example, a single mandrel design could accommodate a wide variety of cup sizes and/or tapers. Alternatively, mandrels for a particular printing position may be selected and/or interchanged according to the cup type corresponding to that printing position and/or cup stack.

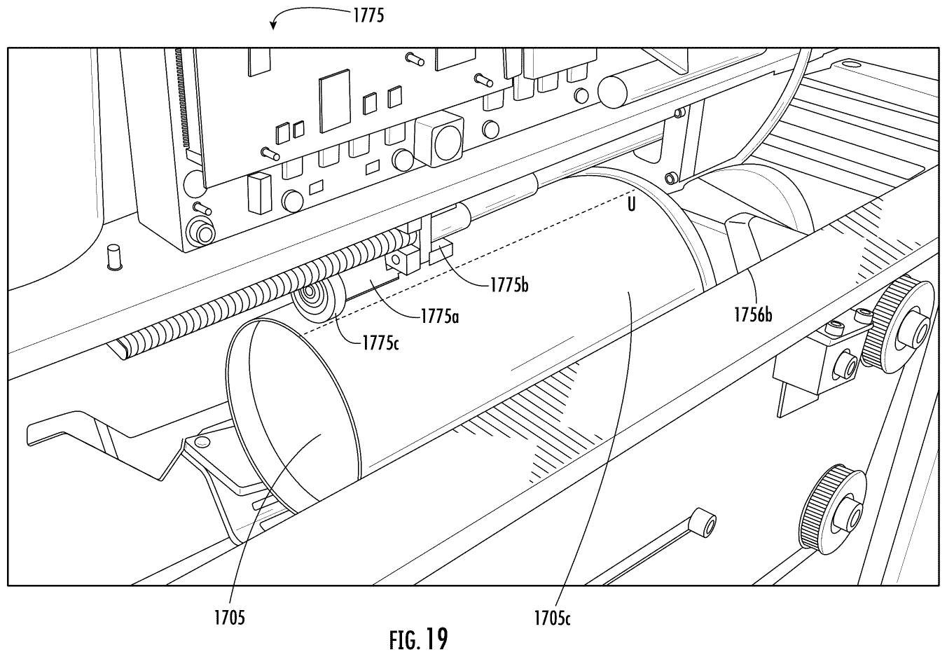

FIG. 19 depicts a cup 1705 engaged with mandrel 1756b in a printing position within the printing module. As shown, the printer device 1775 comprises a carriage 1775a to which the printer head 1775b is attached. The carriage 1775a is disposed over a tapered cup such that the printer head may jet ink toward the uppermost portion (illustrated as dashed line U) of the cup's sidewall 1705c. In particular, the cup is disposed such that the uppermost portion of the sidewall is horizontal such that the printer head may maintain a fixed distance relative to the portion of the cup to be printed as the printer head translates (e.g., linearly) along and over the tapered cup's sidewall. In this regard, in some embodiments, the mandrel 1756b is configured with a tilt angle with respect to horizontal such as may account for the corresponding taper of the cup so as to cause the uppermost portion of the cup to be horizontal.

As shown, a cup positioning element (e.g., wheel 1775c) is also attached to the carriage, the wheel adapted to be disposed in contact with the sidewall of the cup for balancing or otherwise positioning (e.g., centering) the cup on the mandrel 1756b during rotation of the cup. By way of example, loading of the cup onto the mandrel may not always result in the cup being maintained in a horizontal orientation while rotating, for example, due to cup-to-cup variations. The cup positioning wheel 1775c, however, can be utilized to contact the sidewall during rotation of the cup in the printing position (e.g., prior to printing) to help straighten, balance, or otherwise center the cup on the mandrel for consistent printing.

### Example Flowchart(s) for Cup Printing

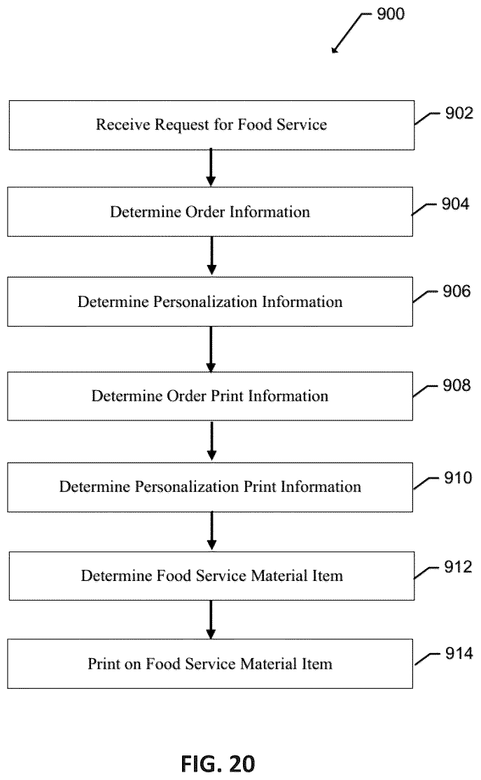

Embodiments of the present invention provide methods, apparatuses and computer program products for providing on-demand food service material printing for a food order according to various embodiments described herein. For example, embodiments of the present invention provide methods, apparatuses and computer program products for providing on-demand cup printing, filling of a printed cup, and/or closing of a filled cup for a food order according to various embodiments described herein. Various examples of the operations performed in accordance with embodiments of the present invention for on-demand cup printing will now be provided with reference to FIG. 20.

FIG. 20 illustrates a flowchart according to an example method for providing on-demand food service material printing for a food order according to an example embodiment. The operations illustrated in and described with respect to FIG. 20 may, for example, be performed by, with the assistance of, and/or under the control of one or more of the components, architectures, modules, networks, and/or systems/devices of system 10, such as described herein.

The method 900 may include receiving a request for food service at operation 902. At operation 904, the method may include determining order information based on the request. At operation 906, the method may include determining personalization information based on the request. Then, the method may include determining order print information, such as based on the order information, at operation 908 and personalization print information, such as based on the personalization information, at operation 910. At operation 912, the method may include determining the food service material item to print on for fulfilling the food order. Then, at operation 914, the method may include printing on the food service material item and presenting it to the food service person for use with preparation of the food order.

FIG. 20 illustrates an example flowchart of a system, method, and computer program product according to various example embodiments described herein. It will be understood that each block of the flowcharts, and combinations of blocks in the flowcharts, may be implemented by hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the control architecture 15. As will be appreciated, any such computer program product may be loaded onto a computer or other programmable apparatus to produce a machine, such that the computer program product including the instructions which execute on the computer or other programmable apparatus may be suitable for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### Example Cup Filling and Devices Therefor

As noted above with respect to FIG. 1, dispensing systems in accordance with various aspects of the present teachings may include an automated cup filler 70b that is configured to fill a cup (e.g., a cup received from cup printer 70a) with the consumable corresponding to the food service order. For example, after printing of the cups by the cup printer 70a, the printed cup may be transferred to the cup filler 70b for filling thereof in accordance with the food service request. By way of example, one or more rollers, conveyor belts, robotic arms, transfer systems, mandrels, chutes, or other hardware (e.g., cup transfer element 673a of FIG. 6A) may be configured to transfer the printed cup to the cup filler 70b, such as from the dispensing/transfer section 1472 of the cup printer 1470a of FIG. 15, for example.

As noted above, in some embodiments, the controller may cause monitoring of the system operation, for example, to confirm that a printed cup is to be filled with a particular consumable by the cup filler. For example, a small cup for cold beverages printed with an identifier that associates that cup with a particular item of a particular food request order may be detected by a mark sensor before, during, or after transfer from the cup printer 70a to the cup filler 70b, for example, prior to filling.

In some embodiments, upon being transferred to the cup filler 70b, the printed cup may be filled, for example, with the type and amount of one or more consumables corresponding to the printed cup based on the food service order. The cup filler 70b, for example, may contain and/or be operatively connected to one or more tanks, reservoirs, and/or supplies containing one or more consumables as well as one or more fill nozzles, chutes, funnels, or tubes, among others, capable of filling the cup with a consumable. By way of example, a cup filler 70b may comprise a chute associated with an ice supply (or ice generator) for adding an appropriate amount of ice (e.g., a default amount of ice corresponding to the cup size or based on a consumer's preferences such as light ice). Additionally or alternatively, a nozzle can provide a beverage from a beverage supply according to the food service request for that particular cup to be filled such as after adding the desired amount of ice.

In various aspects, the cup filler 70b may comprise one or more filling sections, each of which may correspond to a particular consumable, for example. In such example embodiments, the cup filler 70b may also include one or more cup-moving structures/features that may be used to enable movement of the cup between one or more of the consumable filling sections. A cup holder (or positioner) at each filling section may be configured to grasp, hold, or otherwise stabilize the cup during filling thereof to prevent the cup from tipping over, for example.

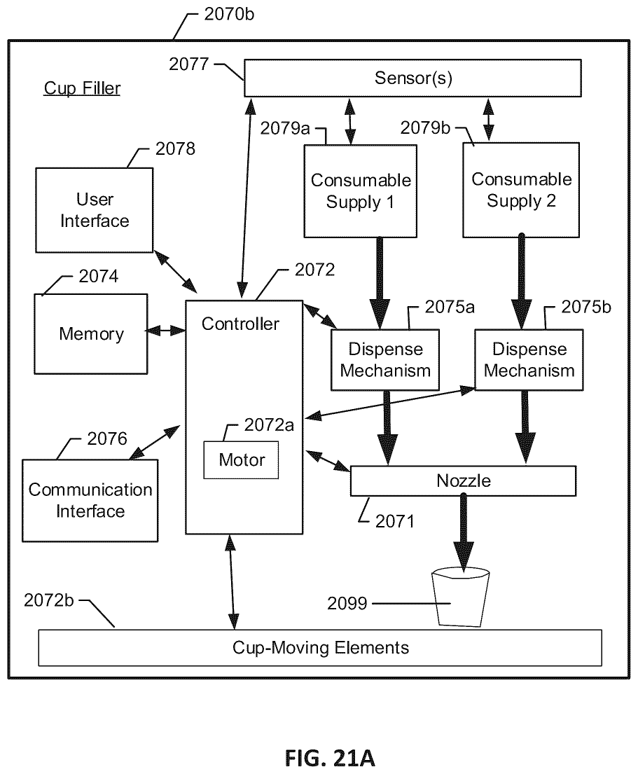

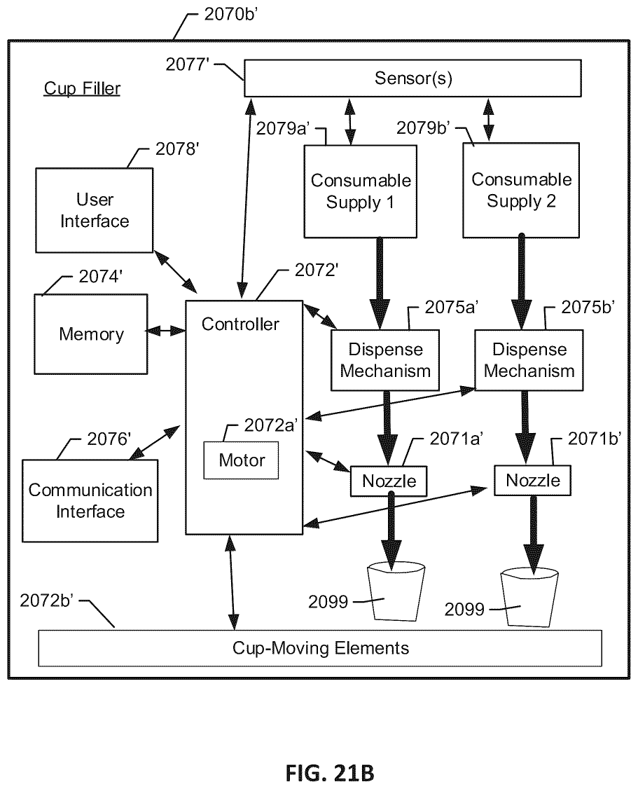

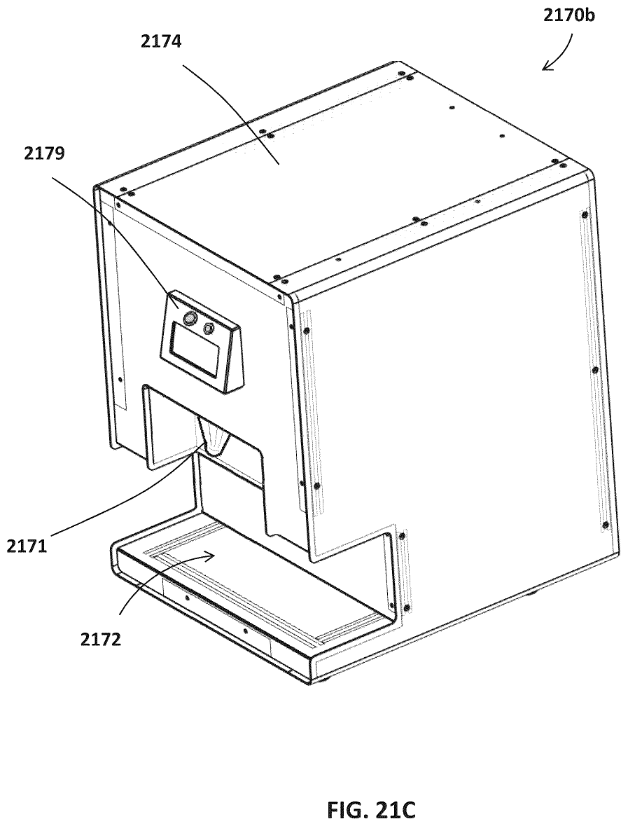

With reference now to FIG. 21A, an example cup filler 2070b may comprise hardware and/or software capable of performing various functions described herein. In this regard, the cup filler 2070b may include and/or be operatively connected to a controller 2072, a motor 2072a, cup-moving elements 2072b, a memory 2074, a communication interface 2076, a user interface 2078, one or more consumable supplies (e.g., Consumable Supply 1 2079a and Consumable Supply 2 2079b), one or more dispense mechanisms (e.g., a first dispense mechanism 2075a and a second dispense mechanism 2075b corresponding to respective consumable supplies), one or more nozzles 2071, and one or more sensor(s) 2077.

The controller 2072 may be configured to execute various programmed operations or instructions stored in a memory device and may be, for example, a device comprising a processor or circuitry operating in accordance with software or otherwise embodied in hardware or a combination of hardware and software, thereby configuring the device or circuitry to perform the corresponding functions of the controller 2072 as described herein. In this regard, the controller 2072 may be configured to receive one or more instructions for filling a cup, such as through the communication interface 2076. In some embodiments, the controller 2072 may be configured to determine, process, and/or choose the determined consumable supply to dispense from (e.g., either ice from the Consumable Supply 1 2079a and/or a cold beverage from Consumable Supply 2 2079b). In some embodiments, the controller 2072 may be configured to cause corresponding dispensing to occur through the one or more dispensing mechanisms 2075a, 2075b and corresponding nozzle(s) 2071. In some embodiments, the controller 2072 is configured to cause dispensing to occur for a certain amount of time to correspond with a desired fill level of the cup 2099. In some embodiments, the controller 2072 may be configured to operate one or more cup-moving elements 2072b, such as to control the cup 2099 before, during, or after filling of the cup. In some embodiments, the controller 2072 may cause monitoring, such as through sensor(s) 2077, of supply materials of the cup filler 2070b. The controller 2072 may also be configured to send gathered information and/or instructions to other devices, systems, or modules to perform various functions described herein. In some embodiments, the controller 2072 may be configured to operate according to one or more modules described herein. For example, in some embodiments, the controller 2072 may be configured to operate according to the control architecture 15, such as the food service material printing module 40.

The one or more consumable supplies 2079a, 2079b may be configured to hold and/or store (or be operatively connected to) one or more consumables to be dispensed for filling the cup. For example, the cup filler 2070b, depending on the configuration, may be configured to enable dispensing of one or more different consumables. For example, the cup filler 2070b may be configured to enable dispensing of such example consumables as beverages (e.g., liquid consumables for drinking, such as soda, coffee, water, juice, wine, beer, etc.), soup, ice cream, ice, and bulk items (e.g., cereal, snacks, etc.). In this regard, the cup filler 2070b may include additional components/features that are used to preserve or otherwise enable holding/storing of such consumables. For example, the cup filler 2070b may include an ice maker and may have a corresponding water supply along with a freezer, etc., such as may be appreciated by one of ordinary skill in the art in light of this disclosure. Further, different varieties of the same consumable type may be provided in different supplies, such as to enable different dispensing options (e.g., cola versus diet cola). Depending on the desired food service order, the appropriate consumable supply can be dispensed from.

The one or more dispense mechanisms 2075a, 2075b may be controlled to cause dispensing of the appropriate consumable. In this regard, the controller 2072 may be configured to control the dispense mechanism to deliver a desired amount of the consumable, such as through the nozzle 2071. This may occur, for example, by controlling how long the dispense mechanism is in an open configuration, thereby allowing or forcing dispensing of the consumable.

One or more motors 2072a may be used to operate various features/components of the cup filler 2070b. In some embodiments, the controller 2072 may be configured to operate the motor(s) 2072a to control dispensing. Additionally or alternatively, one or more motors 2072a may be used to drive one or more cup moving elements 2072b, such as to cause one or more cups 2099 to move through or cooperate with the cup filler 2070b, such as to receive the dispensed consumable.

The one or more sensor(s) 2077 may be configured to monitor various components or supplies of the cup filler 2070b or various features corresponding to the cup being filled. For example, in some embodiments, the one or more sensors 2077 may be configured to monitor the available consumable levels. Additionally or alternatively, other features are contemplated, such as operating as a mark sensor, etc., such as described in various embodiments herein.

The memory 2074 may be configured to store instructions, computer program code, order data (e.g., order information) and other data/information associated with the cup filler 2070b in a non-transitory computer readable medium for use, such as by the controller 2072.

The communication interface 2076 may be configured to enable connection to external systems (e.g., an external network 12, one or more food request systems 80, one or more other systems (e.g., cup printer 70a, cup closer 70c, etc.), a customer's mobile device, a computer server, the control architecture 15, and/or one or more other system(s)/device(s)). In some embodiments, the communication interface 2076 may comprise one or more transmitters configured to transmit, for example, one or more signals according to example embodiments described herein. Likewise, the communication interface 2076 may include at least one receiver configured to, for example, receive data according to example embodiments described herein. In some embodiments, the transmitter and receiver may be combined as a transceiver. In this regard, the cup filler 2070b may be configured for wired and/or wireless communication. In some embodiments, the communication interface 2076 may comprise wireless capabilities for WiFi, Bluetooth, or other wireless protocols. In some embodiments, the cup filler 2070b may be connected, such as through Bluetooth, to one or more food request/POS system(s) 80 such as to enable performance of various functions herein.

The user interface 2078 may be configured to receive input from a user and/or provide output to a user. The user interface 2078 may include, for example, a display, a keyboard, keypad, function keys, mouse, scrolling device, input/output ports, touch screen, or any other mechanism by which a user may interface with the system. Although the user interface 2078 is shown as being directly connected to the controller 2072 and within the cup filler 2070b, the user interface 2078 could alternatively be remote from the controller 2072 and/or cup filler 2070b. Likewise, in some embodiments, other components of the cup filler 2070b could be remotely located.

FIG. 21B illustrates another example cup filler 2070b′ for on-demand filling of cups, such as for use in a food service order. In contrast to the cup filler 2070b shown and described with respect to FIG. 21A, the depicted cup filler 2070b′ of FIG. 21B includes two nozzles 2071a′ and 2071b′. In such a regard, the cup 2099 may undergo two (or more) different fillings at different stations. For example, ice may be dispensed through nozzle 2071a′ and the cup may be moved (e.g., via the cup-moving elements 2072b′) to underneath the nozzle 2071b′ to receive soda (or other consumable). In this regard, the cup filler 2070b′ may be configured to enable mixing of various consumables. Another example is to dispense concentrated consumable through one nozzle and water through a second nozzle to provide the filled cup with the desired consumable mixture. One of ordinary skill in the art in view of this disclosure will appreciate that other consumable mixtures are contemplated. Further, while shown as two different nozzles, like the cup filler 2070b in FIG. 21A, the different consumables could be dispensed through the same nozzle, such as simultaneously or at different times (e.g., leaving the cup in one station for example).

FIG. 21C shows an example cup filler 2170b. The cup filler 2170b includes a housing 2174 that may contain one or more components, such as described with respect to FIGS. 21A-B. For example, the cup filler 2170b includes a user interface 2179, a nozzle 2171, and a corresponding dispensing section 2172. As detailed herein, the dispensing section 2172 may work in conjunction, for example, with one or more cup transfer elements to cause movement of the cup between additional systems/devices (e.g., from a cup printer and/or cup source, to a cup closer, etc.).

Various embodiments of the present invention contemplate any type of cup filler that may be used in conjunction with various systems/devices described herein. An example cup filler that includes components and features that are contemplated for some such example cup fillers is the Cornelius Automated Beverage System (ABS), where an Operator's Manual of the ABS is available at https://www.manualslib.com/manual/1485020/Cornelius-A-B-S-Unit.html, the contents of which is incorporated herein by reference in its entirety.

### Example Flowchart(s) for Cup Filling

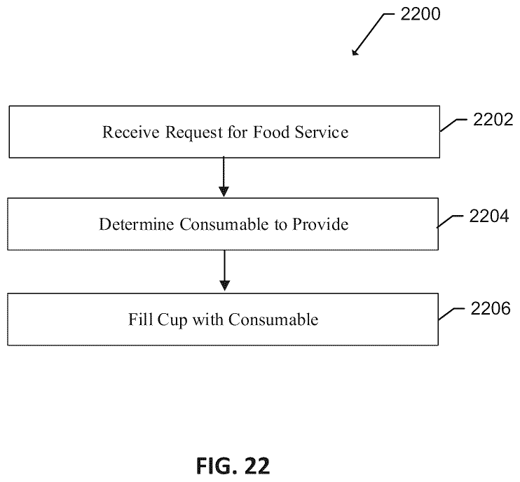

Embodiments of the present invention provide methods, apparatuses and computer program products for providing on-demand food service material dispensing for a food order according to various embodiments described herein. Various examples of the operations performed in accordance with embodiments of the present invention for on-demand cup filling will now be provided with reference to FIG. 22.

FIG. 22 illustrates a flowchart according to an example method for providing on-demand filling for a cup according to an example embodiment. The operations illustrated in and described with respect to FIG. 22 may, for example, be performed by, with the assistance of, and/or under the control of one or more of the components, architectures, modules, networks, and/or systems/devices of system 10, such as described herein.

The method 2200 may include receiving a request for food service at operation 2202. At operation 2204, the method may include determining one or more consumables to provide to fill the cup. At operation 2206, the method may include causing filling of the cup accordingly.

FIG. 22 illustrates an example flowchart of a system, method, and computer program product according to various example embodiments described herein. It will be understood that each block of the flowcharts, and combinations of blocks in the flowcharts, may be implemented by hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the control architecture 15. As will be appreciated, any such computer program product may be loaded onto a computer or other programmable apparatus to produce a machine, such that the computer program product including the instructions which execute on the computer or other programmable apparatus may be suitable for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### Example Cup Closing and Devices Therefor

As noted above with respect to FIG. 1, dispensing systems in accordance with various aspects of the present teachings may include an automated cup closer 70c that is configured to at least partially close (e.g., cover, seal, lid) a cup filled with a consumable as indicated by the food service order. For example, following filling of the cup(s), such as by the cup filler 70b as otherwise discussed herein or being filled manually (or by another cup filler), the filled cup may be transferred to the cup closer 70c for at least partially closing (e.g., covering, lidding, sealing) the open end of the filled cup. By way of example, one or more rollers, conveyor belts, robotic arms, transfer systems, mandrels, chutes, or other hardware (e.g., cup transfer element 673b of FIG. 6A) may be configured to transfer the filled cup to the cup closer 70c, for example. In some embodiments, one or more cup transfer elements may be utilized with various example cup closers detailed herein to help close the open end of the cup, such as by lifting the filled cup into a sealing portion so that the cup can be utilized in conjunction with the cup closer. In some embodiments, one or more cup transfer elements may be utilized to hold a filled cup, such as may be useful in maintaining the position of the cup while a sealing portion of the cup closer moves (e.g., down) over the cup to create a seal/lid thereon. In some embodiments, the controller 672 may be able to confirm before, during, or after transfer to the cup closer 670c the cup and/or its contents (e.g., based on an identifier such as a bar code or QR code) to ensure that the proper closure is provided to the cup, for example.

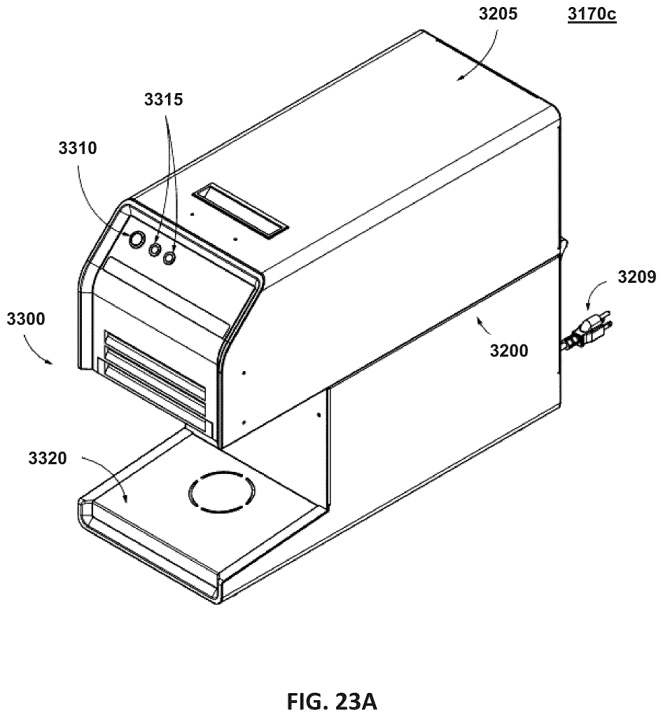

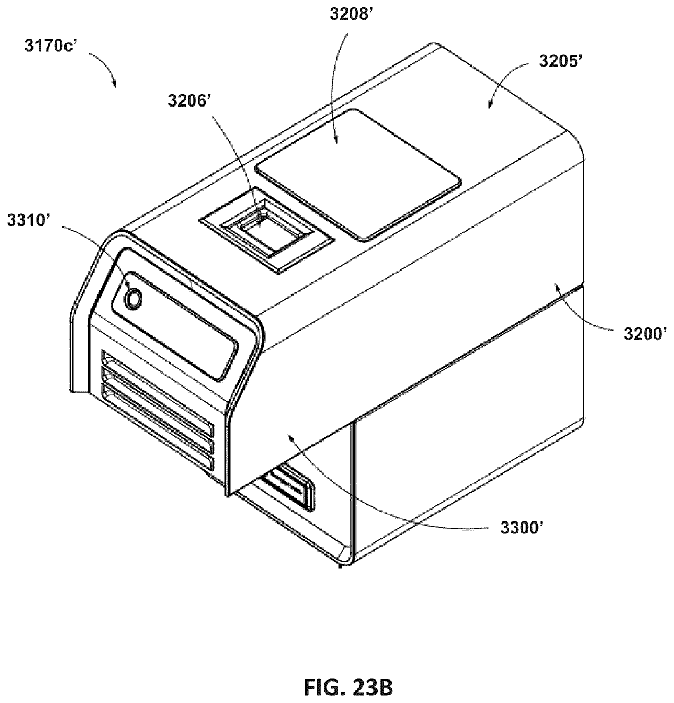

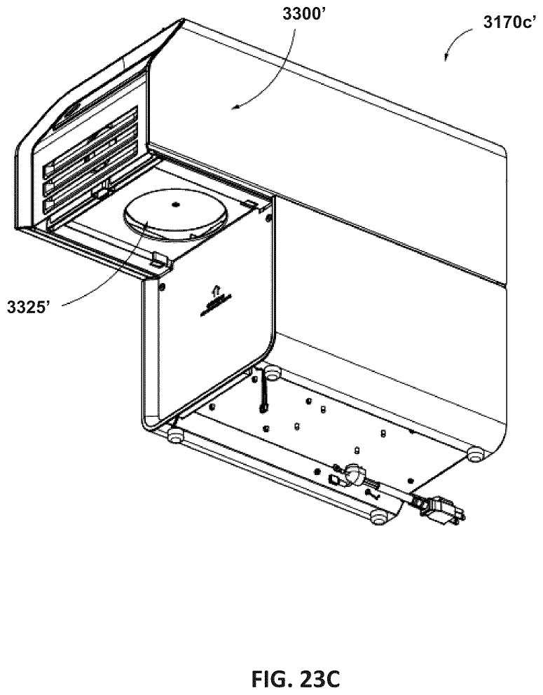

In accordance with various embodiments, a cup closer 70c may be configured to secure a film to a filled cup to form a seal (e.g., a full seal, a partial seal, etc.) of the cup to at least partially cover and/or inhibit flow from the cup is provided (e.g., close the cup). Solely for purpose of illustration, embodiments of an example cup closer for securing a film to a cup in accordance with some embodiments is shown in FIGS. 23A-C. Particularly, and as illustrated, the cup closer 3170c, 3170c′ can have a body portion 3200, 3200′ and securing portion 3300, 3300′.

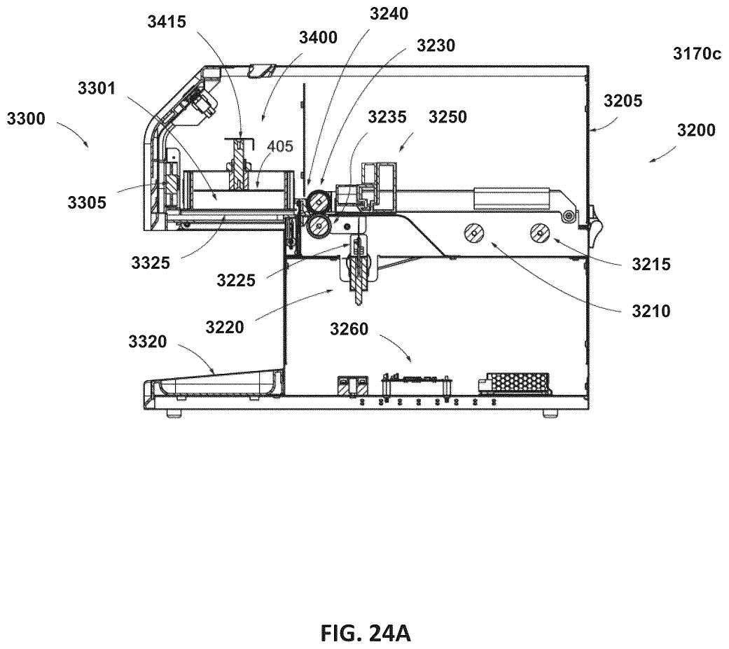

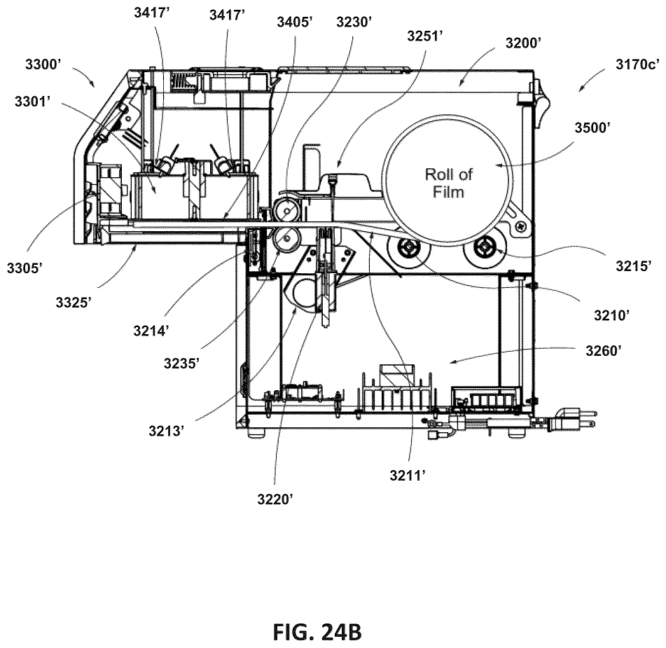

FIG. 24A is a cross-sectional side view of the example apparatus 3170c. As depicted, the securing portion 3300 can be positioned at a front of the apparatus 3170c and adjacent to the body portion 3200. The body portion 3200 can be positioned at the back of the apparatus 3170c. As further described herein, the body portion 3200 can house a length of film therein, such as a roll of film, that can feed into the securing portion 3300. The securing portion 3300 can further include a securing head assembly 3400 with a sealing portion 3301 that secures a film to a top of a cup. FIG. 24B shows another example apparatus 3170c′ with a body portion 3200′ and a securing portion 3300′. Notably, FIG. 24B also illustrates an example film path 3211′ for the film to travel through the apparatus from the roll of film 3500′ to the loading zone within the sealing portion 3301′.

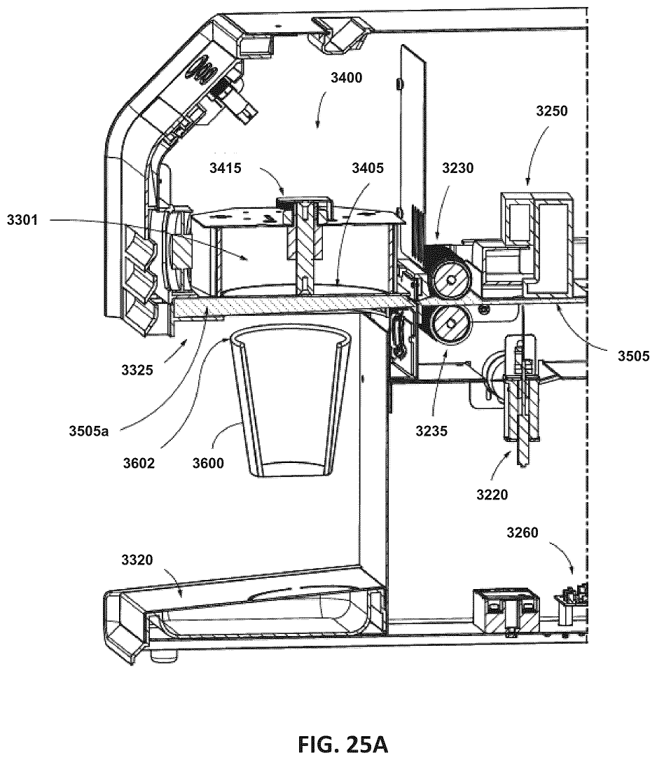

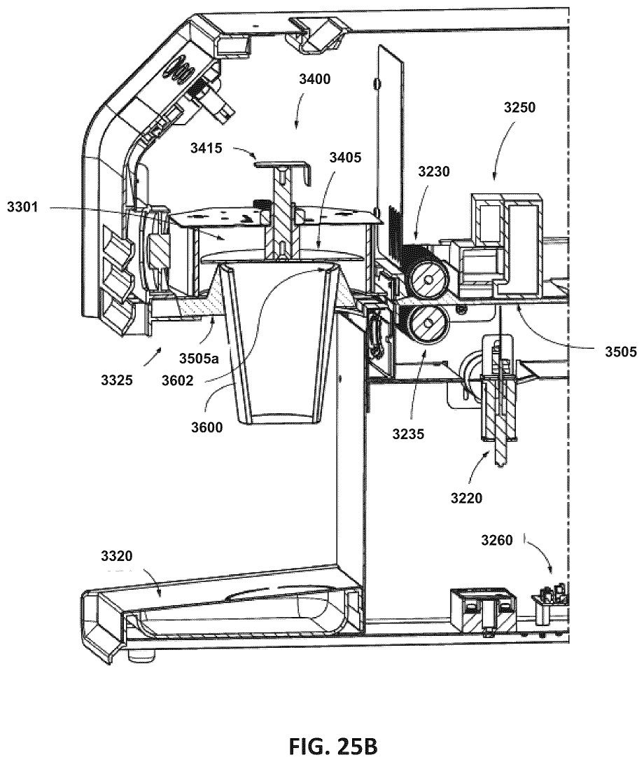

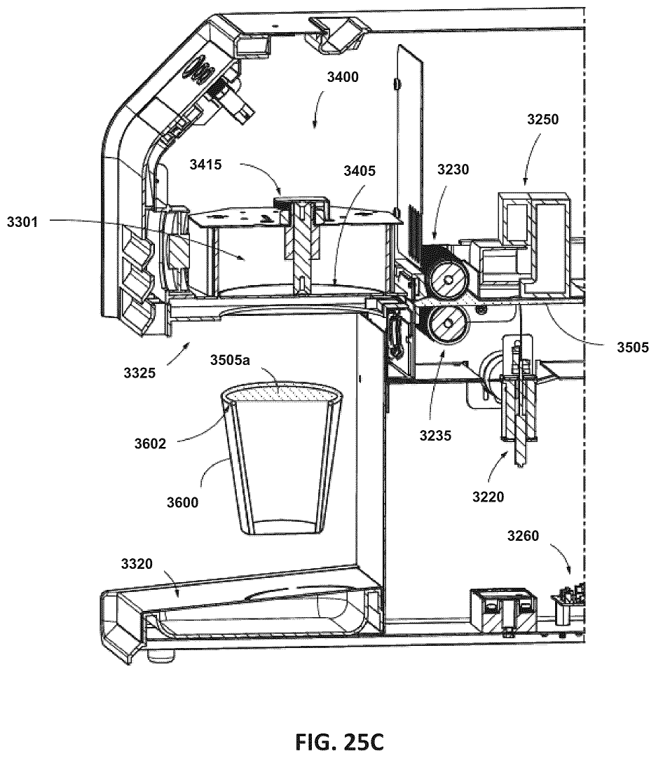

For purposes of illustration, and not limitation, FIGS. 25A-C show the operation of the apparatus with respect to a representative cup, such as a disposable beverage cup 3600 (although any suitable “cup” described herein is contemplated for use with the example cup closers 70c). FIG. 25A depicts a length of film in the sealing portion in a position ready to be secured to a cup 3600. FIG. 25B depicts the cup 3600 cooperating with the apparatus 3170c to secure the film to the cup 3600 during operation thereof. FIG. 25C depicts the film secured to the cup 3600 prior to the apparatus 3170c feeding a next film into the loading zone. A method of operating the apparatus 3170c and reference to FIGS. 25A-C is discussed in detail below.

### Example Body of Cup Closer

The body portion of the illustrated cup closer may contain the initial film loading, a piercer, film rollers, film sensors, a film cutter, and a guide support assembly, among other components, as described herein.

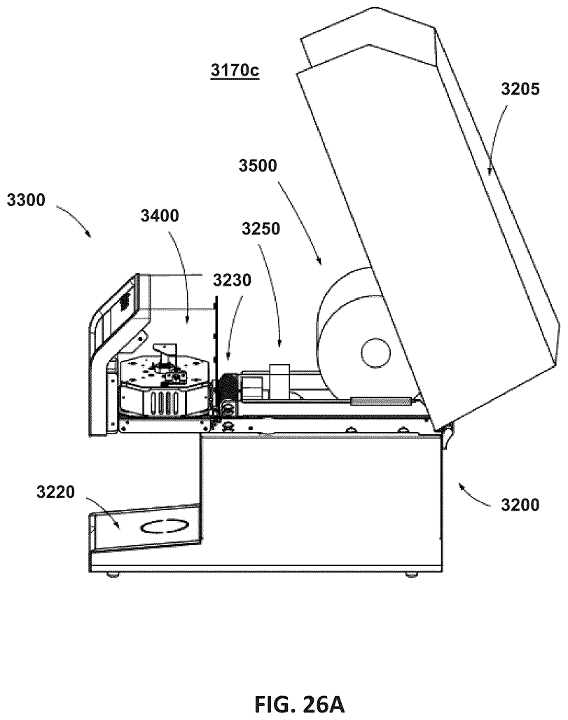

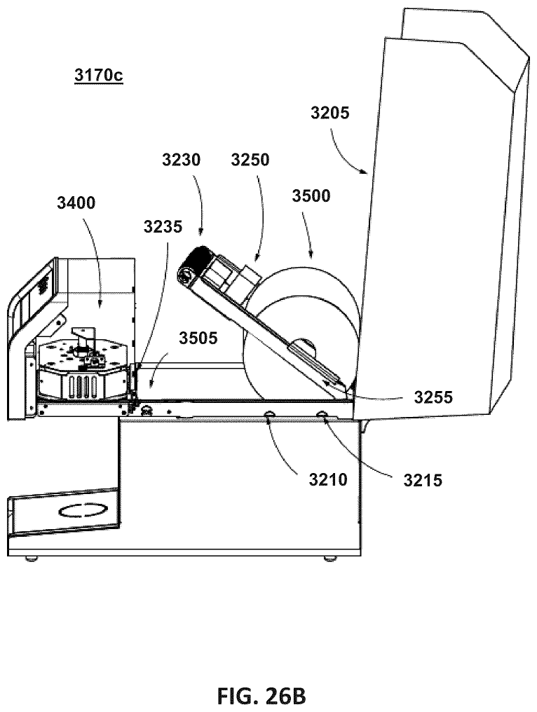

The apparatus 3170c, 3170c′ can include a body portion 3200, as shown in FIGS. 24A and 24B. FIGS. 26A-B are side perspective views of various portions of the apparatus of FIG. 24A. FIG. 26C is side perspective view of another portion of the apparatus of FIG. 24B.

As shown in FIGS. 23A and 23B, the body portion 3200, 3200′ can include a body cover 3205, 3205′, and any other suitable structure to contain the machinery therein. The body cover 3205, 3205′ can be coupled to the body portion 3200, 3200′, for example pivotably coupled by a hinge, screws, positioning, or other coupling devices, and additionally or alternatively, by friction and/or gravity alone. The body cover 3205, 3205′ can improve the usability, safety, aesthetics, and other properties of the apparatus 3170c. For example, the body cover 3205, 3205′ can improve usability by reducing the amount of debris that enters the body portion 3200, 3200′. The body cover 3205, 3205′ can contribute to the safe operation of the apparatus 3170c, such as by reducing the likelihood of bodily contact with internal machinery. The body cover 3205, 3205′ can be sized and/or shaped to accommodate a roll of film to be used for securement to cups in accordance with the present teachings.

The body portion 3200, 3200′ can comprise various features, including for example the body cover 3205, 3205′, a first and second film support roller 3210, 3201′, 3215, 3215′, a piercer 3220, 3220′ with a piercing tip 3225, a printer 3250, a nip including a drive roller 3235, 3235′ and a pinch roller 3230, 3230′, a motor 3213′ (such as for operating the drive roller 3235, 3235′), and one or more film sensors 3240. Although depicted and described as being in the body portion 3200, 3200′, any of the features can be located in any other suitable location. For example, at least one of the piercer 3220, 3220′, the printer 3250, the nip, and the film sensor 3240 can be located in the securing portion 3300, 3300′.

As shown in FIGS. 24A, 25B, and 26B, the apparatus 3170c, 3170c′ can comprise a first film support roller 3210, 3210′ and second film support roller 3215, 3215′ to cooperatively support a roll of film 3500, 3500′. That is, the roll of film 3500, 3500′ can rest between the first film support roller 3210, 3210′ and the second film support roller 3215, 3215′ and be capable of rotation with respect thereto (although other forms of holding the roll of film are contemplated herein, such as with a roll holder). As shown in FIG. 26B, the first and second film support rollers 3210, 3215 can support the roll from underneath, whereas the movable arm 3255 can ensure that the roll of film 3500 is properly positioned transversely in the apparatus. The arm 3255 and the body cover 3205 can move independent to each other, as shown in FIGS. 26A and 26B, such as to enable replacement of an empty roll of film with a replacement roll of film and loading of the leading edge of the roll of film into the nip (e.g., due to the arm 3255 including the pinch roller 3230 such that the pinch roller 3230 is removed from the film path 3211′). In some embodiments, one or both of the film support rollers 3210, 3210′, 3215, 3215′ is mechanically rotated. As such, the rotation of one or both of the film support rollers 3210, 3210′, 3215, 3215′ imparts rotation to the supported roll of film.

In other embodiments, one or both of the film support rollers 3210, 3210′, 3215, 3215′ is capable of passively rotating with non-negligible resistance. In those embodiments, rotation of the roll of film imparts a rotational force on the film support rollers 3210, 3210′, 3215, 3215′. The non-negligible resistance imparts rotational resistance to the roll of film, thereby imparting tension in the film between the roll of film and the drive roller 3235, 3235′. In still other embodiments, one or both of the film support rollers 3210, 3210, 3215, 3215′ can be prevented from rotating. In such embodiments, lack of rotation causes slippage to occur between one or both of the film support rollers 3210, 3210′, 3215, 3215′ and the roll of film 3500, 3500′, imparting rotational resistance to the roll of film, thereby imparting tension in the film between the roll of film and the drive roller 3235, 3215′. In this regard, in some embodiments, the controller is configured to operate the motor to cause a different rotation speed of the drive roller in comparison to a film support roller for the supply of film so as to form tension in the film (which may aid with piercing and/or printing of the film). Although the one or more film support rollers are depicted upstream from the securing portion 3300, the one or more film support rollers can be positioned at a location in any direction along the path of the film 3211′.

In some embodiments, the apparatus 3170c, 3170c′ may include a film supply window that may enable a user to determine/approximate an amount of film supply remaining on an installed roll, such as without opening the body cover 3205, 3205′. For example, the apparatus 3170c′ shown in FIG. 24B includes a film supply window 3208′ that is positioned on the top of the body cover 3205, 3205′.

### Example Piercer

In accordance with another aspect of the present invention, the apparatus 3170c, 3170c′ may include a piercer 3220, 3220′ having one or more protrusions 3225 (e.g., tips, blades, etc.). In some embodiments, the piercer and the protrusions are monolithic such that the piercer is actuatable. The protrusions 3225 can impart an impression upon (or through) a film to weaken the film at such a location for ventilation and/or for insertion of a drinking straw, for purposes of example. The piercer 3220, 3220′ can actuate the protrusions 3225 in any suitable way, for example by electromagnetism via a solenoid, by hydraulics, by a rotating arm actuator, by a linear actuator, or the like. In other embodiments, the entire piercer 3220, 3220′, including protrusions 3225, is actuatable with respect to the body portion. In other embodiments, the piercer 3220, 3220′ does not contain protrusions 3225. Piercers without protrusions can include, for example, air jets, lasers, blast heaters, or any other suitable piercer.

Protrusions 3225 can actuate with respect to the piercer 3220, 3220′ and/or with respect to the body portion 3200, 3200′. The protrusions 3225 can have a variety of shapes, for example, protrusions 3225 can be comprised of one or more blades. Additionally or alternatively protrusions 3225 can have a pyramid shape, such as a triangular pyramid, a square pyramid, a star pyramid, or other shapes as desired. Additionally or alternatively, protrusions 3225 can be shaped to have a series of needle-shaped protrusions. With such configurations, protrusions 3225 can impart an opening or perforation pattern on a film. Additionally still, the protrusions 3225 can be a circumferential blade having a closed shape. Accordingly, protrusions 3225 can remove pieces of film 3505 such as by way of kiss cutting. In some embodiments, the protrusions 3225 are removable from the piercer 3220, 3220′ to be exchanged for a piercing tip of a different construction.

The piercer 3220, 3220′ can be positioned at any suitable location in the apparatus including being positioned in the securing portion 3300. For example, the piercer 3220 can be positioned above the securing head assembly 3400. The piercer can be configured to pierce film 3505 shortly before securement, during securement, or shortly after securement. In some embodiments, the piercer 3220 includes a piercing rod coupled to the piercing tip 3225, wherein the piercing rod is coaxial with and movable with respect to the guide rod of the securing head assembly 3400.

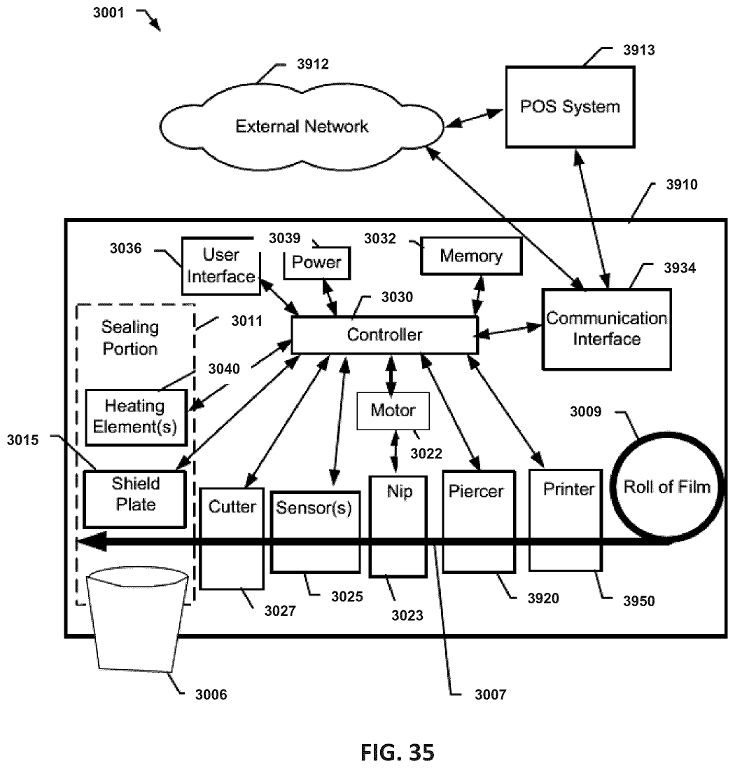

In some embodiments, a controller (e.g., controller 3030 described with respect to FIG. 35), may be configured to cause actuation of the piercer 3220, 3220′ to cause the perforations or slits to be created in the film, such as it travels along the film path 3211′. In some embodiments, the controller may be configured to control the relative position of the perforations or slits on the lid, such as based on a desired operational parameter for the anticipated product or the utilized film.

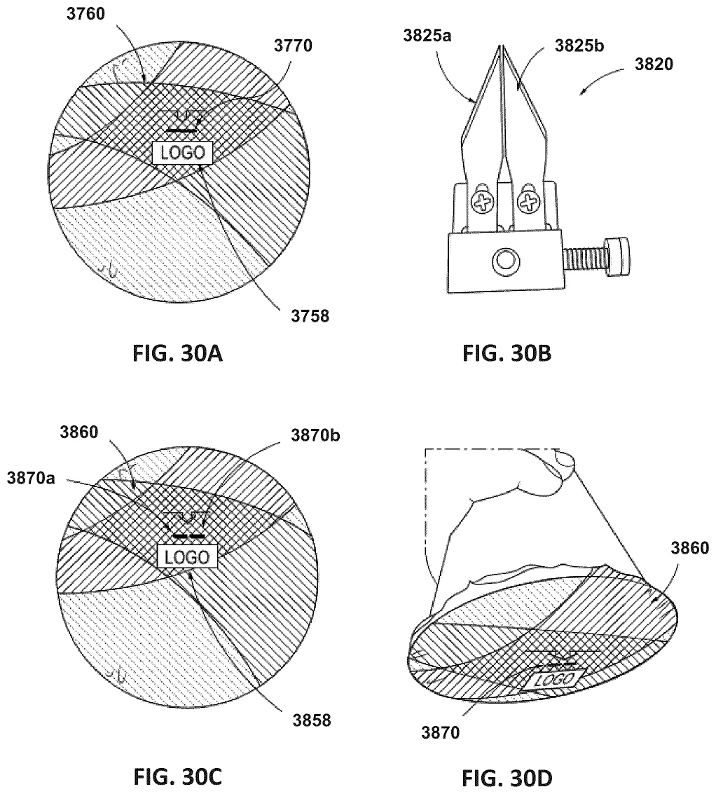

In some embodiments, the piercer 3220, 3220′ may be configured with two or more spaced apart protrusions (e.g., tips, blades, etc.). An example such piercer 3820 is shown in FIG. 30B. The depicted piercer 3820 includes a first protrusion 3825a and a second protrusion 3825b that are spaced apart. In some embodiments, the piercer may form a single device with two or more spaced apart protrusions. In some embodiments, the two or more spaced apart protrusions may be formed of two spaced apart protrusions extending from a single device. In other embodiments, there may be two separate devices that each form a protrusion—to thereby form the spaced apart protrusions. In some embodiments, a single protrusion may be used to form two spaced apart slits/perforations on the film. In such example embodiments the piercer with a single protrusion may move to a different location on the film in between punctures of the film to form the two spaced apart slits/perforations. Alternatively, the film may move to cause the piercer to puncture the film in different locations (e.g., in the machine direction).

In this regard, when applied to the film, such an example piercer 3802 creates two spaced apart slits/perforations on the film. For example, FIG. 30C illustrates an example sealed lid 3860 with two spaced apart slits 3870a and 3870b with a portion of the lid 3860 remaining intact therebetween. Notably, the separation of the slit 3870a and 3870b provides for an elongated point of weakness—which provides for desirable ventilation and a greater weakness point for ease of insertion of a straw, while still providing preferable leakage protection, such as illustrated in FIG. 30D. For example, the extra lid material between the first slit 3870a and the second slit 3870b may keep the edges of the slit film sufficiently closed so as to allow sufficient surface tension to be created by liquid at surface—thereby minimizing/avoiding leakage through the slits 3870. In this regard, the two spaced apart slits are designed to enable venting and discourage leaking when the cup is tilted such as due to the surface tension between the liquid and the portion of the lid between the spaced apart slits. In contrast, a single elongated slit, such as shown as slit 3770 on the sealed lid 3760 in FIG. 30A, of the same length as multiple slits may allow undesirable leakage when the cup is tipped. Said differently, in comparison to a continuous length slit of similar overall length, the double spaced apart slits provide equivalent ventilation for the cup, weakness within the lid to enable insertion of a straw, and increased leakage prevention due to increased surface tension of liquid on an inside portion of the lid. In some embodiments, the double spaced apart slits may provide slight increased resistance to insertion of a straw or other object to avoid/inhibit undesired and/or inadvertent tearing. In this regard, usage of the term equivalent is designed to account for some variation, but generally being similar in comparison.

### Example Film Rollers

In some embodiments of the present invention, the example cup closer (e.g., cup sealing device) may include one or more film advancement mechanisms (e.g., nip 3023 and motor 3022 shown in and described with respect to FIG. 35), such as for advancing the film from the roll of film along the film path. For example, with reference to FIGS. 24A and 24B, the illustrated apparatus 3170c, 3170c′ comprises a nip having a drive roller 3235, 3235′ and a pinch roller 3230, 3230′. In some embodiments, the nip functions to progress film 3505 into the loading zone 3325 (e.g., along the film path 3211′). In some embodiments, the pinch roller 3230, 3230′ is adjustable in relation to the drive roller 3235, 3235′ (such as being attached to the arm 3255) to enable insertion of film 3505 between the drive roller 3235, 3235′ and the pinch roller 3230, 3230′. For example, and as shown in FIG. 26B for purpose of illustration and not limitation, the pinch roller 3230, 3230′ can be coupled to a moveable lever arm 3255. Such a configuration can simplify a process of loading a length of film 3505 into the nip. In other embodiments, the pinch roller 3230 is adjustable relative to the drive roller 3235 to accommodate different thicknesses of film 3505 therebetween. Further, in some embodiments, other ways to load the film into the nip are contemplated, such as by feeding the film into the nip as the drive roller operates to prime the nip.

In some embodiments, the driver roller 3235, 3235′ may be rotated via a motor 3213′, which may be controlled by a controller of the sealing device (e.g., controller 3030 shown and described in FIG. 35). In some embodiments, drive roller 3235, 3235′ can be mechanically rotated. For example, drive roller 3235, 3235′ can be mechanically rotated by a crank mechanism, a rotational driver, a drive shaft, a drive belt, a drive chain, or any other means of imparting rotational force. In some embodiments, pinch roller 3230, 3230′ can freely rotate in response to a torque. For example, torque could be applied by friction between the pinch roller 3230, 3230′ and the rotating drive roller 3235, 3235′, or by friction between the pinch roller 3230, 3230′ and the film 3505.

In some embodiments, the drive roller 3235, 3235′ can be mechanically coupled to at least one of the film support rollers 3210, 3210′, 3215, 3215′. For example, drive roller 3235, 3235′ and the at least one film support roller can be mechanically coupled by a drive shaft, a drive belt, a drive chain, or other suitable couplings. The body portion 3200, 3200′ can further comprise a film support roller 3210, 3210′ to support a length of film, wherein the drive roller 3235, 3235′ rotates at a faster speed than the film support roller 3210, 3210′ such that the film can be positioned taught in along the film path. For example, the drive roller 3235, 3235′ and film support roller 3210, 3210′ can be geared and/or dimensioned such that their coupling imparts a different rotational speed to each roller.

### Example Film Sensor

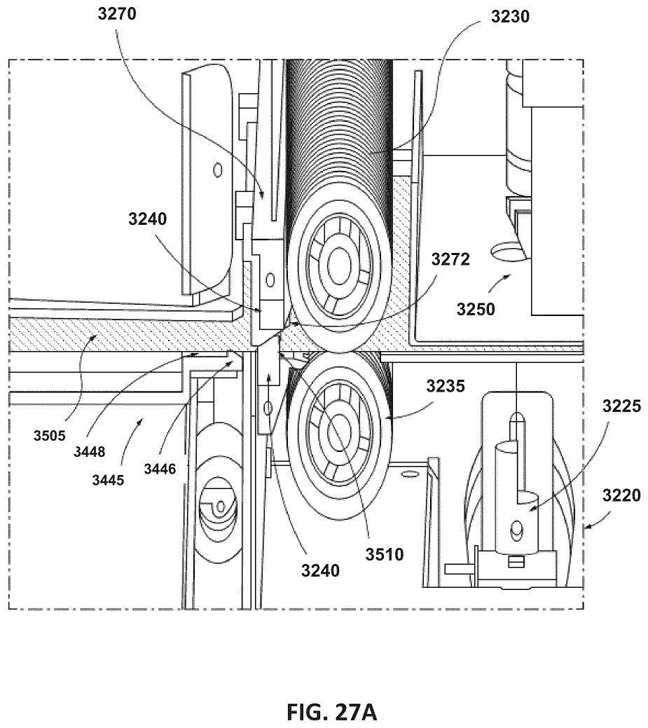

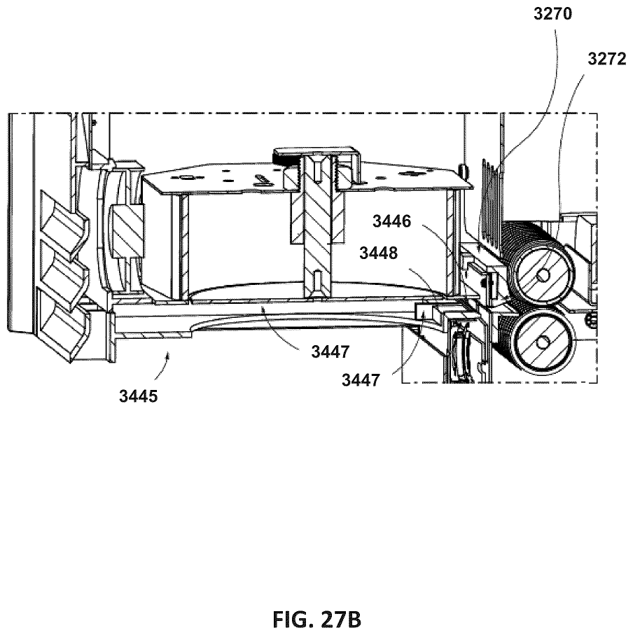

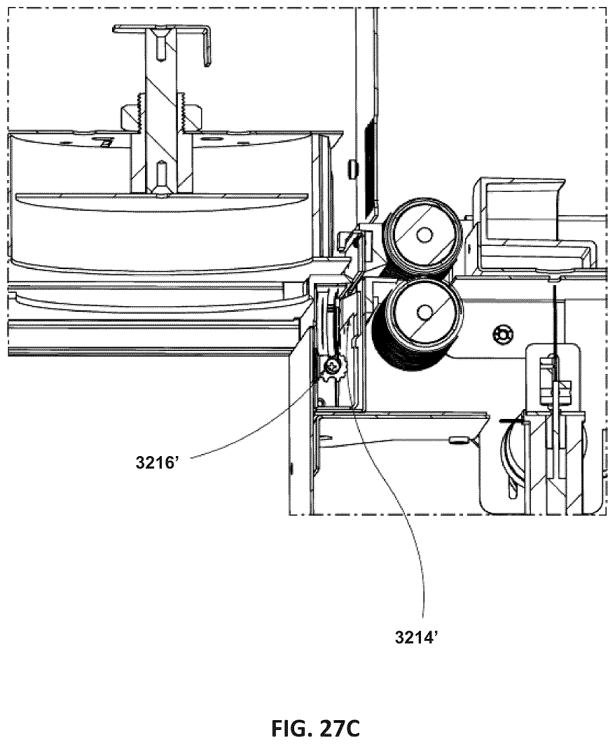

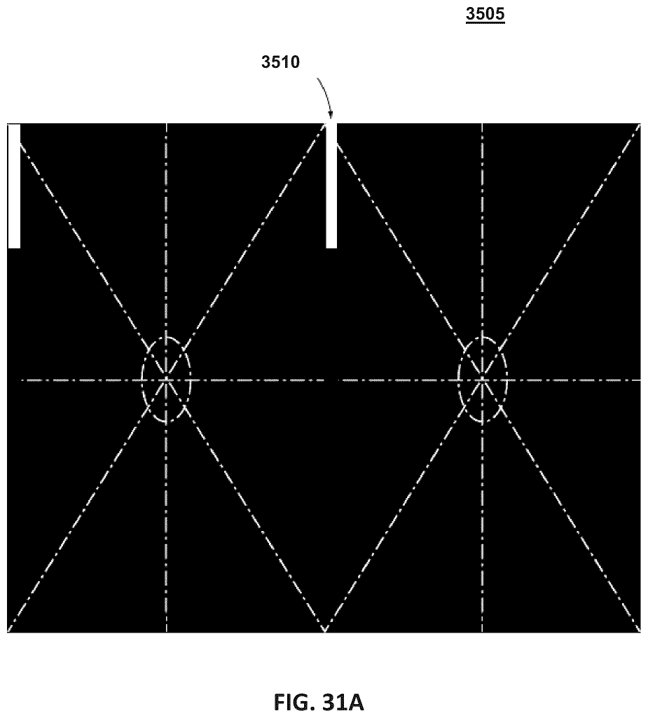

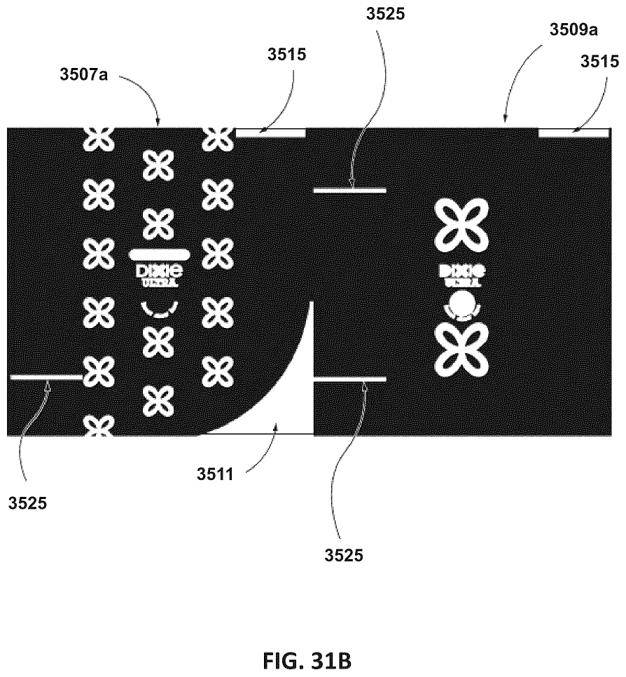

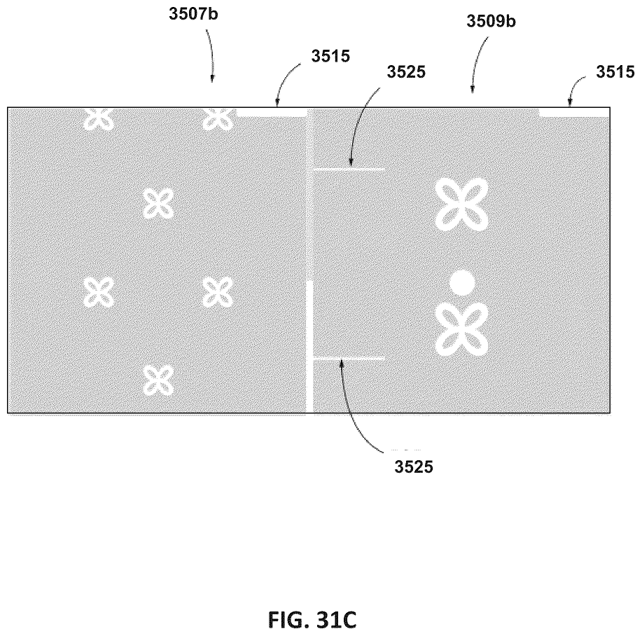

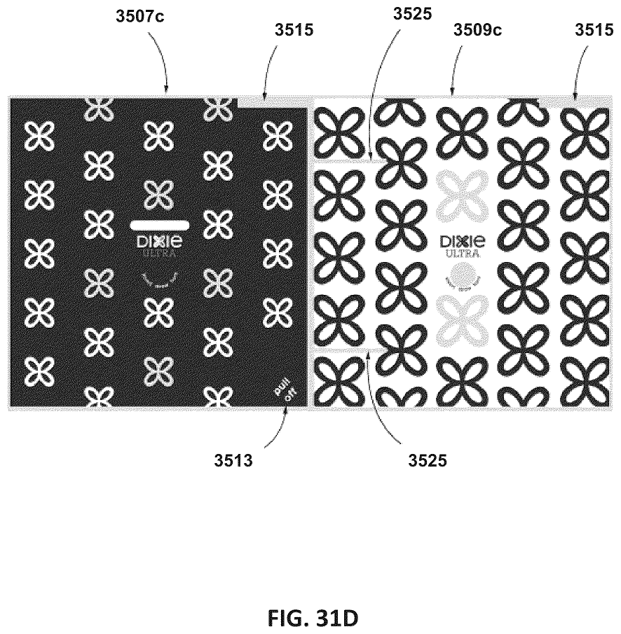

In some embodiments, the apparatus 3170c, 3170c′ may include one or more film sensors 240. In some embodiments, and as shown in FIG. 27A, the film sensor 3240 can comprise a film signal emitter and a film signal sensor to detect a film sensor flag 3510 passing therebetween (although other types of sensors are contemplated). The film sensor flag 3510 positioning can directly correspond to the position of the film as moved by the drive nip, and further discussed herein with respect to FIGS. 31A-D. The film signal emitter can continuously emit a light signal capable of being detected by the film signal sensor. Film 3505 can be positioned between the film signal emitter 241 and the film signal sensor 3242, such that opaque portions of the film 3505 block the light signal where opaque. However, when the film sensor 3240 detects a change of the film, such as when detecting a transparent portion/window of the film or a film sensor flag 3510, the film sensor 3240 can send a signal input indicating that the continuous emission of the signal emitter has been disrupted. Accordingly, as the film 3505 moves between the film signal emitter 3241 and film signal sensor 3242, the film sensor flag 3510 or transparent window can allow transmission of the light signal to the film signal sensor. The film signal sensor, upon detecting the light signal or a change in the intensity of the light signal, can register that the film 3505 has progressed upstream and generate a film sensor input. In other embodiments, a reverse set up can be provided. That is, the film can allow transmission of the light signal to the film signal sensor 3242 until it is blocked or partially blocked by the film once the film has progressed. The film signal sensor, upon detecting the reduction of the light signal, can register that the film has progressed and generate a film sensor input to deactivate the drive nip.

In other embodiments, the film sensor 3240 can be any sensor suitable for detecting the progression. For example, the film sensor 3240 can include at least one of a light sensor as described, a mechanical sensor, a motion sensor, among others. A mechanical sensor can include a rotational sensor, that is rotated by progression of the film, and registers that the film has progressed upon rotation. For example, a mechanical sensor can register a degree of progression by the amount of rotation. In some embodiments, a rotational sensor can be coupled to the pinch roller 230 to detect rotation thereof.

In some embodiments, the drive roller 3235, 3235′ can be can be mechanically rotated based on input from the film sensor 3240. That is, in response to film sensor inputs by the film sensor 3240, the drive roller 3235, 3235′ can have its rotation initiated, continued, or ceased. For example, after a securement cycle, rotation of drive roller 235, 235′ can be initiated, film sensor 3240 can detect progression of film 3505, and film sensor 3240 can provide a film sensor input. In response to the film sensor input, rotation of drive roller 3235 can be ceased.

Solely for purpose of illustration, reference is now made to FIG. 31A, which is a top perspective view of a film that can be used in conjunction with an apparatus of the disclosed subject matter. In some embodiments, and as shown for purpose of illustration and not limitation, the film 3505 can include at least one film window 3510 or other marking. As described above, with respect to the film sensor, the at least one film window 3510 can allow at least partial transmission of the film sensor signal to indicate progression or the location of the film 3505 relative to the dispenser.

In some embodiments, the film can include a plurality of film windows 3510 (e.g., markings) spaced along a length of film at regular intervals. For example, in some embodiments, the plurality of film windows 3510 can be spaced a distance corresponding to a predetermined length of film to be secured to a cup, such as for purposes of example spaced at a distance of every 15 cm. In some embodiments using film windows spaced as above, the film sensor 3240 can generate a film sensor input upon detecting a single film window to allow the film sensor to cooperate with a film cutter in creating the predetermined length of film. In other embodiments, the film window can alternatively be a suitable marking distinguishable from the remaining film area. In some embodiments, the windows (or markings) may be clear, printed, reflective, or printed with an ink that is not visible or readily visible to a human eye, such as phosphorescent ink. In this regard, in some embodiments, the one or more markings may be formed using ink or other coatings.

In other embodiments, the plurality of windows 3510 are spaced at a distance corresponding to a small quantized value. In some embodiments using film windows 3510 spaced at a small quantized distance, the film sensor 3240 can generate a film sensor input upon sensing a predetermined plurality of film windows 3510. For example, the film windows 5310 can be spaced at a distance of 25 mm, and the film sensor 3240 can generate a film sensor input upon sensing the passage of six windows. As such, the apparatus can be programmed to generate different lengths of film for depositing within the loading zone to complement various sized cups thus minimizing film waste. In some embodiments, the film sensor 240 can be adjusted such that the number of film windows 3510 needed to pass before a film sensor input is generated. For example, a command received prior to the initialization of film progression can determine the number of film windows 3510 desired to pass. In some embodiments, the command can be received by the input device 3315 and can be further processed such as by a computer operatively coupled with the apparatus, as further discussed herein. As detailed herein, the input device 3315 may be used to provide many different types of input that can be recognized (such as by the controller 3030) and used to affect operation of the sealing apparatus (e.g., what temperature to operate the heating element(s) at, what to print on the film, etc.).

FIGS. 31B-D illustrate an example portion of film 3505 that includes a plurality of portions (e.g., FIG. 31B illustrates portion 3507a followed (e.g., along a machine direction) by portion 3509a). In order to form the aesthetic look of the seal, such as seal 760 shown and described with respect to FIG. 30A, one or more layers of ink may be applied to the film 3505. Notably, some of the layers of ink may be radiation-absorbing so as to be particularly susceptible to heat, so as to shrink (e.g., around the top of the cup) to form the seal (such as described herein). In this regard, FIG. 31B illustrates a first layer of ink that includes radiation-absorbing ink. FIG. 31C illustrates an applied second layer of ink over the first layer of ink on both portions 3507b, 3509b. Notably, however, in some embodiments, the second layer of ink may be non-radiation-absorbing (or less radiation-absorbing) such that the ink is not particularly susceptible to heat and, thus, does not shrink during application of heat by the heating elements (such as described further herein). FIG. 31D illustrates an applied third layer of ink over the first and second layers of ink on both portions 3507c, 3509c. In this regard, the one or more images or patterns can be built-up based on colors applied via the layers of ink.

Further, however, in some embodiments, one or more markings (e.g., windows) may be provided such as described herein. For example, windows 3515 and markings 3525 may be unapplied portions of the radiation-absorbing layer of ink for portions 5307a, 3509a such that they are detectable (e.g., as described herein). Depending on the desired look of the film, such windows 3515 or markings 3525 may be covered with one or more layers of ink (e.g., non-radiation-absorbing layers of ink) and still be detectable. For example, with reference to FIG. 31C, the marking 3525 on portion 3507b was covered with the corresponding layer of ink.

In some embodiments, the film sensor(s) 3240 may be configured to sense one or more markings, marking schemes, and/or characteristics corresponding to the markings or marking schemes.

In this regard, in some embodiments, the one or more markings may correspond to a marking pattern comprised of a plurality of markings and/or determined spacing between each adjacent marking within the plurality of markings. In some embodiments, the film sensor may be configured to detect various characteristics of the markings or marking schemes, such as the color of the one or more markings, a width of the one or more markings, a length of the one or more markings, or a spacing between adjacent markings. Notably, in some embodiments, the marking scheme may be repeated along the length of the roll of film such that the roll of film comprises a plurality of repeated film marking schemes. As described further herein, such information could be used to determine various characteristics of the film and/or control the device accordingly.

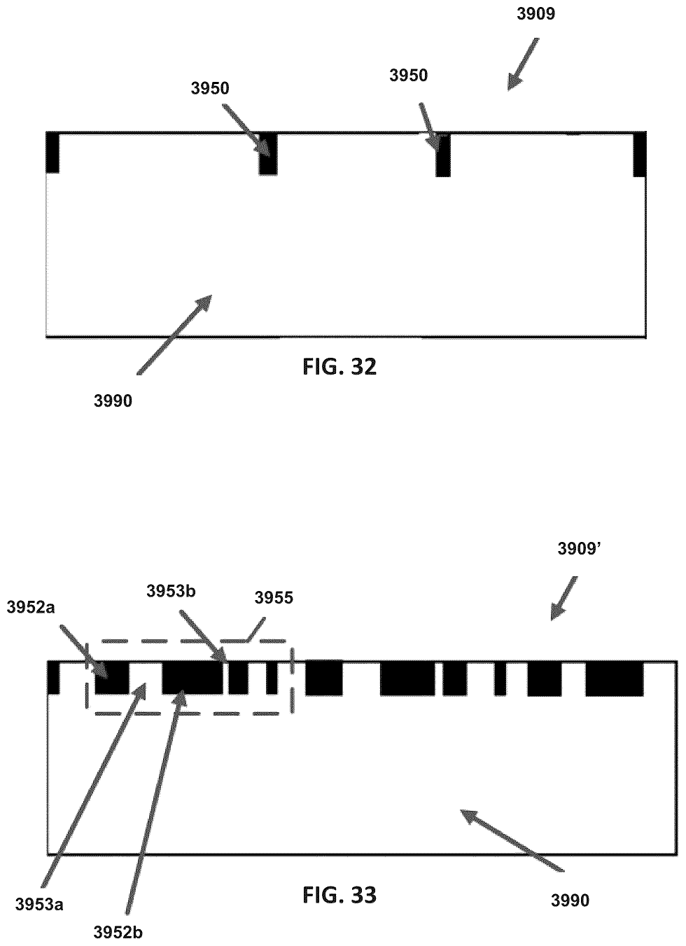

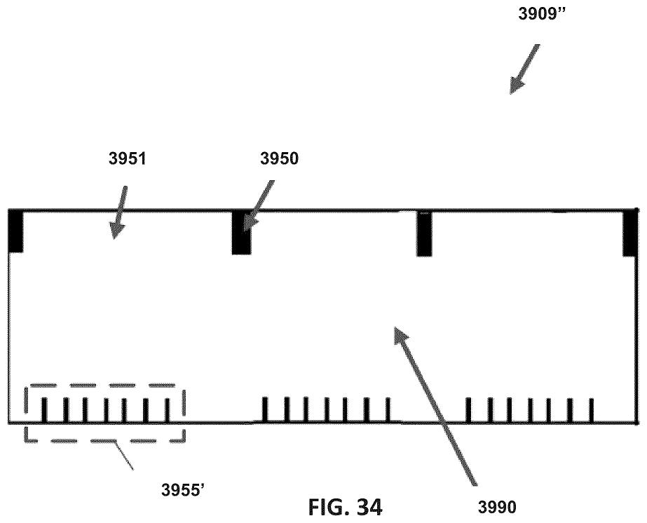

FIG. 32 shows an example film portion 3909 with a marking scheme. The film sensor(s) may be configured to read the markings 3950 and/or various characteristics regarding the read markings, such as their width, their length, or the distance between adjacent marks. FIG. 33 illustrates another example film portion 3909′ with a more complex marking scheme that could be used to convey even more information. In this regard, the various widths and distances between the markings may be sensed and used to convey that information to the device. In the illustrated embodiment, a repeatable series of individual markings could be considered a single repeated marking scheme/pattern (indicated by the dashed line box 3955). In particular, the illustrated marking scheme 3955 includes a series of black markings 952a, 952b (or color markings) of varying widths that are each separated by white space 953a, 953b (or white markings, blank markings, etc.) of varying widths. FIG. 34 illustrates another example film portion 3909″ with marking schemes on both edges of the film (e.g., markings 3950 and 3951 on one edge and marking scheme 3955′ on the other edge). In such an example embodiment, more than one film sensor could be used to gather the desired information. Further, different edges of the film could convey different information. For example, the markings 3950 may be used to provide data regarding the length of film being conveyed (such as for determining when to turn off the motor) and the marking scheme 3955′ may provide information used to determine various characteristics of the film and/or control the device accordingly. Likewise, a type of cut marking could be maintained on one side (such that it could be used with a standard cut-to-mark system), while the other side could be used to provide other marking schemes and convey additional information.

Notably, in the illustrated embodiments the markings are positioned proximate the edges of the film, which may enable various features to be accomplished in the center of the film 3990, such as may translate to the portion of the film that will form the lid of the cup. In this regard, such as described further herein, a printer may print one or more messages or images on the film in the center section 3909 and/or the piercer could form the slits/perforations in the center section 3990.

Though the depicted markings are shown as black markings and white/blank markings, other types of markings are contemplated, such as barcodes, color markings, quick response (QR) codes, among others. In some embodiments, logos or other images on the film may be utilized as markings. In some embodiments, the film sensor may also be configured to measure or sense other types of markings, such as holes, bumps, or other features of the film. In this regard, the film sensor(s) may be configured to read any such markings or subsets/combinations of any such markings.

### Example Film Cutter

In some embodiments, the apparatus 3170c, 3170c′ can further include a film cutter to cut a predetermined length of film from a film roll. For example, FIG. 27C illustrates an example cutter 3214′ that includes driving mechanism 3216′. The predetermined length of film can be sized to cover the top opening of a cup to allow the film to be secured to the cup for a suitable seal thereon. In some embodiments, the film cutter is positioned along the film path 3211′ between the loading zone 3325 and the nip comprised of the drive roller 3235, 3235′ and the pinch roller 3230, 3230′. In some embodiments, the film cutter comprises at least one of a guillotine cutter and a shear cutter. Additionally or alternatively, the film cutter can comprise any cutter suitable for cutting the film 3505 or at least perforating the film to create segments of film. For example, the film cutter can include a rotary cutter, an air jet cutter, a laser cutter, a blast heater cutter, or any other suitable cutter.

In some embodiments, the film 3505 can travel along a longitudinal path. For example, the film 3505 can travel along a longitudinal path within the body portion 3200 of the apparatus 3170c. In some embodiments, the film support roller 3210, the drive nip, and the loading zone 3325 are arranged along the longitudinal path. In other embodiments the path is non-linear.

In some embodiments, a controller (e.g., the controller 3030 of FIG. 35) may be configured to control actuation of the film cutter to cause the portion of the film to be cut from the roll of film. As described herein, such control may be based on a measured distance of travel of the film along a film path and may be based on data conveyed from one or more markings.

In some embodiments, with reference to FIG. 24B, the apparatus 3170c, 3170c′ may include an edge cutter, such as a manual sliding cutter 3251′. The edge cutter may be configured to cut a clean edge of the film. In this regard, in some cases, the film may form a jagged or wrinkled edge that makes it difficult to load or operate the sealing apparatus 3170c, 3170c′. For example, after a film jam incident, the film may be bunched up, wrinkled, or have an uneven edge. The edge cutter may be used to cut the film and re-load it through the sealing apparatus 3170c, 3170c′. In some embodiments, the edge cutter may be manually actuated such that an operator must directly operate it accordingly. In some embodiments, the edge cutter comprises a sliding cutter that includes a movable knife that can be moved within a track across a width of the film to thereby cut the film and form a clean edge.

### Example Guide Assembly

As shown in FIGS. 27A-B, the apparatus can further include a guide assembly to guide the film between the body portion 3200, 3200′ to the securing portion 3300, 3300′. The guide assembly can comprise an entry structure 3270 and a guide support assembly 3445.

The entry structure 3270 can be downstream the drive nip and channel the film towards the loading zone 3325 in the sealing portion 3301, 3301′. The entry structure 3270 can define a funnel 3272 with a wider entry opening and narrower exit to steer a leading end of the film through the entry structure 3270 and towards the loading zone 3326. In an example embodiment, the entry opening is approximately ⅛th inch.

Once the film enters through the entry structure 3270 the film can progress to a guide support assembly 3445 of the apparatus. The guide support assembly 3445 can include a ramp 3446 and at least one guide truss 3447 (e.g., ribs) to guide the film from the body portion to the securing portion. The ramp is configured to receive a predetermined length of film (e.g., film cut from the roll) from the body portion 3200, 3200′ to guide a leading end of the film to the loading zone 3325. The ramp 3446 has a surface extending from a first end to a second end thereof, as shown in FIGS. 27A and 27B. The ramp surface is oriented at an angle of inclination that can be less than or equal to 85 degrees, or more preferably in a range from about 10-65 degrees. In some embodiments, the second end of the ramp is coupled to a guide surface 3448 configured to receive a film 3505 from the surface of the ramp, as shown in FIGS. 27A and 27B.

The guide assembly can serve to facilitate proper progression of the film 3505 into the loading zone 3325. For example, the guide support ramp can promote movement of the leading end of a film in the direction upward of the inclination. In this manner, the film 3505 can have a reduced likelihood of progressing in a direction other than toward the loading zone 3325 and reduce the likelihood the film from falling into a gap (e.g., the aperture for receiving the cup). In particular, the progressing film can intersect the ramp and progress therealong (e.g., along the guide trusses 3447, which may be spread along the width direction of the film path), thus progressing toward the loading zone. In this regard, in some embodiments, the combination of the ramp 3446 and the one or more guide trusses 3447 may form a guide for directing the leading edge of the film such that the leading edge of the film clears the gap/aperture and rests on the other side of the gap/aperture.

In some embodiments, the shield plate may be positioned to cover a second aperture leading into the sealing portion, such as shown in FIG. 27B. In such an embodiment, the shield plate may form a top boundary guide for directing the leading edge of the film through the loading zone 3325.

Furthermore, the entry structure together with the guide support assembly creates the guide assembly structure to enable the film to be positioned in the loading zone at a close vertical proximity to the shield plate in a ready position, thus limiting the gap distance between the film of the loading zone and the shield plate, as further discussed herein. Reducing the gap distance reduces the distance a cup may be required to move further within the apparatus before activation of the heating elements. Accordingly, the film of the loading zone would only need to travel a distance between a top of a truss and the bottom surface of the shield plate to initially engage the shield plate.

In some embodiments, the guide support assembly 3445 can comprise a plurality of guide trusses, each capable of receiving a film from the body portion. In some embodiments, the guide trusses can further include an end portion thereof disposed at an angle of inclination, similar to the ramp. For example, in some embodiments each guide truss can extend in a direction parallel to the direction of film progression into the loading zone 3325 and have at least a portion that is disposed at an angle of inclination with respect thereto.

### Example Films

In accordance with some embodiments, the apparatus 3170c can be used in conjunction with any suitable type of film. In operation, once heating elements are activated and energy is channeled towards the free ends of the film, the free ends of the film change shape and heat shrink about the top portion of the cup, such as about a lip 3602 of the cup 3600, as shown in FIG. 25C and further discussed below. Suitable films include those that will shrink in the presence of heat or radiant energy. For example, the film can be a plastic wrapping film which has the capability of shrinking when it is heated, and in some cases to near the melting point of the film. These films are commonly manufactured from plastic resins such as polyvinyl chloride (PVC); polypropylene (PP); linear-low density polyethylene (LLDPE); low density polyethylene (LDPE); high density polyethylene (HDPE); copolymers of ethylene and vinyl acetate (EVA); copolymers of ethylene and vinyl alcohols (EVOH); ionomers (e.g., SURLYN™, by E.I. du Pont de Nemours and Company of Wilmington, Del.)); copolymers of vinylidene chloride (e.g., PVDC, SARAN™ (“SARAN” is a trademark of The Dow Chemical Company of Midland, Mich.)); copolymers of ethylene acrylic acid (EAA); polyamides (PA); polyester, polystyrene, nylon and copolymers of ethylene and octene. Additionally or alternatively, the film can be a bi-axially oriented thin shrink film having a thickness of between 40 to 120 gauge (1.02 mm to 3.05 mm). In another embodiment, the film can be a bi-axially oriented thin shrink film having a thickness of between 60 to 100 gauge (1.52 mm to 2.54 mm).

In accordance with some embodiments, the film can further include at least one energy absorbing substance (e.g., a radiation-absorbing layer of ink) on at least part of the film. In some embodiments, the one or more energy absorbing substances can be pre-applied to the film, such as by printing, brushing, spray coating, electrostatic coating, electrodeposition coating, flow coating, roller coating, dip coating, among others. Additionally or alternatively, the substances can be incorporated into the film during formation or manufacture thereof. In other embodiments, the one or more substances can be printed onto the film during operation of the disclosed apparatus. Such substances can allow or enable shrinking of the film at the desired locations to create a suitable seal.

The film can be dimensioned to operate within the confines of the apparatus. In one embodiment, the film can have a width dimension of between approximately 8 and approximately 30 cm. In some embodiments, the film can be cut to a predetermined length dimension of between approximately 8 to approximately 30 cm. In some embodiments, the width and lengths dimensions of the predetermined dimensioned film can be the same. In some embodiments, the predetermined dimensioned film can be square, although other shapes are contemplated herein.

In some embodiments, the film can have a degree of elasticity. As such, when the film is secured to a top of the cup and thereafter removed from the cup, the removed film maintains its shape with respect to the heat shrunk edges, and the film can be reapplied to the top of the cup for securement.

In some embodiments, the film may be pre-printed prior to installation into the sealing device 3170c. For example, such as described herein, the film may include one or more markings pre-printed thereon. In this regard, as is consistent with various embodiments described herein, the one or more markings may be configured to be read by the film sensor(s) or other components to provide information/data for use in operation of the sealing device. For example, with reference to FIGS. 31A-34 and the corresponding description herein, the roll of film may include a repeated marking scheme configured to be read by a film sensor of the automatic sealer. Depending on the desired functionality, the marking scheme may be utilized to affect operation of the automatic sealer (e.g., sealing device) and/or one or more components thereof. For example, the marking scheme may be checked against an approved marking scheme list/database and corresponding affecting (e.g., disabling, enabling, changing, etc.) operation of the automatic sealer and/or components thereof may occur.

In some embodiments, the repeated marking scheme on the film may comprise characteristics formed of at least one of the color of one or more markings of the repeated marking scheme, a width of the one or more markings of the repeated marking scheme, a length of the one or more markings of the repeated marking scheme, or a spacing between adjacent markings of the repeated marking scheme. In some embodiments, the repeated marking scheme is designed to be read by the film sensor to control operation of one or more components of the automatic sealer based on one or more characteristics of the repeated marking scheme.

In some embodiments, the repeated marking scheme is formed along its entire length. In some embodiments, various types of markings may be used, such as windows, ink, paint, a Quick Response Code, a barcode, or a logo. In some embodiments, the markings may be clear such that they are detectable by the film sensor. However, such as described herein with respect to FIGS. 31B-D, it may be desirable to cover the clear markings with an ink that visually covers the clear marking to a user looking through the ink, but also enables detection of the clear marking through the ink. In this regard, the ink (e.g., specific layers of ink) may have specific properties that enable detection by the film sensor therethrough without allowing a user to see therethrough (e.g., the ink may be a detection transparent ink). As noted, this provides a marking that is detectable by a film sensor through the ink, but that is non-visible by a user through the ink (e.g., the marking may be a detectable non-visible marking). Said differently, in some embodiments, the marking scheme comprises a detectable non-visible marking, wherein the detectable non-visible marking is covered using an ink that is visible to a user from the top of the film and still configured to enable detection of the marking by a film sensor from the top of the film. Further, utilizing such a detection transparent ink may provide a more consistent shrinkage of the film during formation of the lid on the cup, such as opposed to when no ink was present in the marking (e.g., window).

In some embodiments, the portions of the film that are designed to form individual seals may be formed with a “pull tab” or “peel tab”. For example, with reference to FIGS. 31B-D, a corner portion 3511 of the portion 3507a may be unapplied with the radiation-absorbing layer of ink (e.g., with respect to a remainder of the portion 3507a). In this regard, upon application of heat, the corner portion 3511 may not shrink like the remainder of the portion 3507a and, thus, it may remain relatively flat and available for a user to grasp and use to peel back the seal. As noted herein, additional layers of ink (e.g., non-radiation-absorbing layers of ink) may be applied over the corner portion 3511 and still the corner portion 3511 may not shrink. In this regard, indications or instructions to the user, such as “pull off” 513, could be printed over the corner portion 3511 to direct the user. Notably, while the above example describes a corner portion 3511, other portions of the film are contemplated to form a pull or peel tab.

### Example Printer

In accordance with some embodiments, the apparatus 3170c, 3170c′ can further include additional components. For example, the apparatus can further comprise a printer 3250 to print any suitable information (e.g., messages or images) on the film 3505, such as the type of drink or product (or symbol or emoji thereof) disposed within the cup as noted below (e.g., an example image (e.g., LOGO 3758) is shown printed on the sealed lid 3760 in FIG. 30A and another example image (e.g., LOGO 3858) is shown printed on the sealed lid 3860 in FIG. 30C). The printer 3250 can be any suitable type of printer to make markings on film 3505. For example, the printer can make markings by laser printing, ink jet printing, laser etching, or any other type of printing suitable for film 3505.

In some embodiments, the printer 3250 can be used to print the same message on film 3505 during every securement cycle. Additionally or alternatively, printer 3250 can be used to print a message on film 3505 depending on an input. For example, the apparatus 3170c, 3170c′ can further comprise a computer (e.g., controller 3030 of FIG. 35) to receive at least one command. The computer can be operatively coupled with the apparatus. As such, the apparatus can contain the computer therein or the apparatus can cooperate with a wireless or remote computer/server. In any arrangement, the computer can send a signal to the printer 3250 to print a predetermined message on film 3505 associated with the at least one command when the at least one command is received. For example, the message can indicate at least one of the type of contents secured within the cup, a trademark, a safety message, or any other suitable message. Alternatively or in addition thereto, the printer can be configured to receive commands through a network and wirelessly.

The printer 3250 can be positioned at any suitable location within the apparatus and is not limited to placement within the body portion 3200, 3200′. In some embodiments, the printer 3250 can be positioned in the securing portion 3300, 3300′. For example, the printer 3250 can be positioned above the securing head assembly 3400. The printer can be configured to print on film 3505 shortly before securement, during securement, or shortly after securement. In some embodiments, the securing head assembly 3400 and the shield plate each include a printing window through which printer 3250 can print a message on film 3505.

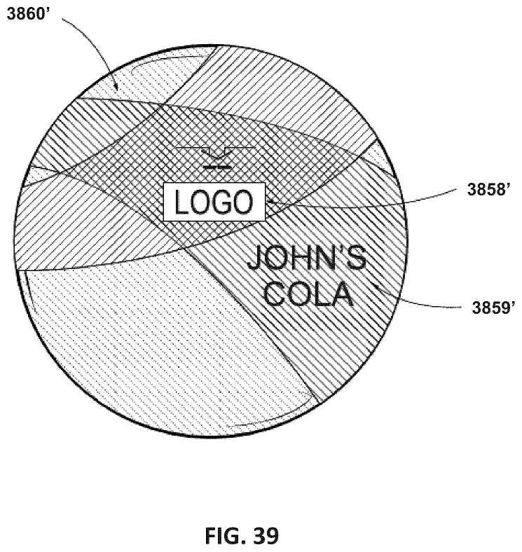

In some embodiments, such as described herein, the controller may be configured to print one or more messages or icons on the film based on input from an external device/network. For example, the controller may be in communication with a remote device/server and receive instructions or other data that may cause the controller to cause printing on the film, such as using the printer 3250. As an example, the sealing apparatus 3170c, 3170c′ may be in communication with a point-of-sale (POS) system (e.g., the POS system 3013 shown in FIG. 35). In such an embodiments, the POS system may receive an order that may include one or more drink orders. In response, the controller 3030 of the sealing apparatus 3170c may be configured to receive data corresponding to the order and control its operations accordingly, such as by printing a label on the film to indicate the drink order (e.g., “Cola” or “Diet Cola”). In some embodiments, the printed message or image may be customized, such as indicating the customer (e.g., “John's Cola”). In such a manner, the corresponding sealed lid may include the appropriately printed data that can be used with fulfilling the order. In some embodiments, the determination as to what to print may occur remotely from the sealing apparatus 10 and communicated thereto, such as at the POS system 3013 or some other remote system. An example customized lid 3860′ with a logo 3858′ and a printed customized message (“JOHN'S COLA”) 3859′ is shown in FIG. 39.

As noted above, the cup closer (e.g., sealing device 3170c) and/or the components thereof may form part of a beverage forming apparatus or system (e.g., dispenser 10 of FIG. 1). For example, the beverage forming apparatus/system may create (e.g., mix, satisfy, dispense, form, etc.) a beverage order, such as pour a cup of soda, water, or juice, from one or more supplies. In addition to forming the beverage, the beverage forming apparatus/system may employ various components/systems described herein (e.g., a sealing apparatus) in conjunction with creating the beverage such that the beverage is produced to a customer with a sealed lid. In some embodiments, such as described herein, the sealed lid may include one or more identifying messages or images appropriate for the created beverage.

In some embodiments, the controller may be configured, such as in response to certain operation conditions, to have the printer print a specific code on the film to provide one or more indications to an operator, such as the position of a splice, an amount of film remaining in the supply, or other indication. In the case of the splice, this may allow the sealing device to alert the operator that a certain film and/or components within the sealing device may be non-functional (e.g., due to presence of splice). In the case of an amount of film remaining, the operator may be alerted that the sealing apparatus may need a replacement supply of film (e.g., due to an indication of a low amount of film supply remaining).

### Example Securing Head Assembly

The securing head assembly of the apparatus can contain a housing, at least one heating element, and sensor assembly among other components as described herein. The securing head assembly can further include a plate, such as a shield plate or bearing plate, as further discussed herein. Although described herein as an assembly, in some embodiments, one or more components may not be part of an assembly and may be generally a part of the overall device.

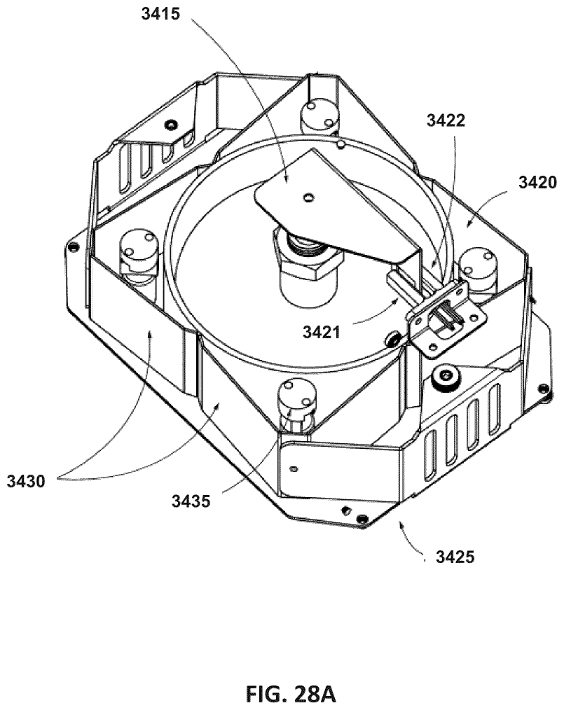

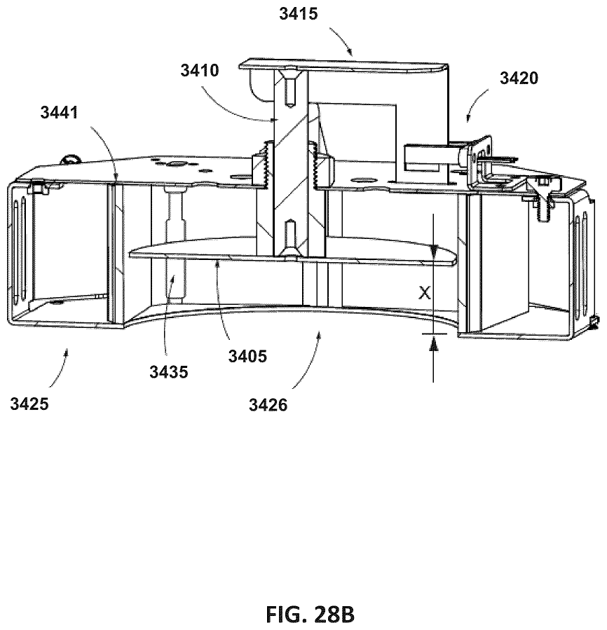

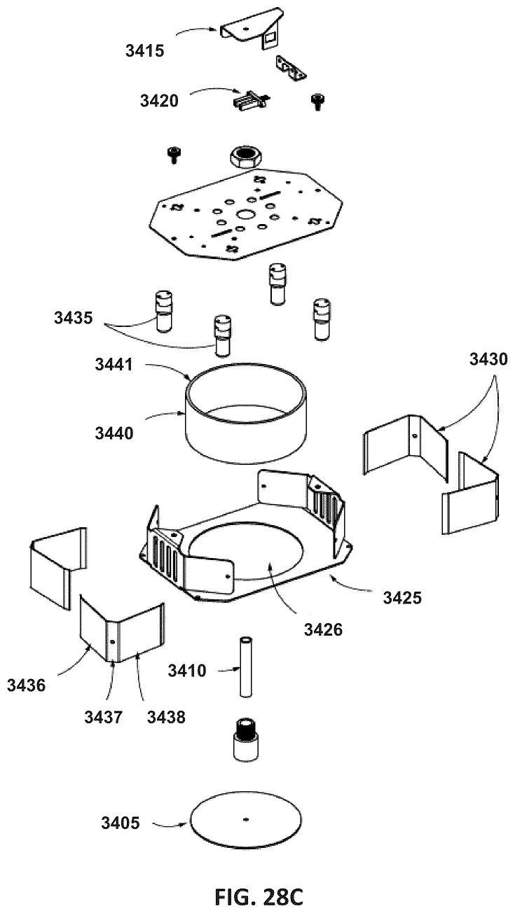

FIGS. 28A-28C respectively depict a top perspective view of the securing head assembly in partial phantom, an enlarged cross-sectional side view of the securing head assembly, and an exploded view of a securing head assembly. As shown, the securing head assembly includes a housing 3425 defining an aperture 3426 sized to receive at least a top portion of a cup therethrough so that the top portion of the cup may fit within the sealing portion 3301, 3301′ (shown in FIGS. 24A and 24B). As shown, a wall 3440 is disposed within the housing which has a width dimension (e.g., diameter) sized to receive at least a top portion of a cup. In the illustrated embodiment, a shield plate 3405 is movable within the sealing portion 3301, 3301′ and with respect to the wall 3440 between a first position and a second position, although other configurations are contemplated herewith as further discussed. The first position of the shield plate 3405 is shown in FIGS. 25A and 25C. FIG. 25B and FIG. 28B depict the shield plate 3405 moving from the first position and towards the second position. In some embodiments, when the shield plate 3405 reaches a predetermined distance, such as a top portion 3441 of the wall 3440, the shield plate is in the second position, as further discussed herein. As described herein, however, in other embodiments, the shield plate may be fixedly positioned within the sealing portion.

### Example Housing

The housing 3425 of the securing head assembly defines a sealing portion 3301, 3301′ that can house the shield plate 3405 therein when in the first position. Furthermore, the aperture 3426 can be sized to receive at least a top portion of a cup when the shield plate is translated. The aperture 3426 and the sealing portion 3301, 3301′ can be dimensioned and shaped to accommodate at least a top portion of a variety of cups. For example, the aperture 3426 defined by the housing 3425 can be a circular aperture with a diameter larger than the average diameter of a cup, such as a disposable drinking cup. In one embodiment, the diameter can range up to approximately 30 cm, and in one embodiment can be approximately 15 cm. The aperture 3426 can have any suitable shape such as polygonal, square, rectangular, elliptical, rectilinear, ovoid, circular, or irregular. The aperture 3426 of the securing head assembly can coincide with any additional apertures of the apparatus 3170 to facilitate movement of the cup within the sealing portion of the securing portion 3300, 3300′.

As referenced above, the securing head assembly 3400 can further include a wall 3440 that can be disposed within the housing 3425. The wall can create a barrier between the heating element(s) and the film disposed on the cup. As such, the wall can protect the heating element from having the film melt onto the heating element. In certain embodiments, the wall can also protect the cup and user from broken heating elements, e.g., broken bulbs. As shown in the example of FIG. 27B and FIG. 28C, the wall 3440 is embodied as a glass tubular structure that tracks along a periphery defining the aperture 3426. Such structure allows the energy to emanate through the wall, but still protect the heating elements, as discussed below. The tubular structure complements the shape of the cup inserted therein. The wall 3440 can have any suitable shape, for example defining a polygonal, square, rectangular, elliptical, circular, ovoid, circular, or irregular tube. The wall 3440 can have a width dimension sized to receive at least a top portion of a cup. For example, in some embodiments, the width dimension (e.g., diameter) of the wall 3440 is at least the width dimension of the aperture 3426 defined by the housing 3425. The wall can furthermore deflect corners of a film disposed on a cup downward toward a rim of the cup to better position the film for securement to the cup, as further discussed herein.

In an alternative example, the at least one wall can be disposed about the at least one heating element. Accordingly, in one embodiment, the wall can be embodied as a glass tubular protective structure that houses the heating element therein. Any inadvertent rupturing of heating elements, such as broken bulbs, can be contained within the glass tubular structure and be contained therein. In such an example, a portion of the glass tubular wall can have a reflective surface or coating, and the remaining portion of the glass tubular wall can be configured to reflect energy from the heating element in a desired direction. In some embodiments, the wall (e.g., a protective structure) may also be configured to filter out undesirable wavelengths of electromagnetic radiation produced by the heating elements (e.g., the UV component of energy emitted by the tungsten-halogen light bulbs)

The wall 3440 can be made of any suitable material. For example, the wall 3440 can be made of glass, plastic, or metal or fiber screening. In some embodiments, the wall 3440 may be at least partially transparent or translucent to permit energy emanated from the at least one heating element 3435 through the wall 3440. In other embodiments, the wall can include opaque sections and transparent sections to focus the energy through the transparent sections. In some embodiments of the disclosed subject matter, the wall 3440 can be coupled to the shield plate 3405 (when provided) and also be movable with the shield plate3 405 between the first and second positions. That is, as the shield plate 3405 moves position, the wall 3440 can move therewith. However, in the embodiment of FIGS. 28A-28C, the wall 3440 remains static and the shield plate moves with respect to the wall between positions. As such, the wall 3440 may be coupled to the housing 3425 as shown in FIG. 28B, wherein the shield plate 3405 is movable with respect to the wall 3440 between the first position and the second position. That is, movement of the shield plate 3405 does not move the wall 3440. As shown in FIG. 28B for purpose of illustration and not limitation, the shield plate 3405 is moveable within the aperture and the wall 3440 between a first position and a second position along an axis defined by the wall 3440. In some embodiments, the wall 3440 can be coupled to the housing 3425 along a circumference of the aperture.

### Example Heating Elements

As shown in the example of FIGS. 28A and 28B, at least one heating element 435 is disposed within the housing and positioned external to the wall 440. In the embodiment of FIG. 28A, the at least one heating element 3435 comprises four heating elements as further discussed herein, but any suitable number of heating elements is contemplated herein. The at least one heating element 3435 is activated to emanate energy towards the wall 3440 when the shield plate is in the second position. Furthermore, the at least one heating element can deactivate while still in the second position after a predetermined length of time to ensure safety of the apparatus. The emanated energy can interact with a film disposed between the shield plate and a cup to couple the film to the cup. The securing head assembly may further include a sensor assembly 3420 to sense movement of the shield plate 3405 and to activate the at least one heating element 3435 when the shield plate 3405 is in the second position. A loading zone 3325 is configured to receive a predetermined dimensioned film from the body portion (e.g., portion 3505a), as shown in FIG. 25A and as further discussed herein. The loading zone 3325 is positioned adjacent the shield plate 3405 in the first position. As shown by FIGS. 25A-25C, a top portion 3602 of a cup 3600 is movable within the aperture 3426 and wall 3440 to move the shield plate 3405 to the second position and to secure a predetermined dimensioned film portion 3505a to a top of a cup 3600. This is accomplished by energy from the at least one heating element 3435 causing the film portion 3505a to shrink around the top portion 3602 (e.g., a lid) of the cup 3600—thereby forming a seal, such as shown in FIG. 25C. As noted herein, the film portion 3505a may include one or more radiation-absorbing layers of ink that shrink upon application of heat.

The at least one heating element can comprise any suitable device that can be configured to emanate a suitable amount of energy to cause the film to secure to a cup to form a seal thereon. In one example, the at least one heating element comprises a light bulb containing a tungsten filament (e.g., a tungsten-halogen light bulb). Other examples include, but are not limited to, a resistor, a cathode ray tube, a light emitting diode, a carbon filament bulb, a ceramic heater, amongst others. In some embodiments, the heating element(s) may be chosen/tailored to the specific component of the film which absorbs the radiant heat (e.g., carbon black pigment or other near infrared absorbing pigment/dye which could be a component of the applied coatings/inks). For example, an appropriate heating element (e.g., a bulb, an LED, a heater, etc.) may be chosen that radiates a type of heat that maximizes efficient absorption from the type of film and/or ink/coating thereon for sealing purposes. In some embodiments, two or more different types of heating elements may be installed in the sealing device and the most efficient/effective type of heating element may be chosen to operate based on the film that is currently being utilized (such as described with respect to various embodiments herein).

The at least one heating element c435 can be activated, such as via a controller (e.g., controller 3030 of FIG. 35) to emanate energy. In this regard, the term “emanate” may encompass any type of heat transfer to the film (e.g., conduction, convection, radiation, transfer, etc.). In this regard, though the described example light bulbs radiate energy, some embodiments of the present invention contemplate other types of heating elements that emanate energy via other methods, such as convention, conduction, heat transfer, radiation, etc.

For example, the at least one heating element 3435 can comprise a light bulb that illuminates when the shield plate 3405 moves between a first position and a second position. The emanated energy from the at least one heating element 3435 can contact and heat the film, causing it to shrink. For example, energy from the at least one heating element can pass through wall 3440 to contact the film. As discussed further below, the shrinkage of the film causes the film to secure or tightly secure to or around a lip, rim, or edge of a cup. As used herein, shrinkage of the film creates a seal around the cup opening where the film has substantially sealed the opening. In some embodiments, the film is not adhered or heat glued to the cup, but rather is heat-shrinked to itself. In some embodiments, the film can cooperate with the cup to melt and fuse together. For example, the cup can include a coating that interacts with the film upon the activation of energy thereto.

In embodiments that include a plurality of heating elements, the plurality of heating elements can be activated simultaneously when the shield plate 3405 is in the second position to effectuate a uniform melting of the film about the cup. As used herein, the term “simultaneously” or “simultaneous” means at the same time or nearly at the same time such that any difference in activation is not readily apparent or detectable. The at least one heating element 3435 can be positioned at any suitable location within the apparatus 3170c. For example, in one embodiment, the at least one heating element 3435 can be disposed between the wall 3440 and the surrounding housing of the securing head assembly 3400. In other embodiments having a plurality of heating elements, the heating elements 435 can be equally radially spaced around a central axis defined by the wall 3440.

In some embodiments, each of the plurality of heating elements may be activated individually. Similarly, in some embodiments, groups of the plurality of heating elements may be activated together (e.g., in the case of four heating elements, a first group of two heating elements can be activated at the same time and then the second group of heating elements can be activated at a same second time). In some embodiments, the heating elements may be activated individually or in groups to achieve a desired effect (e.g., reach different temperatures, heat different sections of the film, etc.), such as for efficiently securing the film to the cup. In some embodiments, the size or shape of the cup may be detected and/or determined and the heating elements may be activated individually or in groups according to the detected and/or determined size or shape. In some embodiments, the ink applied to the film may be detected and/or determined and the heating elements may be activated individually or in groups according to the detected and/or determined ink.

The at least one heating element can be activated for a predetermined time once the heating element receives a signal for activation, such as from a controller. Alternatively, the at least one heating element can be activated while the shield plate remains in the second position.

In some embodiments, the heating element(s) may be configured to be replaceable to facilitate quick and easy replacement thereof. For example, the connection of the heating element(s) to the sealing apparatus may comprise a quarter turn connection or other type of connection.

In accordance with some embodiments, the apparatus 3170c, 3170c′ can comprise at least one reflective device 3430 disposed within the housing 3425 and exterior to the wall 3440. The reflective device 3430 reflects at least a portion of energy from the heating element 3435 toward the wall 3440 when the shield plate is in the second position. This energy propagates through the wall and is imparted upon the film ready to be secured to the cup, as noted above. In some embodiments, the at least one reflecting element 3430 comprises a mirror. In other embodiments, the at least one reflecting element 3430 can comprise any suitable mechanism to allow energy to be redirected in a desired direction, such as but not limited to a metal piece, a plastic piece, a painted piece, a reflective coating, amongst others.

As shown in the illustrated embodiments of FIGS. 28A and 28B, the apparatus comprises a plurality of reflecting elements 3430 that can be arranged to form a continuous perimeter about the at least one heating element 3435. As shown, there are four reflecting elements in FIGS. 28A-C. In some embodiments, and as shown for example in FIG. 28C, each reflecting element 3430 comprises a first panel 3436, a second panel 3437, and a third panel 3438, wherein the first panel 3436 is disposed at a first angle relative to the second panel 3437, and the third panel 3438 is disposed at a second angle relative to the second panel 3437. In some embodiments, the first angle can be the same as the second angle. In alternate embodiments, the first and second angles can differ. Either or both of the first and second angles can be any suitable angle, for example in a range of about 20-70 degrees. In other embodiments, the reflecting element can include a monolithic curved plate embodied as the first, second, and third panel.

### Example Shield Plate

As shown in FIG. 28B, the apparatus can include a movable shield plate 3405 (although in some embodiments the shield plate may be fixed so as to not be movable within the sealing portion). As depicted in the example of FIG. 28B, the shield plate 3405 is movable and can be coupled to a guide rod 3410. The guide rod 3410 can facilitate movement of the shield plate 3405 from the first position to the second position. The guide rod 3410 can be of any suitable shape and can guide the shield plate 3405 along any suitable movement trajectory between the first position and the second position within the sealing portion 3301, 3301′. For example, and as shown in FIGS. 28B and 28C for purpose of illustration and not limitation, guide rod 3410 can have a longitudinal shape and can guide shield plate 3405 along a vertical axis. In some embodiments, the vertical axis can be parallel to an axis defined by a center of the wall 3440. In other embodiments, guide rod 3410 can have a different shape and can guide the shield plate 3405 along a different trajectory between the first position and the second position, such as a curved trajectory. The shield plate in embodiment of FIG. 28B is illustrated at a distance X above a portion of the housing for purposes of discussion. In some embodiments, it is contemplated herewith that the shield plate only need to move a minimal distance suitable to signal the sensors of the housing in order to activate the heating element. Thus, the shield plate can have a short stroke distance to activate the apparatus. As noted above, the guide assembly enables the minimal distance required for activation as the guide assembly loads the film in a ready position into the loading zone.

In an alternative embodiment, the shield plate is static and disposed at a distance above the aperture 3426 to allow a top portion of the cup to press a film there against. Such distance required for operation may be minimized due to the guide assembly, as referenced above. In such embodiments, the apparatus can include a sensor assembly adjacent the aperture 3426 that detects when an object, such as the film and top of the cup, breaks a plane of the aperture (or at least breaks a plane at a distance above the aperture) to signal the heating element to activate. In this embodiment, the static shield plate can be disposed beyond the aperture to provide a surface for the film to be pressed against by a top of the cup while the heating element is activated. In yet another embodiment, the sensor assembly can be disposed in any suitable location to signal when the film is pressed against the shield plate by a top of the cup and in a ready configuration, as further discussed herein. In some embodiments, a top wall of the securing head assembly may perform the same function as the fixed shield plate such that no shield plate is needed.

The shield plate 3405 can be made of any suitable material that absorbs minimal energy from the heating element or is at least partially retardant thereto. In some embodiments, the shield plate is nonconductive and does not absorb energy. For example, the shield plate can be made of certain plastics, metals, wood, or other suitable materials. In one embodiment, the shield plate comprises aluminum. The shield plate 3405 is preferably at least partially opaque with respect to energy emanated by the at least one heating element 3435. Thus, the shield plate 3405 can protect a portion of the film from energy emanated by the at least one heating element. The shield plate, in some embodiments, can be biased towards the first position by gravity and by the weight of the shield plate itself. In other embodiments, the apparatus can include a biasing mechanism such as a spring to further bias the shield plate toward the first position to ensure the shield plate returns to the first position after use.

### Example Sensor Assembly

In accordance with some embodiments, a sensor assembly can be operatively coupled to the shield plate 3405 when the shield plate is embodied as a movable part. In other examples, such as when the shield plate is embodied as a static part, the sensor assembly can be positioned within the apparatus beyond the aperture, as discussed above.

In the embodiment shown in FIG. 28A, the sensor assembly includes a signal emitter 3421, a signal sensor 3422, and a sensor flag 3415 therebetween. The sensor flag positioning can directly correspond to the position of the shield plate as moved by the cup. The signal emitter can continuously emit a signal capable of being detected by the signal sensor. The sensor flag 3415 can be positioned between the signal emitter and the signal sensor, such that sensor 3flag 415 blocks the signal where opaque. However, the sensor flag 3415 can further define a window therein at a predetermined location in order to allow the signal to trigger the signal sensor. Accordingly, as the signal flag 3415 moves between the signal emitter and signal sensor, the window can allow transmission of the signal to the signal sensor. The signal sensor, upon detecting the signal, can register that the shield plate 3405 has moved between the first position and the second position and generate a sensor input. In other embodiments, a reverse set up can be provided. That is, the sensor flag 3415 can allow transmission of the signal to the signal sensor until it is blocked by the flag once the shield plate 3405 has moved between the first position and the second position. The signal sensor, upon detecting the reduction of the signal, can register that the shield plate 3405 has moved between the first position and the second position and generate a sensor input to activate at least one heating element 3435. Similarly, the signal sensor can deactivate the heating element(s) once the signal flag 3415 moves back between the signal emitter and signal sensor, or as the signal sensor returns to its first state.

In other embodiments, the sensor can be any sensor 3420 suitable for detecting the movement of the shield plate 4305 between the first position and the second position, or detect when the film and top of the cup breaks a threshold plane when the shield plate is embodied as a static part. For example, the sensor 3420 can include at least one of a signal sensor as described, a mechanical sensor, a motion sensor, amongst others. A mechanical sensor can include a rotational sensor, that is rotated by movement of the shield plate, a guide rod, a sensor flag, or another part coupled to the shield plate, and registers movement of the shield plate upon rotation, or registers other movements as contemplated herein. For example, a mechanical sensor can register a degree of movement by the amount of rotation.

The sensor input generated by sensor 3420 can activate the at least one heating element 3435 when the shield plate 3405 has moved between the first position and the second position, or detect when the film and top of the cup breaks a threshold plane when the shield plate is embodied as a static part. Thus, at least one heating element 3435 can be activated to emanate energy when the shield plate 405 is in the second position, initiating a securing cycle.

### Example Additional Components

The securing portion 3300 can further include any additionally desired components. Accordingly, the securing portion can include a base portion 3320 as shown in FIG. 23A. In some embodiments, the base portion 3320 can be reflective to assist a user in aligning a cup in the proper position. As such, the reflective base portion 3320 can assist a user to insert a cup into an approximate center of the aperture or can otherwise assist in positioning the cup within the aperture in the proper location and ready for securement.

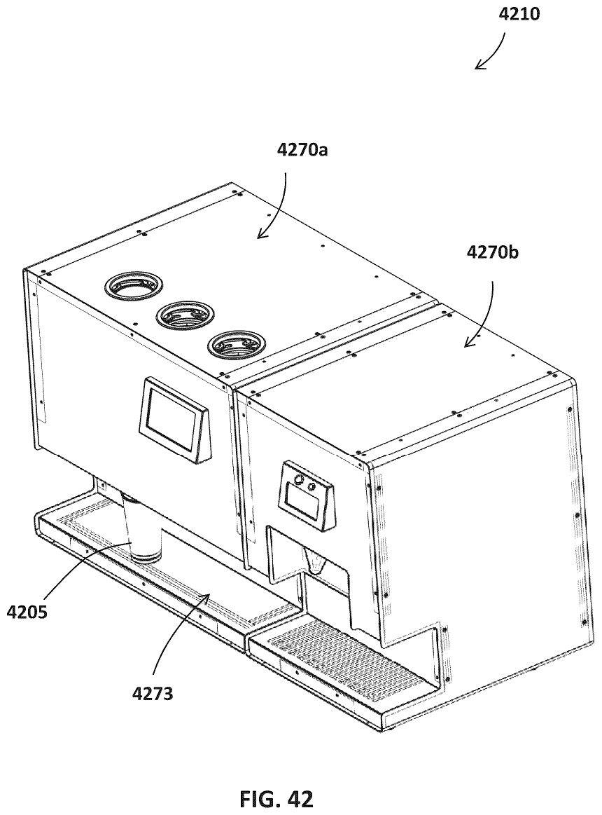

As shown in FIGS. 24A and 42B, the securing portion 3300, 3300′ can further contain a fan 3305, 3305′ or a cooling mechanism to at least partially regulate the temperature of the securing portion 3300, 3300′. In such embodiments, the securing portion 3300, 3300′ can further include a temperature sensor, a time keeper, or the like to either sense or calculate the temperature of the securing portion 3300, 3300′. The temperature regulation allows the apparatus 100, 100′ to have improved repeat usability and to enhance safety. For example, the temperature regulation reduces the ability of the securing portion 3300, 3300′ to overheat, which may cause damage to various components of the sealing apparatus and/or the cup or may cause the film to improperly melt in an undesired manner. Additionally or alternatively, the partial temperature regulation allows for improved safety, for example by decreasing the risk that a person that comes into close proximity or contact with the securing portion 3300, 3300′ may be exposed to undesirable heat. The fan 3305, 3305′ can function to channel air toward the interior of the securing head assembly, or alternatively, away from the interior of the securing portion 3300, 3300′. Furthermore, the securing portion 3300, 3300′ can contain more than one fan 3305, 3305′ or other cooling devices known in the art.

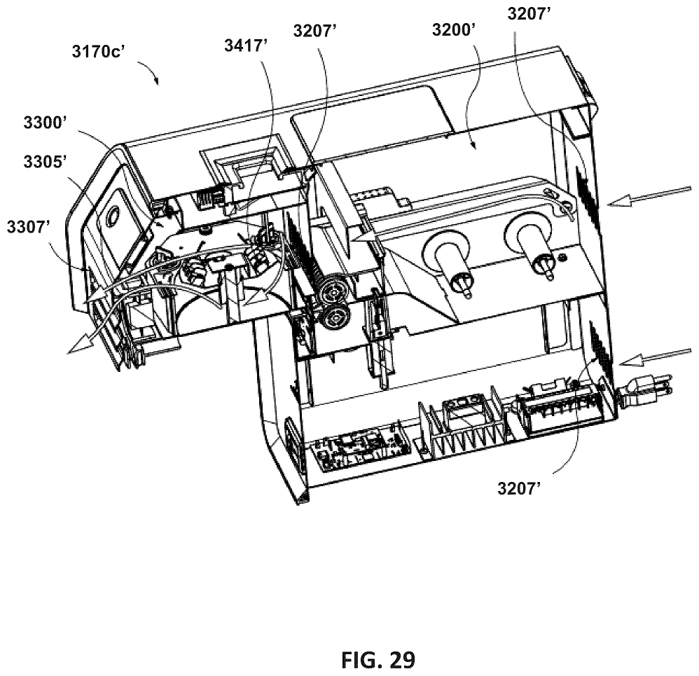

In some embodiments, various vents or louvers may be employed within the apparatus 3170c, 3170c′ to regulate heat within body portion 3200, 3200′ and/or securing portion 3300, 3300′. For example, with reference to FIGS. 24A and 29, the securing head assembly 3400′ includes two louvers 3417′ that are configured to vent heat from within the sealing portion 3301′. Further, the apparatus 3170c′ may include various vents 3307′, 3207′ that are configured to enable air flow through the various components of the apparatus 3170c′. For example, FIG. 29 illustrates an example air flow (shown by arrows) through the apparatus 3170c′, such as may be due to the fan 3305′ pulling air from within the apparatus 3170c′ and pushing the air out to the environment through vent 3307′.

In some embodiments, the fan 3305, 3305′ may be configured to operate or not operate at certain points during a life cycle of a sealing operation. For example, the controller may be configured to cease operation of the fan 3305, 3305′ during operation of the heating elements 3435 so as to enable efficient heat transfer to the film portion 3505a for shrinking thereof (and forming a seal around a top of a cup). In some embodiments, after deactivation of the heating elements 3435, the controller may be configured to cause the fan 3305, 3305′ to operate to cool down the inside of the apparatus 3170c, 3170c′. Further, in some embodiments, the controller may be configured to cease operation of the fan 305, 305′ after a certain amount of time, such as to preserve power for the apparatus 3170c, 3170c′ and/or prolong the overall life of the fan 3305, 3305′.

### Example User Interface

The apparatus 3170c, 3170c′ can be configured to receive inputs and commands. Such inputs and comments can be effectuated by way of a user interface operatively coupled with the apparatus. Alternatively or additionally thereto, the apparatus can be configured to receive inputs and comments remotely or wirelessly from a user or other electronically coupled devices.

In some embodiments, the securing portion 3300, 3300′ includes a user interface to receive inputs and commands from a user. The user interface can include an indicator 3310, 3310′ to display information to a user and at least one input device 3315 to receive information. Furthermore, the indicator and input device can be combined as one device. In some embodiments, the indicator 3310, 3310′ can include but is not limited to at least one of an electronic display (such as LED, OLED, LCD and the like), a light, a rotating indicator, sound device, an actuating indicator, a touchscreen, a smart device, or the like. The indicator 3310, 3310′ can indicate the status or mode of the apparatus 3170c, 3170c′. For example, the indicator 3310, 3310′ can indicate that the apparatus 3170c, 3170c′ is in a ready state, a securing state, a preparing state, or another state. Additionally or alternatively, the indicator 3310, 3310′ can indicate how many cycles the apparatus has performed since reset, the status of adjustable settings, repair information, a warning such as to replace a roll of film therein, and/or other information about the apparatus, as desired. Upon operation of the apparatus 3170c, 3170c′ for example, the indicator 3310, 3310′ can indicate completion of a securement cycle.

In some embodiments, the at least one input device 3315 can include at least one of a push button, a lever, a dial, a virtual input on a graphical user interface, or the like. The at least one input device 3315 can adjust at least one adjustable setting of the apparatus 3170c. For example and not limitation, the at least one input device 315 can adjust the operation of the securing head assembly 3300. Additionally or alternatively, the at least one input device 3315 can include a command capable of being understood by a computer (e.g., controller 30). The indicator 3310, 3310′ and the input device 3315 can, in some embodiments, work in parallel and are not dependent on each other. In some embodiments, the input device 3315 can display the value of the information received, for example, the input device 3315 can comprise a dial that displays the value associated with each radial position of the dial. Additionally or alternatively, the apparatus can operatively cooperate with an external device, such as a smartphone, tablet, or external computer. As such, the apparatus can send and/or receive commands by such external devices. Thus, any indications contemplated by the indicator 3310 or inputs by the input device 315 can be sent to and from the external device.

In some embodiments, and as further discussed herein, the apparatus further includes a computer (e.g., controller 3030 of FIG. 35) therein or be configured to cooperate with an external computer or device. The computer can be configured to at least one of control the apparatus, control the indicator 3310, 3310′, receive information from the at least one input device 3315, store adjustable settings, and communicate with an external device. Additionally or alternatively, the computer can be configured to process information, for example warning information, status information, and mode information, among others. In some embodiments, the computer can coordinate the operation of the apparatus 3170c, for example by receiving sensor inputs and activating certain functionalities in accordance with the adjustable settings. The computer can be internal or external to the apparatus. The apparatus can furthermore include any devices necessary to ensure the apparatus carries out its operation, such as a circuit board 3260, 3260′.

In some embodiments, the user interface may be configured to display and receive user input, such as one or more user selections. For example, in some embodiments, a user may be able to select and/or provide instructions for the apparatus 3170c, 3170c′. As an example, the user interface may display printing options for a user to select from for printing on the film (such as with the printer). In some embodiments, the user may enter a desired message for printing on the film. In such embodiments, the resulting sealed lid will then include the user selected message and/or image.

### Example Methods of Use of the Cup Closer

Some example methods of operating the apparatus are discussed throughout the description and in relation to the figures. According to some embodiments, the method comprises providing an apparatus having a body portion to house film, and a securing head assembly. The securing head assembly includes a housing defining an aperture to receive at least a top portion of a cup, a wall disposed within the housing, a shield plate movable within the aperture and wall between a first position and a second position, at least one heating element disposed within the housing and positioned external to the wall, a sensor assembly to sense movement of the shield plate and to activate the at least one heating element when the shield plate is in the second position, and a loading zone to receive a predetermined dimensioned film from the body portion. The wall has a width dimension sized to receive at least a top portion of a cup. The at least one heating element is activated to emanate energy when the shield plate is in the second position. The loading zone is positioned adjacent the shield plate in the first position. The method further includes moving the top portion of the cup relative to the aperture to move the shield plate to the second position and to secure a predetermined dimensioned film to a top of the cup by energy from the at least one heating element. The method may further include moving the shield plate from the second position toward the first position, such as to deactivate the at least one heating element and/or after a period of time has elapsed.

In accordance with the disclosed subject matter, cups that can be used in conjunction with the disclosed subject matter can be of any suitable shape and size. For example, in some embodiments, cups that can be used in conjunction with the disclosed subject matter have a rim, lip or flange at the top portion of the cup. In some embodiments, the film can shrink around the lip or flange and thereby be secured to the top portion of the cup. In other embodiments, cups that can be used in conjunction with the disclosed subject matter have at least one of tabs, threads, ribs, panels, or other features to facilitate securement of the film to the cups.

As disclosed herein, the devices presented herein can be used for securing film to cups. The cups can contain a product held therein. Such products can include any type of product suitable for the cups, such as fluids or flowable products, beverages, food products and the like. The products can also include non-flowable products like solids and semi-solids of any of the above categories and more.

In accordance with the disclosed subject matter, in some embodiments cups that can be used in conjunction with the disclosed subject matter can be made of plastic, paper, metal, biodegradable materials, recycled materials, and/or reusable materials, among others. The material construction of the cups can complement the kind of film used to affect a secure film attachment. In some embodiments, the disclosed subject matter can secure a film to the top of cups ranging from about 200 mL to about 800 mL in capacity.

The disclosed subject matter can be combined with other features as well. For example, in some embodiments, the disclosed subject matter can be combined with a cup filling assembly (e.g., cup filler 70b) in an integral dispensing unit (e.g., dispenser 10). For example, the apparatus of any of the embodiments of the disclosed subject matter can further comprise a fill nozzle, chute, funnel, or tube, among others, capable of filling product into the cup before securing the film. Additionally or alternatively, in other embodiments, product can be filled into the cup after securing of the film, for example through a portion of film pierced by the piercer 3220. In this manner, known filling assemblies can be incorporated with the disclosed subject matter.

In some embodiments, the disclosed subject matter can be combined with a cup moving assembly. For example, the apparatus of any of the embodiments of the disclosed subject matter can further comprise a mechanically movable gripper (e.g., a cup transfer element) to hold and/or move cups. The mechanically moveable gripper can be of any suitable format. Alternatively, the apparatus can include a cup seat (e.g., a cup transfer element) to move cups disposed therein and/or a cup platform (e.g., a cup transfer element) to move cups disposed thereon, as known in the art. In other embodiments, the apparatus can comprise a plurality of moveable levers for moving a cup, amongst others. In some embodiments, the various cup transfer elements may be configured to hold and/or move a cup to interact with the apparatus of the disclosed subject matter, for example by rotational, linear, or other actuation. In this manner, known cup moving assemblies can be incorporated with the disclosed subject matter.

### Example Marking Scheme System for the Cup Closer

Some embodiments of the present invention may provide a system for ensuring that an approved film is utilized with the sealing device. In this regard, there may be a desire to avoid usage of unauthorized rolls of film with the sealing apparatus, such as to avoid providing an unsatisfactory film or avoid potential maintenance issues.

For example, one or more film sensors (e.g., film sensor 3240) may be used to read one or more markings on the film, once the film is loaded into the apparatus 3170c, 3170c′. The sensor data may be sent to a controller (e.g., controller 3030 of FIG. 35), which may then determine, based on sensor data from the film sensor, if a detected one or more markings on the film satisfies an approved marking scheme. For example, the controller may be configured to access a database (such as in memory) of approved marking schemes and determine if the detected markings and/or marking scheme match (or sufficiently match) one of the approved marking schemes. In some embodiments, the controller may determine that certain marking characteristics of the detected markings matches (or sufficiently matches) one of a set of approved marking characteristics. Then, if approved, the apparatus 3170c, 3170c′ and/or various functions/components (e.g., such as described herein) of the apparatus 3170c, 3170c′ may be enabled for use. If unapproved, the apparatus 3170c, 3170c′ and/or various functions/components (e.g., such as described herein) of the apparatus 3170c, 3170c′ may be disabled. Additionally, reports of the approved or unapproved film usage may be provided to a remote server for data generation and use (e.g., re-ordering, maintenance, etc.). In some embodiments, the controller may cause the sensor data to be sent to a remote server to determine whether or not the detected one or more markings satisfy an approved marking scheme at the remote server.

In some embodiments, the controller may be configured to determine a film marking scheme for the film based on the detected one or more markings. For example, the determined film marking scheme may correspond to a marking pattern comprised of a plurality of markings and determined spacing between each adjacent marking within the plurality of markings. In some embodiments, the controller may determine the film marking scheme based on at least one of the color of the one or more markings, a width of the one or more markings, a length of the one or more markings, a spacing between adjacent markings, etc.

In some embodiments, the determined film marking scheme may be repeated along the length of the roll of film such that the roll of film comprises a plurality of repeated film marking schemes. In such an embodiment, the film can be checked (e.g., continuously or periodically) and reconfirmed to avoid switching to an unapproved film after an initial loading takes place. Additionally or alternatively, in some embodiments, a body lid switch may be employed that provides an indication to the controller when the body lid has been opened. In response, the controller may check the marking scheme to confirm that the installed film includes an approved marking scheme.

In some embodiments, the determined film marking scheme may be checked against an approved marking scheme, such as via a controller. In response, one or more operations of the sealing device may be affected based on whether or not the detected marking scheme satisfies an approved marking scheme. For example, the controller may affect operation by enabling operation, disabling operation, or changing operation of the sealing device and/or one or more components of the sealing device. In some embodiments, the current or future operation (e.g., cycles) of the sealing apparatus may be affected.

In some embodiments, the controller may be configured to cause, in an instance in which the detected one or more markings satisfies the approved marking scheme, enabling operation of the sealing device and/or components thereof. For example, the controller may enable power to transfer to the sealing device (or its components); enable operation of the motor, enable operation of the heating element(s), enable operation of the printer, enable operation of the piercer, and/or enable operation of other various components.

Additionally or alternatively, in some embodiments, the controller may be configured to cause, in an instance in which the detected one or more markings does not satisfy the approved marking scheme, disabling operation of the sealing device and/or components thereof. For example, the controller may cut off power to the sealing device, disable the motor, disable the heating element(s), disable the printer, disable the piercer, or other various components.

Additionally or alternatively, in some embodiments, the controller may be configured to change or alter operation of one or more components of the sealing device. For example, if the detected one or more markings does not satisfy the approved marking scheme, the controller may cause one or more components to operate in a reduced or hindered capacity to discourage further use of the unauthorized film. For example, the controller may decrease a speed of operation of the motor, cause the film to misalign with the top of the cup, decrease a speed or temperature of operation of the at least one heating element, cause the printer to print one or more messages or images in an off-center position on the film, cause the printer to print one or more messages indicating that an unapproved film is being utilized, increase a delay time between sealing operations performed by the sealing device, or cause the piercer to pierce the film in a undesired location. As more examples, the controller may cause an increased or over anticipated amount of film to be used to cause faster depletion of the unauthorized supply of film and/or misalignment of features to provide a less desirable end product.

In some embodiments, the one or more markings may be read and used to provide information (e.g., characteristics) relevant to the installed film. For example, various characteristics of the film (e.g., thickness, pre-printed information, etc.) may be determined and/or various desired operational parameters of the sealing apparatus during use with the film (e.g., how long to activate the heating element(s), what to print on the film, whether or not to pierce the film, etc.) may be determined. For example, an installed roll of film may have a thickness that would require a longer than normal time of operation for the heating element(s) to remain active for providing a sealed lid. Similarly, the planned lid may be printed with a lighter ink that may require a different than normal amount of time of operation for the heating element(s) to remain active for providing a sealed lid.

For example, in response to determining one or more characteristics of the one or more markings, the controller may further determine a desired operation of one or more components of the apparatus based on the detected one or more characteristics and cause operation of the one or more components of the apparatus based on the determined desired operation. As an example, the controller may cause the at least one heating element 3435 to operate according to at least one of a specific amount of time or a specific heat based on the determined one or more characteristics (e.g., the specific film may require a certain heat for proper shrinkage and sealing). As another example, the controller may cause the motor 3213′ to operate according to at least one of a specific amount of time or according to a specific number of detected markings based on the determined one or more characteristics (e.g., the film may correspond to a specific product and/or may be designed for use with a specifically-sized cup—which may lead to a desire to provide a portion of film of a specific length to the sealing portion 3301, 3301′). As yet another example, the controller may cause the piercer 3220, 3220′ to operate based on the determined one or more characteristics (e.g., the associated product may not require the piercer to operate or it may be desirable to utilize the piercer to provide a slit/perforation in a specific location or of a specified dimension). As yet another example, the controller may cause the printer 3250 to operate based on the determined one or more characteristics, such as by printing one or more messages or images on the film based on the determined one or more characteristics (e.g., the associated product that is utilized with the film may be associated with a certain logo to be printed on the film). In addition to the above examples, other example operations/features that would be controllable are contemplated, such as providing a delay between dispenses of the film portion, controlling the fan air flow, controlling the motor operation speed, controlling which ones and how many heating elements to activate, controlling the user interface, among many others.

In some embodiments, the controller may determine one or more characteristics of the film based on the detected one or more marking characteristics. For example, the controller may determine at least one of the thickness of the film, the associated customer for the cup, the associated product for use with the film, a time of operation of the heating element, a subset of printing options to present to a user for selection, or the amount of film remaining on the roll of film. In the case of being able to determine the amount of film remaining on the roll of film, the marking scheme may further include a differentiating characteristic from among at least some of the marking schemes to thereby indicate a relative position along the roll of film (e.g., there may be countdown type characteristic applied to some of the marking schemes).

In some embodiments, the controller may be configured to communicate with a remote server. In some such example embodiments, the controller may be configured to receive an update (e.g., a software update) and update various functionality accordingly. In some example embodiments, the controller may communicate any gathered information to the remote server, such as with respect to usage data or other types of data.

### Example Cup Closer System Architecture

FIG. 35 illustrates an example system/environment in which some example embodiments of the present invention may be employed. The system 3001 may include an example sealing apparatus 3170c, 3170c′, such as described herein. The example sealing apparatus 3010 may comprise hardware and/or software capable of performing functions described herein. In this regard, the apparatus 3010 may include a roll of film 3009 (although the film may be in stacks in some embodiments) that includes a leading edge that extends through the sealing apparatus along a film path 3007. Additionally, the apparatus 3010 may include a controller 3030, a motor 3022, a memory 3032, a communication interface 3034, a user interface 3036, and a power source 3039. Further, the apparatus 3010 may include a printer 3050, a piercer 3020, a nip 3023, one or more film sensors 3025, a cutter 3027, and a sealing portion 3011 that are positioned along the film path 3007. The sealing portion 3011 may include one or more heating elements 3040 and a shield plate 3015. A user may position a cup 3006 within the sealing portion 3011 to cause sealing thereof. In this regard, various described components and features of the example system 3001 may correspond to components and features described herein, such as with respect to apparatus 3170c, 3170c′ (among the other described embodiments).

The controller 3030 may be any means configured to execute various programmed operations or instructions stored in a memory device such as a device or circuitry operating in accordance with software or otherwise embodied in hardware or a combination of hardware and software, thereby configuring the device or circuitry to perform the corresponding functions of the controller 3030 as described herein. In this regard, the controller 3030 may be configured to receive (such as via the communication interface 3034 or user interface 3036) and/or determine (such as based on sensor data) one or more instructions for operating one or more components of the apparatus 3010. In this regard, the controller 3030 may be connected to and control or cause operation of the user interface 3036, memory 3032, communication interface 3034, motor 3022, printer 3050, piercer 3020, film sensor(s) 3025, cutter 3027, shield plate 3015, and/or heating element(s) 3040. Though shown as a single controller, in some embodiments, various separate controllers (whether alone or in communication with each other) may perform functions described herein.

The one or more motors 3022 may be used to drive (e.g., through rotation or otherwise) the nip 3023 (e.g., the drive roller) to cause advancement of the film from the roll of film 3009 along the film path 3007. In some embodiments, the controller 3030 may be configured to operate the motor 3022 accordingly.

The printer 3050 may be configured to print on the film. In some embodiments, the printer 3050 includes ink that enables the printing, such as provided from one or more ink cartridges, tanks, reservoirs, etc. In some embodiments, the controller 3030 may be configured to instruct the printer 3050 to cause printing of various messages and/or images.

The film sensor(s) 3025 may be configured to detect one or more markings and/or marking characteristics of a marking scheme on the film, such as described herein. The film sensor(s) 3025 may be configured to provide the sensor data to the controller 30, such as described herein.

The cutter 3027 may be configured to operate to cut the film, such as in response to instruction from the controller 3030.

The heating element(s) 3040 may be configured to operate, such as based on instructions from the controller 3030 or other sensor assembly, such as described herein. In particular, in some embodiments, the heating element(s) 3040 may be configured to emanate energy to cause shrinkage of the film to or around the top portion of the cup 3006 to form a sealed lid thereon. In some embodiments, the formed seal may be configured to be absolute such that no liquid may leak around the seal. In other embodiments, the formed seal may be configured to be partial such that a portion of the top cup is unsealed or lightly sealed. In such an example embodiment, a user may be able to drink from the unsealed portion and/or peal back the unsealed or lightly sealed portion (e.g., to facilitate drinking therefrom and/or pouring therethrough).

The shield plate 3015 may be configured to provide a shielded surface for positioning of the cup 3006 within the sealing portion 3011. The shield plate 3015 may provide physical resistance and/or heat dispersion or other characteristic to aid in sealing of the cup 3006.

The memory 3032 may be configured to store instructions, computer program code, approved marking schemes and/or characteristics, and other data/information associated with the apparatus 3010 in a non-transitory computer readable medium for use, such as by the controller 3030.

The communication interface 3034 may be configured to enable connection to external systems (e.g., an external network 3012 and/or one or more other system(s)/device(s), such as another apparatus 3010). In some embodiments, the communication interface 3034 may comprise one or more transmitters configured to transmit, for example, one or more signals according to example embodiments described herein. Likewise, the communication interface 3034 may include at least one receiver configured to, for example, receive data according to example embodiments described herein. In some embodiments, the transmitter and receiver may be combined as a transceiver. In this regard, the apparatus 3010 may be configured for wired and/or wireless communication. In some embodiments, the communication interface 3034 may comprise wireless capabilities for WiFi, Bluetooth, or other wireless protocols. In some embodiments, the apparatus 3010 may be connected to one or more point-of-sale system(s) 3013 to aid in performance of food orders (such as by forming sealing lids for use with the order).

The user interface 3036 may be configured to receive input from a user and/or provide output to a user. The user interface 3036 may include, for example, a display, a keyboard, keypad, function keys, mouse, scrolling device, input/output ports, touch screen, or any other mechanism by which a user may interface with the system. Although the user interface 3036 is shown as being directly connected to the controller 3030 and within the apparatus 3010, the user interface 3036 could alternatively be remote from the controller 3030 and/or apparatus 3010. Likewise, in some embodiments, other components of the apparatus 3010 could be remotely located.

The power source 3039 may be any type of power source, such as a battery (or batteries) and/or an external power source (e.g., a plug 3209, such as shown in FIG. 23A, may be used to receive power from an outlet). Power from the power source 3039 may be used to provide power to any of the components/devices utilized in the apparatus 3010.

### Example Flowchart(s) for the Cup Closer

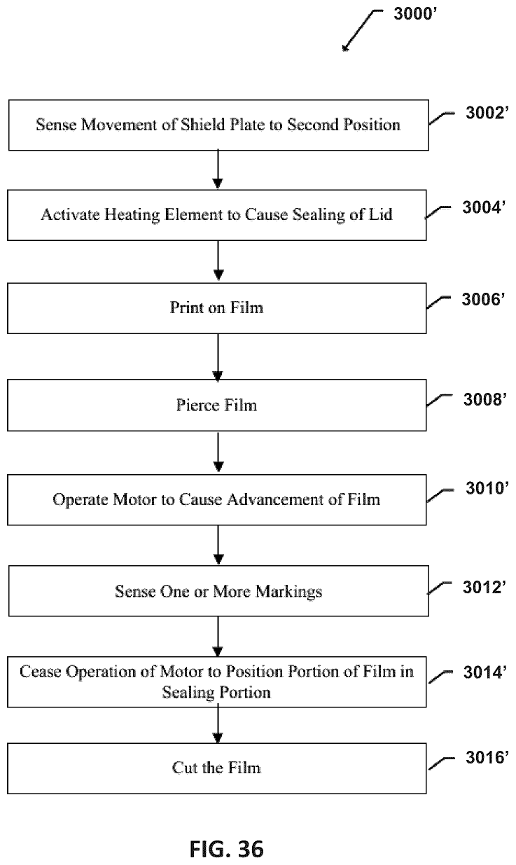

Embodiments of the present invention provide methods, apparatuses and computer program products for operating example cup closer devices according to various embodiments described herein (such as in conjunction with a cup filler and/or cup printer). Various examples of the operations performed in accordance with embodiments of the present invention will now be provided with reference to FIGS. 36-38.

FIG. 36 illustrates a flowchart according to an example method for operating an example sealer device according to an example embodiment. Notably, while FIG. 36 provides a flow of various operations, the order of occurrence of the operations is not meant to be limited to that illustrated in FIG. 36 and may vary within embodiments of the present invention. The operations illustrated in and described with respect to FIG. 36 may, for example, be performed by, with the assistance of, and/or under the control of one or more of the components of example systems/device described herein, such as apparatus 3010, 3170c, 3170c′ among other things.

The method 3000′ may include sensing movement of the shield plate to a second position within the sealing portion at operation 3002′. At operation 3004′, the method may include activating one or more heating element(s) to cause sealing of the film to a cup. At operation 3006′, the method may include printing on the film, such as including one or more messages or images. Then, the method may include piercing the film with a piercer at operation 3008′. The method may further include operating the motor to cause advancement of the film along the film path at operation 3010′. At operation 3012′, the method may include sensing one or more markings on the film. Then, at operation 3014′, the method may cause ceasing operation of the motor to position portion of the film in the sealing portion. Next, at operation 3016′, the method may include cutting the film, thereby putting the sealing device back into a ready status.

As noted above, in some embodiments, different orders of operations of FIG. 36 may occur in various embodiments described herein. For example, the printing and/or piercing may occur before the heating elements are activated. Likewise, the printing and/or piercing may occur after the motor has operated to advance the film. In some embodiments, the operations may occur at the same time (e.g., the piercing may occur while the motor is operating to advance the film, the sensing may occur while the motor is operating to advance the film, etc.).

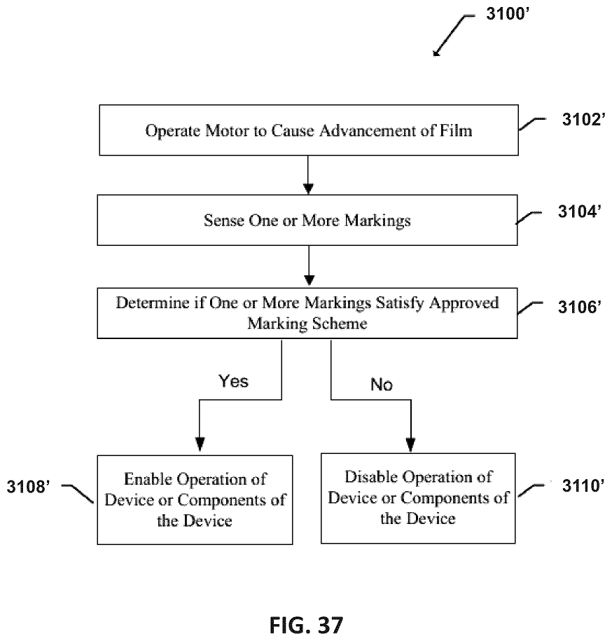

FIG. 37 illustrates a flowchart according to an example method for enabling or disabling operational ability of the sealer device based on whether the installed film is an approved roll of film according to an example embodiment. The operations illustrated in and described with respect to FIG. 37 may, for example, be performed by, with the assistance of, and/or under the control of one or more of the components of example systems/device described herein, such as apparatus 3010, 3170c, 3170c′ among other things.

The method 3100′ may include operating the motor to cause advancement of the film along the film path, such as across the film sensor, at operation 3102′. At operation 3104′, the method may include sensing one or more markings on the film. At operation 3106′, the method may include determining if the one or more markings satisfy an approved marking scheme. Then, if the one or more markings do satisfy an approved marking scheme, the method may include enabling operation of the sealing device and/or various components of the sealing device at operation 3108′. However, if the one or more markings do not satisfy an approved marking scheme, the method may include disabling operation of the sealing device and/or various components of the sealing device at operation 3110′.

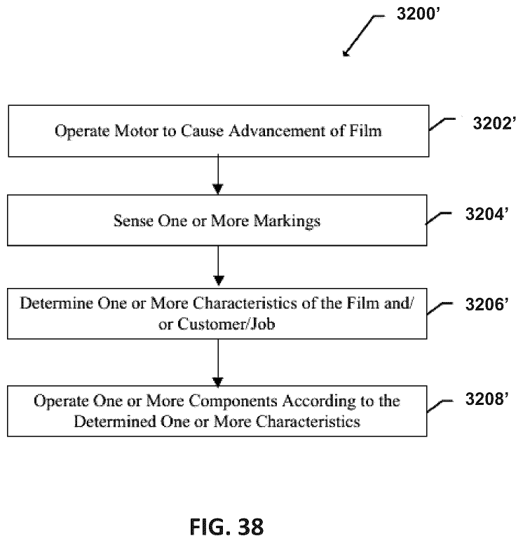

FIG. 38 illustrates a flowchart according to an example method for operating an example sealer device according to an example embodiment. The operations illustrated in and described with respect to FIG. 38 may, for example, be performed by, with the assistance of, and/or under the control of one or more of the components of example systems/device described herein, such as apparatus 3010, 3170c, 3170c′ among other things.

The method 3200′ may include operating the motor to cause advancement of the film along the film path, such as across the film sensor, at operation 3202′. At operation 3204′, the method may include sensing one or more markings on the film. At operation 3206′, the method may include determining one or more characteristics of the film and/or the planned operation of the sealer device based on the sensor data. Then, the method may include operating one or more components of the sealer device according to the determined one or more characteristics at operation 3210′.

FIGS. 36-38 illustrates an example flowchart of a system, method, and computer program product according to various example embodiments described herein. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the controller 3030. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### Example Integrated Cup Dispensing Systems and Devices

As detailed herein, example embodiments of the present invention provide various integrated cup dispensing systems that utilize two or more of a cup printer, cup filler, and cup closer to provide for on-demand cup dispensing. Such on-demand cup dispensing may be provided in conjunction with a food service request module to provide a useful solution for providing automated cup dispensing functionality to be used with food service orders. Returning briefly to FIGS. 6A-6C, example integrated dispensers 610 (FIG. 6A), 610′ (FIG. 6B), and 610″ (FIG. 6C) include integrated combinations of a cup printer 670a, cup filler 670b, and a cup closer 670c. Further, an example controller 672, 672′, 672″ provides control functionality, such as in conjunction with a food request system 680, 680′, 680″. One or more cup transfer elements 673a, 673b, 673a′, 673b″ provide for movement and handling of the cup through the dispensers 610, 610′, 610″.

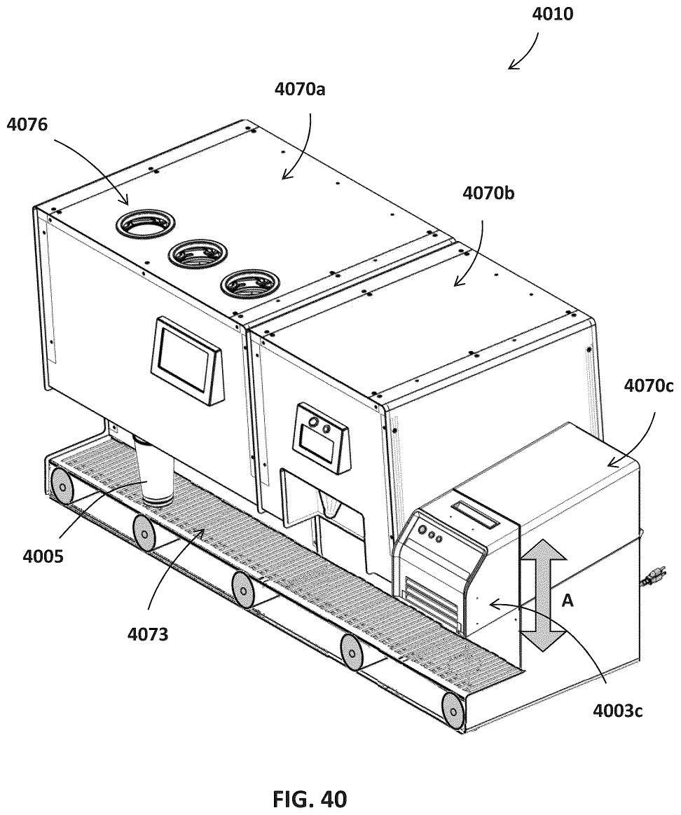

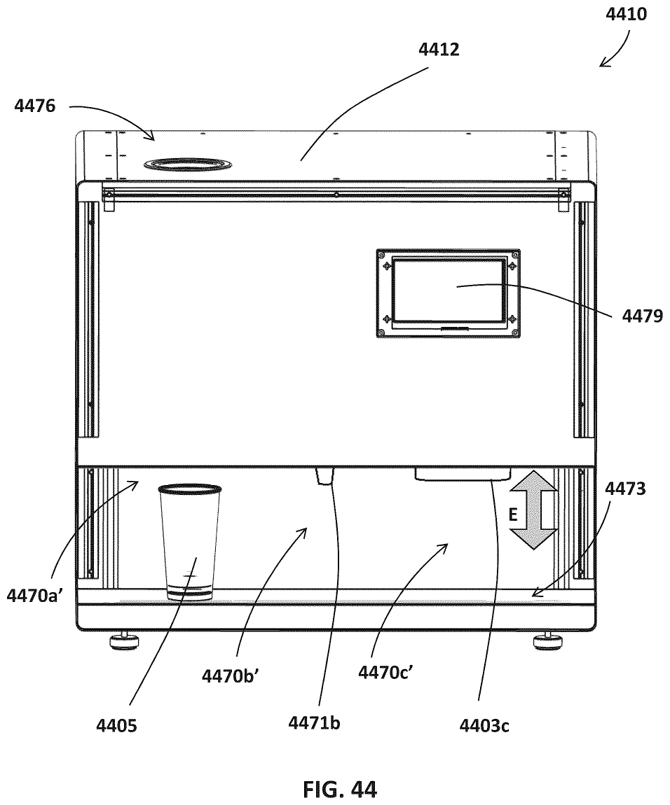

In this regard, various example integrated systems are contemplated, which may include various combinations of described devices (e.g., cup printer, cup filler, cup closer) working in conjunction while being in distinct and/or separate devices (e.g., shown in FIGS. 40-43) or while being integrated in a single housing (e.g., shown in FIGS. 44-46)—or various combinations thereof. The following example dispensers are shown and described in limited form for example purposes and one of ordinary skill in the art in view of the disclosure would appreciate that various components and features described within this disclosure could be incorporated as appropriate to provide the desired functionality.

FIG. 40 shows an example cup dispenser 4010 that includes a cup printer 4070a, a cup filler 4070b, and a cup closer 4070c. A cup transfer element 4073 in the form of a conveyor belt with or without cup holders (not shown) (although other forms of cup transfer elements are contemplated herein) may cause movement of the cup 4005 through the dispenser 4010. The cup 4005 may be obtained from a cup source 4076. The cup 4005 may undergo printing via the cup printer 4070a, filling via the cup filler 4070b, and receiving a lid/seal via the cup closer 4070c. In the illustrated embodiment, the cup closer 4070c includes a sealing portion 4003c that is configured to be moved up and down (e.g., along arrow A) to provide the lid/seal to the cup 4005. For example, when the cup 4005 is in a closing position (e.g., underneath the sealing portion 4003c), the sealing portion 4003c may move from a resting position (shown) to an operating position to cause the lid/seal to be applied. As noted herein, the known size of the cup may be used in control of movement of the sealing portion 4003c to provide an effective and desirable lid/seal to the cup 4005.

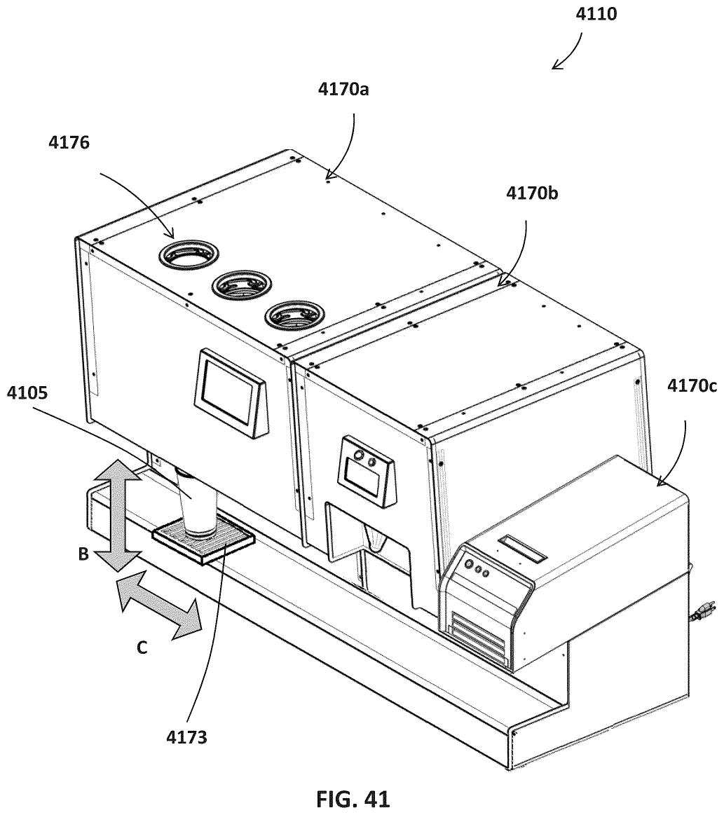

FIG. 41 shows another example cup dispenser 4110 that includes a cup printer 4170a, a cup filler 4170b, and a cup closer 4170c. A cup transfer element 4173 in the form of a movable platform (although other forms of cup transfer elements are contemplated herein) may cause movement of the cup 4105 through the dispenser 4110. In this regard, the cup 4105 may be moved between the various devices (e.g., along arrow C) and, such as when the cup 4105 comes to a closing position below a portion of the cup closer 4170c, the platform may be configured to move the cup upwardly (e.g., along arrow B) into the cup closer 4170c to cause application of the lid/seal to the cup 4105.

FIG. 42 shows another example cup dispenser 4210 that includes a cup printer 4270a and a cup filler 4270b (but does not include a cup closer). Accordingly, the cup 4205 may be directed through the dispenser 4210 (such as via the cup transfer elements 4273) to form a printed, filled cup. In this regard, the cup 4205 may undergo printing via the cup printer 4270a and filling via the cup filler 4270b.

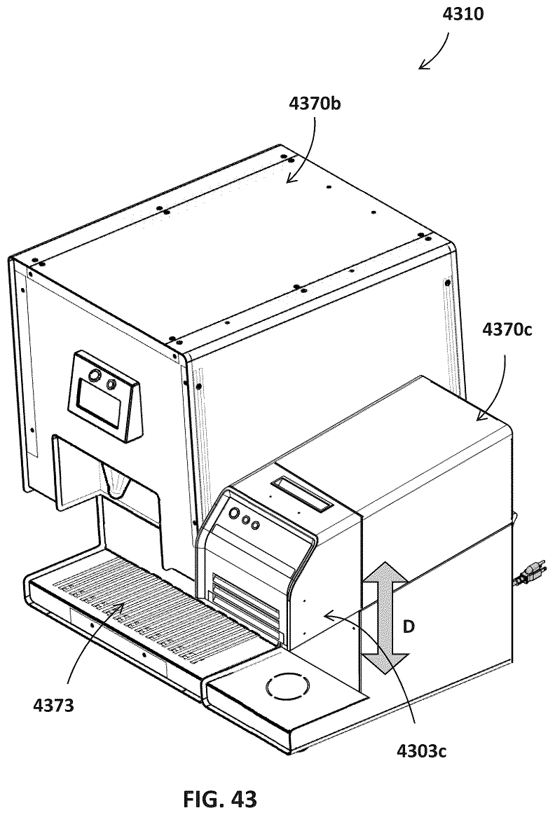

FIG. 43 shows another example cup dispenser 4310 that includes a cup filler 4370b and a cup closer 4370c (but does not include and cup printer). Accordingly, the cup 4305 may be directed through the dispenser 4310 (such as via the cup transfer elements 4373) to form a filled, closed cup. In this regard, the cup 4305 may undergo filling via the cup filler 4370b and receiving a lid/seal via the cup closer 4370c (e.g., via movement along arrow D of the sealing portion 4303c). Although the sealing portion 4303c is shown as being configured to move to cause creation of the lid/seal, in some embodiments (such as similar to described in FIG. 41) one or more cup transfer elements could be used to move the cup into the sealing portion 4303c (or as otherwise needed).

FIG. 44 shows an example cup dispenser 4410 that includes a cup printer 4470a′, a cup filler 4470b′, and a cup closer 4470c′ all contained within a single housing 4412. A cup transfer element 4473 in the form of a conveyor belt (although other forms of cup transfer elements are contemplated herein) may cause movement of the cup 4405 through the dispenser 4410. The cup 4405 may be obtained from a cup source 4476. The cup 4405 may undergo printing via the cup printer 4470a′, filling via the cup filler 4470b′ (e.g., with the nozzle 4471b), and receiving a lid/seal via the cup closer 4470c′ (e.g., via movement along arrow E of the sealing portion 4403c). Although the sealing portion 4403c is shown as being configured to move to cause creation of the lid/seal, in some embodiments (such as similar to described in FIG. 41) one or more cup transfer elements could be used to move the cup into the sealing portion 4403c (or as otherwise needed). In the illustrated embodiment, the dispenser 4410 includes a user interface 4479, such as may be useful in controlling operation of the dispenser 4410.

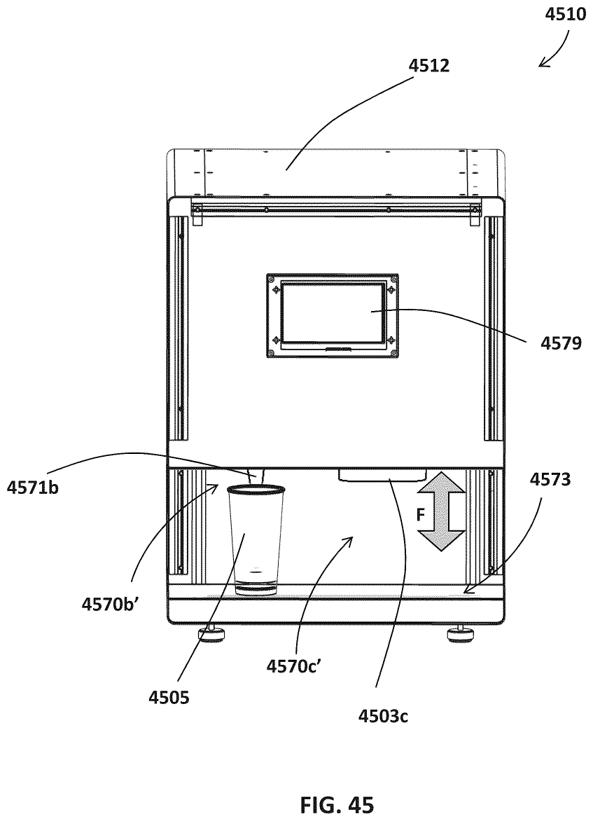

FIG. 45 shows another example cup dispenser 4510 that includes a cup filler 4570b and a cup closer 4570c (but does not include a cup printer) contained within a single housing 4512. Accordingly, the cup 4505 may be directed through the dispenser 4510 (such as via the cup transfer elements 4573) to form a filled, closed cup. In this regard, the cup 4505 may undergo filling via the cup filler 4570b′ (e.g., with the nozzle 4571b) and receiving a lid/seal via the cup closer 4570c′ (e.g., via movement along arrow F of the sealing portion 4503c). Although the sealing portion 4503c is shown as being configured to move to cause creation of the lid/seal, in some embodiments (such as similar to described in FIG. 41) one or more cup transfer elements could be used to move the cup into the sealing portion 4503c (or as otherwise needed).

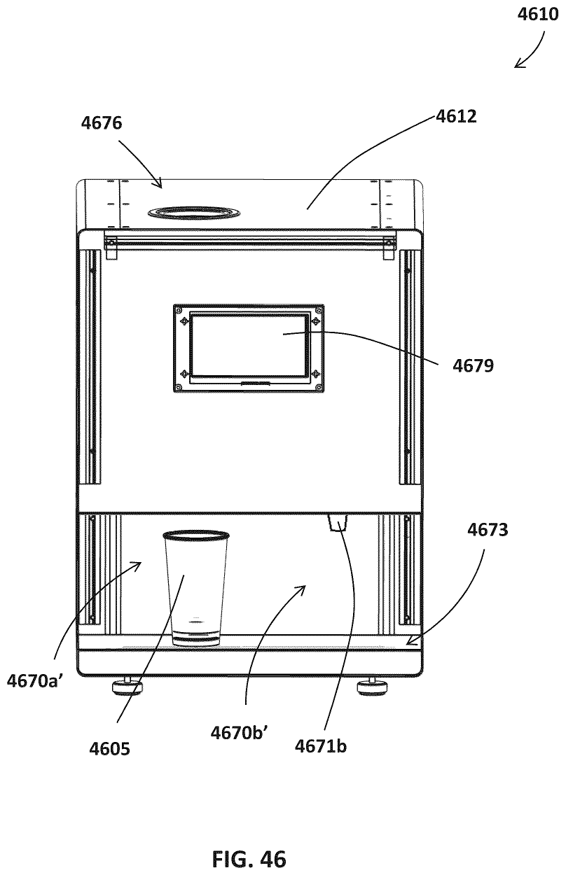

FIG. 46 shows another example cup dispenser 4610 that includes a cup printer 4670a and a cup filler 4670b (but does not include a cup closer) contained within a single housing 4612. Accordingly, the cup 4605 may be directed through the dispenser 4610 (such as via the cup transfer elements 4673) to form a printed, filled cup. In this regard, the cup 4605 may undergo printing via the cup printer 4670a′ and filling via the cup filler 4670b′ (e.g., with the nozzle 4671b).

As noted herein, while the above examples illustrate use of a conveyor belt and/or movable platform as example cup transfer elements, various embodiments contemplate use of other types of cup transfer elements (e.g., additionally or alternatively), such as described herein. Likewise, though movement of the cup is shown in front of and/or below the various devices, such movement could occur in other forms and/or places (e.g., within the various devices, behind the devices, through tunnels connecting the various devices, or combinations thereof). As an example, a tunnel may connect the cup printer to the cup filler and a cup may pass from the cup printer to the cup filler via the tunnel (such as by being oriented to fit within the tunnel). The cup could then travel through the tunnel, such as via a vacuum, forced air, etc.

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1.-23. (canceled)

24. A system for on-demand dispensing of a cup for a food service order, the system comprising:
a food request module configured to receive a request for food service for a customer, wherein the request for food service includes the food service order;
a cup source configured to hold one or more cups, each of the one or more cups comprising an open end and a closed end and a sidewall extending therebetween;
a cup printer configured to print both order information and personalization information on a sidewall of a first cup of the one or more cups so as to form a printed first cup, wherein the order information and the personalization information are each based on the food service order associated with the first cup, wherein the cup printer comprises a printer that is configured to print the at least one of order information or personalization information on the sidewall of the first cup when the first cup is in a horizontal orientation, wherein, when the first cup is in the horizontal orientation, at least one of a central axis of the first cup extending through each of the first cup's open and closed ends or a portion of the sidewall of the first cup is horizontal during printing of the first cup;
a cup filler configured to fill said printed first cup with a consumable based on the food service order associated with the first cup so as to form a filled first cup;
a cup closer configured to at least partially close the open end of the filled first cup so as to form a closed first cup; and
one or more cup transfer elements for transferring the first cup between the cup printer, the cup filler, and the cup closer.

25. The system of claim 24, further comprising a cup dispensing control system, the cup dispensing control system comprising:
a communication element;
a controller configured to:
cause the cup printer to print the at least one of order information or personalization information on the first cup corresponding to the food service order;
cause the cup filler to fill the printed first cup with the consumable based on the food service order associated with the first cup;
cause the cup closer to at least partially close the open end of the filled first cup; and
cause the one or more cup transfer elements to transfer the first cup between the cup printer, the cup filler, and the cup closer.

26. The system of claim 24, wherein the first cup comprises a marking printed thereon, wherein the system further comprises:
at least one cup mark sensor configured to detect the marking printed on the first cup; and
a cup dispensing control system comprising:
a communication element; and
a controller configured to:
receive data corresponding to the detected marking; and
cause operation of at least the cup printer and the cup closer based on the received data.

27. The system of claim 24, wherein the one or more cup transfer elements comprises at least one conveyor belt for transferring the first cup between at least the cup printer, the cup filler, and the cup closer.

28. The system of claim 24, wherein the one or more cup transfer elements comprises at least one robotic device for transferring the first cup between at least the cup printer, the cup filler, and the cup closer.

29. The system of claim 24, wherein a portion of the cup closer is configured to move between an operating position and a resting position, wherein the portion of the cup closer is configured to move to the operating position in an instance in which the first cup is positioned underneath the portion of the cup closer to cause the first cup to be closed.

30. The system of claim 24, wherein the one or more cup transfer elements comprises at least one of a movable platform or a robotic arm, wherein, when the first cup is underneath a portion of the cup closer, the at least one movable platform or robotic arm is configured to raise the first cup at least partially into the portion of the cup closer to be closed.

31. The system of claim 24, wherein the cup printer and the cup filler are within a single housing.

32. The system of claim 24, wherein the cup filler and the cup closer are within a single housing.

33. The system of claim 24, wherein the cup printer, the cup filler, and the cup closer are within a single housing.

34. The system of claim 24 further comprising a dispensing section configured to enable a user to access the closed first cup.

35. The system of claim 24, wherein the cup closer comprises:
a body portion configured to house a supply of film;
a sealing portion configured to receive at least a top portion of the first cup, wherein the sealing portion comprises an aperture sized to receive the top portion of the first cup therethrough, wherein the body portion defines a film path leading from the supply of film to the sealing portion;
a nip defined by a drive roller and a pinch roller, wherein the nip is positioned along the film path and configured to receive the film therethrough;
a motor configured to operate the drive roller to cause advancement of the film along the film path;
at least one heating element configured to activate to emanate energy; and
a controller configured to cause the at least one heating element to activate to emanate energy to cause the portion of the film within the sealing portion to seal the top portion of the first cup to form a lid for the first cup.

36. A system for on-demand dispensing of a cup for a food service order, the system comprising:
a food request module configured to receive a request for food service for a customer, wherein the request for food service includes the food service order;
a cup source configured to hold one or more cups, each of the one or more cups comprising an open end and a closed end and a sidewall extending therebetween; and
a cup filler configured to fill a first cup from said cup source with a consumable based on the food service order so as to form a filled first cup;
a cup closer configured to at least partially close the open end of the filled first cup so as to form a closed cup;
one or more cup transfer elements for transferring the first cup between the cup filler and the cup closer; and
a cup dispensing control system, the cup dispensing control system comprising:
a communication element;
a cup mark sensor configured to detect a marking printed on the first cup; and
a controller configured to:
receive data corresponding to the detected marking; and
cause operation of the cup printer and the cup closer based on the received data.

37. The system of claim 36, wherein the controller is further configured to:
cause the cup filler to fill the first cup with the consumable based on the food service order associated with the first cup;
cause the cup closer to at least partially close the open end of the filled first cup; and
cause the one or more cup transfer elements to transfer the first cup between the cup filler and the cup closer.

38. The system of claim 36, wherein a portion of the cup closer is configured to move between an operating position and a resting position, wherein the portion of the cup closer is configured to move to the operating position in an instance in which the first cup is positioned in underneath the portion of the cup closer to cause the first cup to be closed.

39. The system of claim 36, wherein the one or more cup transfer elements comprises at least one of a movable platform or a robotic arm, wherein, when the first cup is underneath a portion of the cup closer, the at least one movable platform or robotic arm is configured to raise the first cup at least partially into the portion of the cup closer to be closed.

40. A system for on-demand dispensing of a cup for a food service order, the system comprising:
a food request module configured to receive a request for food service for a customer, wherein the request for food service includes the food service order;
a cup source configured to hold one or more cups, each of the one or more cups comprising an open end and a closed end and a sidewall extending therebetween; and
a cup printer configured to print order information and personalization information on a sidewall of a first cup of the one or more cups so as to form a printed first cup, wherein the order information and the personalization information are each based on the food service order associated with the first cup, wherein the cup printer comprises a printer that is configured to print the at least one of order information or personalization information on the sidewall of the first cup when the first cup is in a horizontal orientation, wherein, when the first cup is in the horizontal orientation, at least one of a central axis of the first cup extending through each of the first cup's open and closed ends or a portion of the sidewall of the first cup is horizontal during printing of the first cup;
a cup filler configured to fill said printed first cup with a consumable based on the food service order associated with the first cup so as to form a filled first cup; and
one or more cup transfer elements for transferring the first cup between the cup printer and the cup filler.

41. The system of claim 40 further comprising a cup dispensing control system, the cup dispensing control system comprising:
a communication element;
a controller configured to:
cause the cup printer to print the at least one of order information or personalization information on the first cup corresponding to the food service order;
cause the cup filler to fill the printed first cup with the consumable based on the food service order associated with the first cup; and
cause the one or more cup transfer elements to transfer the first cup between the cup printer and the cup filler.

42. The system of claim 41, wherein the first cup comprises a marking printed thereon, wherein the cup dispensing control system comprises a cup mark sensor configured to detect the marking, and wherein a controller is configured to:
receive data corresponding to the detected marking; and
cause operation of one or more of the cup printer or cup filler based on the received data.

43. The system of claim 40, wherein the cup printer and the cup filler are within a single housing.
